(19) United States
(12) Patent Application Publication
(10) Pub. No.: US 2016/0196216 A1
(43) Pub. Date: Jul. 7, 2016

(54) MAPPING TABLE MANAGING METHOD AND ASSOCIATED STORAGE SYSTEM

(71) Applicant: SAMSUNG ELECTRONICS CO., LTD., Suwon-Si (KR)

(72) Inventor: Ju-Pyung LEE, Yeonsu-Gu (KR)

(21) Appl. No.: 14/979,903

(22) Filed: Dec. 28, 2015

(30) Foreign Application Priority Data
Jan. 2, 2015 (KR) 10-2015-0000295

(51) Int. Cl. G06F 12/10; G06F 3/06

(52) U.S. Cl. CPC G06F 12/1018; G06F 3/0604; G06F 3/064; G06F 3/0683; G06F 3/0631; G06F 2212/65

(57) ABSTRACT

A mapping table managing method, performed in a storage system, includes organizing mapping information about the storage system into a plurality of pieces of partial mapping table (PMT) information and distributing and storing the plurality of pieces of PMT information in storage devices (SDs). The method includes searching for a storage location in an SD on which an access operation is to be performed, by using the PMT information stored in each of the SDs, and performing the access operation on a found storage location in the SD.

### CROSS-REFERENCE TO RELATED APPLICATIONS

This application claims the benefit of Korean Patent Application No. 10-2015-0000295, filed on Jan. 2, 2015, in the Korean Intellectual Property Office, the disclosure of which is incorporated herein in its entirety by reference.

### FIELD

The inventive concept relates to a method and apparatus for processing data in a storage system, and more particularly, to a mapping table managing method performed in a storage system, and the storage system to which the mapping table managing method is applied.

### BACKGROUND

A redundant array of independent disks (RAID) is technology for distributing and storing data in a plurality of hard disk devices. Due to technical developments, solid state drives (SSDs) may be used instead of hard disk drives (HDDs). Since a storage system, to which the RAID technology is applied, should reconstitute data that is to be written to form a log structure, the storage system should manage mapping information about a virtual address and a physical address. However, the size of the mapping information greatly increases with increases in the number of SSDs configuring a storage system, to which the RAID technology is applied, and the storage capacities thereof. Accordingly, improved approaches for efficiently managing mapping information in a storage system is needed.

### SUMMARY

The inventive concept provides a mapping table managing method which is performed in a storage system and in which mapping information of the storage system is distributed into and stored in storage devices (SDs).

The inventive concept also provides a storage system which distributes and stores mapping information into and in SDs and manages the same.

According to an aspect of the inventive concept, there is provided a mapping table managing method in a storage system, the method including: organizing mapping information about the storage system into a plurality of pieces of partial mapping table (PMT) information and distributing and storing the plurality of pieces of PMT information in storage devices (SDs); searching for a storage location in an SD on which an access operation is to be performed, by using the PMT information stored in each of the SDs; and performing the access operation on a found storage location in the SD.

According to another aspect of the inventive concept, there is provided a storage system including a plurality of SDs each comprising a random access memory (RAM) region and a non-volatile memory region. A controller transmits a read command or a write command to the plurality of the SDs based on a log-structured storage environment. Mapping information about the storage system is organized into a plurality of pieces of PMT information, the plurality of pieces of PMT information are distributed into and stored in respective RAM regions of the SDs, and a read command or a write command received from the controller is performed using the PMT information stored in each of the SDs.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a storage system according to an exemplary embodiment of the inventive concept;

FIG. 2 is a block diagram of a storage system according to another exemplary embodiment of the inventive concept;

FIG. 3 is a block diagram of a storage system according to another exemplary embodiment of the inventive concept;

FIG. 4 is a block diagram of a storage system according to another exemplary embodiment of the inventive concept;

FIG. 5 is a block diagram of a storage system according to another exemplary embodiment of the inventive concept;

FIG. 6 is a block diagram of a storage system according to another exemplary embodiment of the inventive concept;

FIGS. 7A and 7B are schematic representations showing various examples of setting storage regions in the non-volatile random access memory (NVRAM) shown in FIGS. 2, 4, and 6;

FIG. 8 is a schematic diagram illustrating a write operation according to a parity-based redundant array of independent disks (RAID) method in a storage system according to an exemplary embodiment of the inventive concept;

FIG. 9 is a schematic diagram illustrating a log-structured RAID method in a storage system according to an exemplary embodiment of the inventive concept;

FIG. 10 is a block diagram illustrating an example of executing a solid state drive (SSD)-based log-structured RAID method by using a NVRAM in a storage system, according to an exemplary embodiment of the inventive concept;

FIGS. 11A and 11B are block diagrams illustrating a write operation performed in units of stripes in a storage system, according to an exemplary embodiment of the inventive concept;

FIGS. 12A-12D are block diagrams illustrating a data storing process in an example of writing data to storage devices (SDs) in units of memory blocks by using NVRAM in a storage system according to an exemplary embodiment of the inventive concept;

FIGS. 13A-13D are block diagrams illustrating a data storing process in an example of writing data to SDs in units of pages by using NVRAM in a storage system according to an exemplary embodiment of the inventive concept;

FIGS. 14A-14H are block diagrams illustrating a garbage collection operation performed by using NVRAM in a storage system according to an exemplary embodiment of the inventive concept;

FIGS. 15A and 15B are block diagrams illustrating various examples of copying valid pages included in a victim stripe into new memory blocks during a garbage collection operation by using NVRAM in a storage system according to an exemplary embodiment of the inventive concept;

FIG. 16 is a block diagram illustrating an example of a stripe constitution after a garbage collection operation is performed in a storage system according to an exemplary embodiment of the inventive concept;

FIG. 17A illustrates a virtual address mapping table that is used in a storage system according to an exemplary embodiment of the inventive concept;

FIG. 17B illustrates a stripe mapping table that is used in a storage system according to an exemplary embodiment of the inventive concept;

FIG. 18 is a block diagram illustrating respective data storage locations on SDs according to the virtual address mapping table and the stripe mapping table of FIGS. 17A and 17B;

FIG. 19 is a block diagram illustrating a method of distributing and storing mapping information into and in SSDs in a storage system according to an exemplary embodiment of the inventive concept;

FIG. 20 is a block diagram illustrating a method of distributing and storing a mapping table into and in SDs in a storage system according to an exemplary embodiment of the inventive concept;

FIG. 21 is a block diagram illustrating a process of updating pieces of partial virtual address mapping table information according to a write command in a storage system according to an exemplary embodiment of the inventive concept;

FIG. 22 is a block diagram illustrating a read operation performed in a storage system according to an exemplary embodiment of the inventive concept;

FIG. 23 is a block diagram illustrating a read operation performed in a storage system according to another exemplary embodiment of the inventive concept;

FIG. 24 is a block diagram illustrating a mapping table managing method in a storage system according to another exemplary embodiment of the inventive concept;

FIG. 25 is a block diagram illustrating a mapping table managing method in a storage system according to another exemplary embodiment of the inventive concept;

FIG. 26A shows a virtual address mapping table that is used in a storage system, according to another exemplary embodiment of the inventive concept;

FIG. 26B shows a stripe mapping table that is used in a storage system, according to another exemplary embodiment of the inventive concept;

FIG. 27 shows distributed storing and backup management of the virtual address mapping table and the stripe mapping table of FIGS. 26A and 26B in a storage system, according to an exemplary embodiment of the inventive concept;

FIG. 28A shows a virtual address mapping table that is used in a storage system, according to another exemplary embodiment of the inventive concept;

FIG. 28B shows a stripe mapping table that is used in a storage system, according to another exemplary embodiment of the inventive concept;

FIG. 29 shows distributed storing and backup management of the virtual address mapping table and the stripe mapping table of FIGS. 28A and 28B in a storage system, according to an exemplary embodiment of the inventive concept;

FIG. 30A shows a virtual address mapping table that is used in a storage system, according to another exemplary embodiment of the inventive concept;

FIG. 30B shows a stripe mapping table that is used in a storage system, according to another exemplary embodiment of the inventive concept;

FIG. 31 illustrates a mapping information restoring method when one SSD is defective, in a storage system according to an exemplary embodiment of the inventive concept;

FIG. 32 is a block diagram of an SSD forming a storage system according to an exemplary embodiment of the inventive concept;

FIG. 33 is a schematic diagram showing an example of channels and ways in the SSD of FIG. 32;

FIG. 34 is a block diagram illustrating a detailed structure of a memory controller included in the SSD illustrated in FIG. 32;

FIG. 35 is a block diagram illustrating a detailed structure of a flash memory chip included in a memory device included in the SSD of FIG. 33;

FIG. 36 is a schematic view illustrating a memory cell array included in the memory device illustrated in FIG. 35;

FIG. 37 is an equivalent circuit diagram of a first memory block included in the memory cell array of FIG. 35;

FIG. 38 is a flowchart of a mapping table managing method in a storage system according to an exemplary embodiment of the inventive concept;

FIG. 39 is a flowchart of a write operation controlling method in a host of a storage system according to an exemplary embodiment of the inventive concept;

FIG. 40 is a flowchart of a read operation controlling method in a host of a storage system according to an exemplary embodiment of the inventive concept;

FIG. 41 is a flowchart of a write operation performing method in an SD of a storage system according to an exemplary embodiment of the inventive concept;

FIG. 42 is a flowchart of a read operation performing method in an SD of a storage system according to an exemplary embodiment of the inventive concept; and

FIG. 43 is a flowchart of a read operation performing method in an SD of a storage system according to another exemplary embodiment of the inventive concept.

### DETAILED DESCRIPTION OF THE EMBODIMENTS

Hereinafter, the inventive concept will be described more fully with reference to the accompanying drawings, in which exemplary embodiments of the inventive concept are shown. These embodiments are provided so that this disclosure will be thorough and complete, and will fully convey the scope of the inventive concept to one of ordinary skill in the art. As the inventive concept allows for various changes and numerous embodiments, particular embodiments will be illustrated in the drawings and described in detail in the written description. However, this is not intended to limit the inventive concept to particular modes of practice, and it is to be appreciated that all changes, equivalents, and substitutes that do not depart from the spirit and technical scope of the inventive concept are encompassed in the inventive concept. In the drawings, like reference numerals denote like elements and the sizes or thicknesses of elements may be exaggerated for clarity of explanation.

The terms used in the present specification are merely used to describe particular embodiments, and are not intended to limit the inventive concept. An expression used in the singular encompasses the expression in the plural, unless it has a clearly different meaning in the context. In the present specification, it is to be understood that the terms such as “including”, “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless defined differently, all terms used in the description including technical and scientific terms have the same meaning as generally understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Herein, for convenience of explanation, a storage system according to the inventive concept is described as a redundant array of independent disks (RAID) storage system. However, the storage system according to the inventive concept may be any of various types of storage systems without being limited to a RAID storage system. The term “RAID controller” used herein may also be indicated as “controller”.

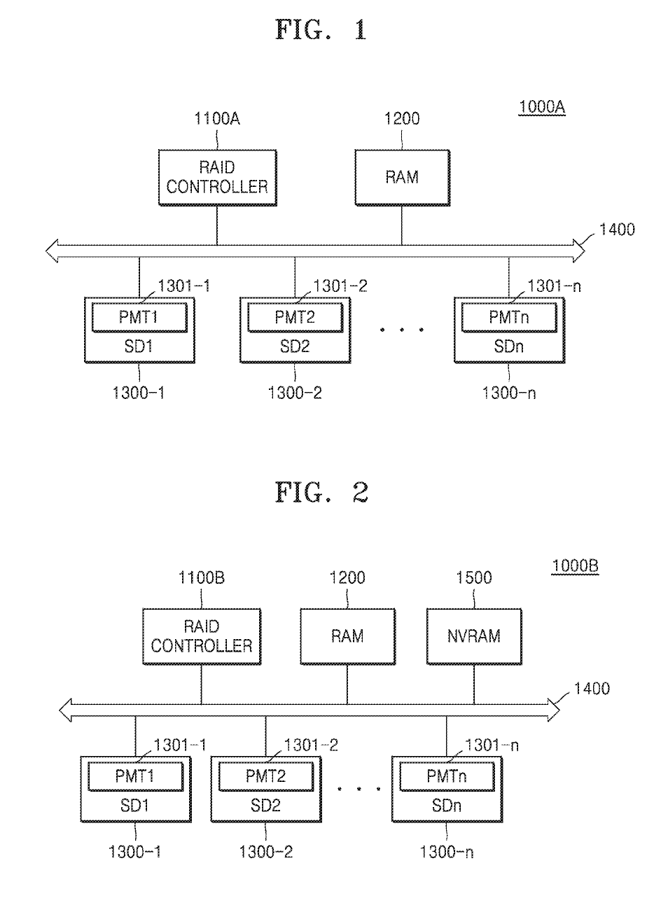

FIG. 1 is a block diagram of a storage system 1000A according to an exemplary embodiment of the inventive concept.

Referring to FIG. 1, the storage system 1000A includes a RAID controller 1100A, a random access memory (RAM) 1200, a plurality of storage devices (SDs), namely, first through n-th SDs 1300-1 through 1300-n, and a bus 1400. The components of the storage system 1000A are electrically coupled to each other via the bus 1400.

Examples of a RAID method include a method of restoring data by using a mirroring-based technique and a method of restoring data by using a parity-based technique, to prevent data loss when some storage devices are defective. For example, the storage system 1000A may use a parity-based RAID method.

The first through n-th SDs 1300-1 through 1300-n may be implemented by using solid state drives (SSDs) or hard disk drives (HDDs). According to exemplary embodiments of the inventive concept, the first through n-th SDs 1300-1 through 1300-n are SSDs. SSDs implement storage devices by using a plurality of non-volatile memory chips. For example, SSDs may implement storage devices by using a plurality of flash memory chips.

A plurality of pieces of partial mapping table (PMT) information 1301-1 through 1301-n are distributed into and stored in the first through n-th SDs 1300-1 through 1300-n, respectively. For example, a RAID-Level mapping table is divided into the plurality of pieces of PMT information 1301-1 through 1301-n, and the plurality of pieces of PMT information 1301-1 through 1301-n are distributed into and stored in the first through n-th SDs 1300-1 through 1300-n, respectively.

Mapping information for the storage system 1000A is divided into the plurality of pieces of PMT information 1301-1 through 1301-n based on an initially-set criterion, and the plurality of pieces of PMT information 1301-1 through 1301-n are distributed into and stored in the first through n-th SDs 1300-1 through 1300-n.

For example, the mapping information may include virtual address mapping information Virtual Address Map in which volume identification information VolumeID and a virtual address Vaddr are mapped with stripe identification information StripeID and a physical address Paddr, and stripe mapping information Stripe Map in which the stripe identification information StripeID is mapped with pieces of memory block identification information BlockID of SDs.

For example, the virtual address mapping information Virtual Address Map may be divided into a plurality of pieces of partial virtual address mapping table information based on a value obtained by hashing the volume identification information VolumeID, and the plurality of pieces of partial virtual address mapping table information are distributed into and stored in the first through n-th SDs 1300-1 through 1300-n. In detail, the virtual address mapping information Virtual Address Map may be classified into a plurality of pieces of partial virtual address mapping table information, based on the remainder obtained by dividing the volume identification information VolumeID by the number n of first through n-th SDs 1300-1 through 1300-n constituting the storage system 1000A having a log structure, and the plurality of pieces of partial virtual address mapping table information may be stored in the first through n-th SDs 1300-1 through 1300-n, respectively.

For example, the virtual address mapping information Virtual Address Map may be divided into a plurality of pieces of partial virtual address mapping table information based on a value obtained by hashing the virtual address Vaddr, and the plurality of pieces of partial virtual address mapping table information may be distributed into and stored in the first through n-th SDs 1300-1 through 1300-n. In detail, the virtual address mapping information Virtual Address Map may be classified into a plurality of pieces of partial virtual address mapping table information based on the remainder obtained by dividing the virtual address Vaddr by the number n of first through n-th SDs 1300-1 through 1300-n constituting the storage system 1000A, and the plurality of pieces of partial virtual address mapping table information may be stored in the first through n-th SDs 1300-1 through 1300-n, respectively.

For example, the stripe mapping information Stripe Map is divided into a plurality of pieces of partial stripe mapping table information in which stripe identification information for each SD is mapped with one piece of memory block identification information BlockID, and the plurality of pieces of the partial stripe mapping table information are distributed into and stored in the SDs, respectively.

For example, first PMT information 1301-1 is stored in the first SD 1300-1, second PMT information 1301-2 is stored in the second SD 1300-2, and n-th PMT information 1301-n is stored in the n-th SD 1300-n. For example, each of the plurality of pieces of PMT information 1301-1 through 1301-n may include one piece of partial virtual address mapping table information and one piece of partial stripe mapping table information.

Each of the first through n-th SDs 1300-1 through 1300-n includes a RAM region and a non-volatile memory region (for example, a flash memory region). The plurality of pieces of PMT information 1301-1 through 1301-n are distributed into and stored in respective RAM regions of the first through n-th SDs 1300-1 through 1300-n. In other words, the plurality of pieces of PMT information 1301-1 through 1301-n are stored in the respective RAM regions of the first through n-th SDs 1300-1 through 1300-n, respectively.

After a certain time period or after a write operation is completed, the plurality of pieces of PMT information distributed into and stored in the RAM regions of the first through n-th SDs 1300-1 through 1300-n are backed up in the flash memory regions of the first through n-th SDs 1300-1 through 1300-n.

For example, during a write operation, the first through n-th SDs 1300-1 through 1300-n write header information including the volume identification information VolumeID and the virtual address Vaddr, together with data, to the flash memory regions thereof.

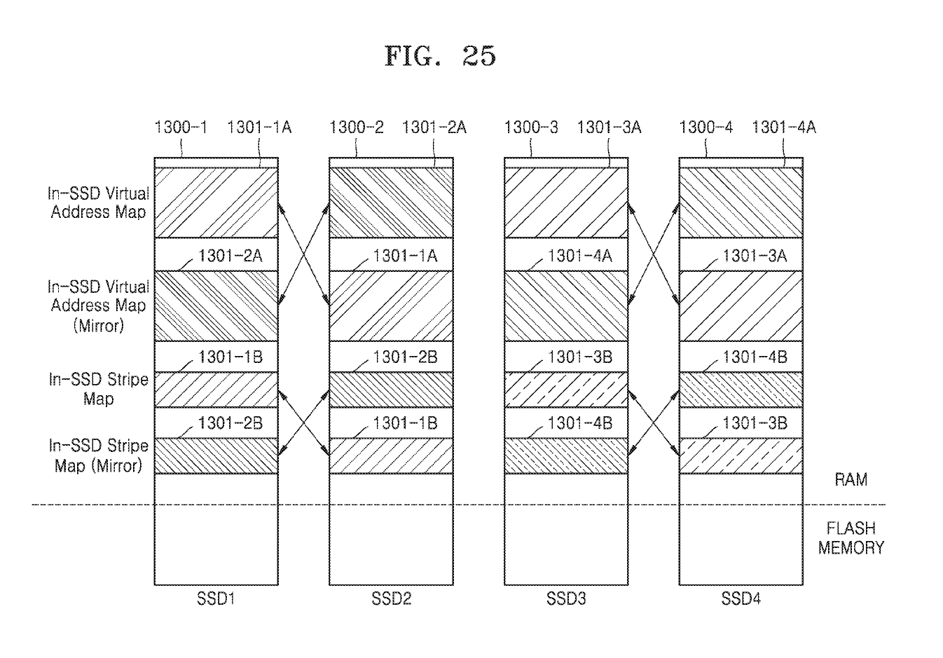

When one of the first through n-th SDs 1300-1 through 1300-n is defective, the RAID controller 1100A restores the plurality of pieces of PMT information by using the PMT information backed up in the flash memory regions of the first through n-th SDs 1300-1 through 1300-n and the header information stored together with the data in the flash memory regions thereof. Various methods of restoring PMT information will be described in detail later with reference to FIGS. 25-31.

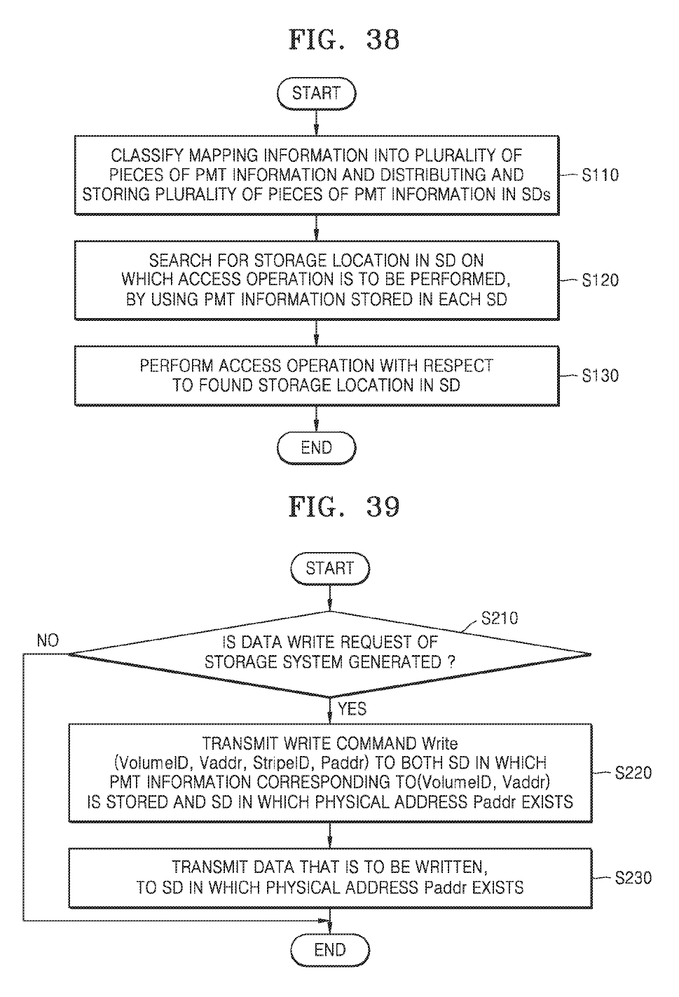

The RAM 1200 is a volatile memory, and may be DRAM or SRAM. The RAM 1200 functions as a main memory. The RAM 1200 may store information or program codes necessary for operating the storage system 1000A. For example, the RAM 1200 may store program codes necessary for performing the flowcharts of FIGS. 38-40.

The RAID controller 1100A controls the first through n-th SDs 1300-1 through 1300-n, based on a log-structured RAID environment. In detail, when updating data stored in the first through n-th SDs 1300-1 through 1300-n, the RAID controller 1100A controls the storage system 1000A not to overwrite data but instead write data to a new location in a log format. For example, a plurality of memory blocks to which data is written in the log format, and a memory block that stores parity information about the data written to the plurality of memory blocks constitute one stripe.

The RAID controller 1100A may perform the flowcharts of FIGS. 38-40 by using the program codes stored in the RAM 1200.

The RAID controller 1100A transmits a read command or a write command to the first through n-th SDs 1300-1 through 1300-n.

For example, the RAID controller 1100A generates a write command including the volume identification information VolumeID, the virtual address Vaddr, the stripe identification information StripeID, and the physical address Paddr. The RAID controller 1100A transmits a write command Write (VolumeID, Vaddr, StripeID, Paddr) to the i-th SD 1300-i in which PMT information PMTi corresponding to the volume identification information VolumeID and the virtual address Vaddr included in the write command is stored, and to the j-th SD 1300-j in which the physical address Paddr exists.

For example, the RAID controller 1100A generates a read command including the volume identification information VolumeID and the virtual address Vaddr. The RAID controller 1100A transmits a first read command VRead (VolumeID, Vaddr) to the i-th SD 1300-i in which the PMT information PMTi corresponding to the volume identification information VolumeID and the virtual address Vaddr included in the read command is stored.

For example, when receiving information (StripeID, Paddr) from the i-th SD 1300-i, the RAID controller 1100A transmits a second read command PRead (StripeID, Paddr) including the received information (StripeID, Paddr) to the j-th SD 1300-j in which the physical address Paddr exists.

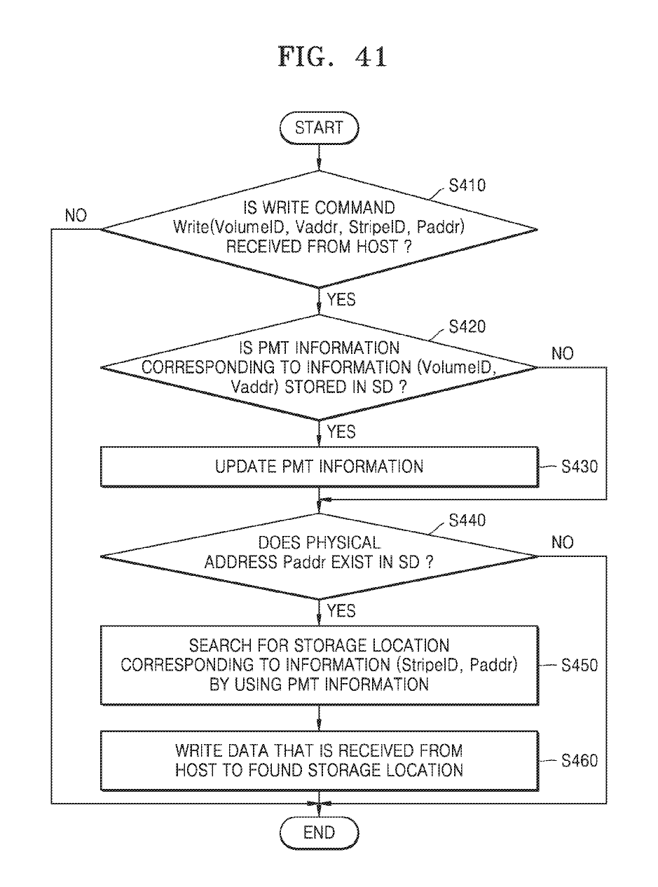

Each of the first through n-th SDs 1300-1 through 1300-n may perform a write operation or a read operation according to the flowcharts of FIGS. 41-43.

For example, the i-th SD 1300-i from among the first through n-th SDs 1300-1 through 1300-n performs a write operation as follows.

In response to the write command Write (VolumeID, Vaddr, StripeID, Paddr), the i-th SD 1300-i determines whether PMT information corresponding to information (VolumeID, Vaddr) included in a write command is stored therein. If it is determined that the PMT information corresponding to the information (VolumeID, Vaddr) included in the write command is stored in the i-th SD 1300-i, the i-th SD 1300-i performs an update operation by adding, to the PMT information PMTi, mapping information about a storage location in which data writing is to be performed based on the write command

The i-th SD 1300-i also determines whether the physical address Paddr included in the write command exists therein. If it is determined that the physical address Paddr included in the write command exists in the i-th SD 1300-i, the i-th SD 1300-i searches for a storage location corresponding to information (StripeID, Paddr) by using the PMT information PMTi and writes data received from the RAID controller 1100A to a found storage location.

For example, the i-th SD 1300-i or the j-th SD 1300-j from among the first through n-th SDs 1300-1 through 1300-n performs a read operation as follows.

In response to the first read command VRead(VolumeID, Vaddr), the i-th SD 1300-i searches for information (StripeID, Paddr) corresponding to information (VolumeID, Vaddr) included in the first read command by using the PMT information PMTi.

If a found physical address Paddr exists in the i-th SD 1300-i, the i-th SD 1300-i searches for a storage location corresponding to found information (StripeID, Paddr) by using the PMT information PMTi, namely, PMT information 1301-i. Then, the i-th SD 1300-i reads data from the found storage location and transmits the read data to the RAID controller 1100A.

On the other hand, if the found physical address Paddr does not exist in the i-th SD 1300-i, the i-th SD 1300-i transmits the found information (StripeID, Paddr) to the RAID controller 1100A.

Then, in response to the second read command PRead (StripeID, Paddr), the j-th SD 1300-j searches for a storage location corresponding to the found information (StripeID, Paddr) by using PMT information PMTj. Then, the j-th SD 1300-j reads data from the found storage location and transmits the read data to the RAID controller 1100A.

FIG. 2 is a block diagram of a storage system 1000B according to another exemplary embodiment of the inventive concept.

Referring to FIG. 2, the storage system 1000B includes a RAID controller 1100B, a RAM 1200, a plurality of SDs, namely, first through n-th SDs 1300-1 through 1300-n, a bus 1400, and a non-volatile RAM (NVRAM) 1500. The components of the storage system 1000B are electrically coupled to each other via the bus 1400.

The RAM 1200, the first through n-th SDs 1300-1 to 1300-n, and the bus 1400 of FIG. 2 have already been described above with reference to FIG. 1, and thus, detailed descriptions thereof will be omitted here.

The storage system 1000B may additionally include the NVRAM 1500, unlike the storage system 1000A of FIG. 1.

The NVRAM 1500 is RAM in which stored data is retained if power is removed. For example, the NVRAM 1500 may be implemented by using phase change RAM (PRAM), ferroelectric RAM (FeRAM), or magnetic RAM (MRAM). An another example, the NVRAM 1500 may be implemented according to a method of applying power to DRAM or SRAM, which is volatile memory, by using a battery or a capacitor. In other words, when system power is cut off, the DRAM or SRAM is driven by the battery or the capacitor, and thus data may be retained by moving data stored in the DRAM or SRAM to an SD which is a non-volatile storage space.

According to this method, even when system power is removed, data stored in the DRAM or SRAM may be retained.

The NVRAM 1500 may include a cache that stores data that is not protected temporarily by parity information during a garbage collection operation. The data that is not protected temporarily by parity information is referred to as orphan data. A cache allocated to the NVRAM 1500 in order to store orphan data is referred to as an orphan cache.

For example, a cache for storing data that is to be written in units of stripes to the first through n-th SDs 1300-1 through 1300-n may be allocated to the NVRAM 1500. The cache allocated to the NVRAM 1500 in order to store data that is to be written in units of stripes is referred to as a stripe cache.

The RAID controller 1100B controls the first through n-th SDs 1300-1 through 1300-n, based on a log-structured RAID environment. In detail, when updating data stored in the first through n-th SDs 1300-1 through 1300-n, the RAID controller 1100B controls the storage system 1000B not to overwrite data but instead write data to a new location in a log format. For example, a plurality of memory blocks to which data is written in the log format, and a memory block that stores parity information about the data written to the plurality of memory blocks define one stripe.

The RAID controller 1100B copies, into the NVRAM 1500, valid pages of the first through n-th SDs 1300-1 through 1300-n that are included in the victim stripe for garbage collection, and controls a garbage collection operation by using data corresponding to the valid pages copied into the NVRAM 1500. In detail, the RAID controller 1100B copies, into the orphan cache of the NVRAM 1500, the valid pages of the first through n-th SDs 1300-1 through 1300-n that are included in the victim stripe for garbage collection.

The RAID controller 1100B erases a memory block of the victim stripe that stores parity information, copies the valid pages included in the victim stripe into memory blocks that are used to define a new stripe, and erases memory blocks of the victim stripe that have stored the valid pages copied into the memory blocks that are used to define the new stripe.

The RAID controller 1100B calculates parity information about pieces of data copied into the orphan cache of the NVRAM 1500 and copies the calculated parity information into a memory block that is used to constitute the new stripe.

Since the valid pages of the first through n-th SDs 1300-1 through 1300-n included in the victim stripe are stored in the orphan cache of the NVRAM 1500, even if some of the first through n-th SDs 1300-1 through 1300-n have defects, the valid pages written to the memory blocks of the SDs having defects may be restored by the data stored in the orphan cache of the NVRAM 1500.

When a request to read the pages included in the victim stripe occurs during the garbage collection operation, the RAID controller 1100B reads data corresponding to the pages requested to be read from the orphan cache of the NVRAM 1500.

The RAID controller 1100B may perform the flowcharts of FIGS. 38-40 by using the program codes stored in the RAM 1200.

An operation corresponding to a mapping table distributing and managing method which is performed by the RAID controller 1100B is the same as that of the RAID controller 1100A of FIG. 1, and thus, detailed descriptions thereof will be omitted here.

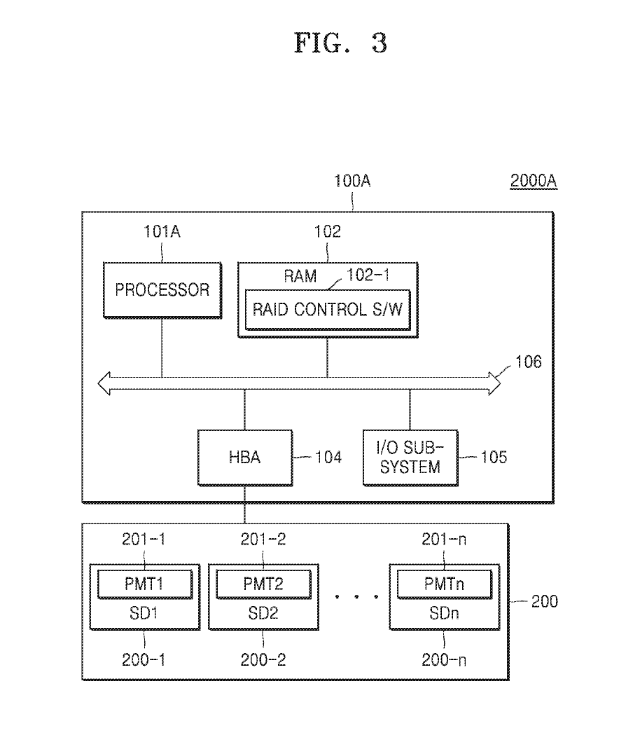

FIG. 3 is a block diagram of a storage system 2000A according to another exemplary embodiment of the inventive concept.

Referring to FIG. 3, the storage system 2000A may include a processor 101A, a RAM 102, a host bus adaptor (HBA) 104, an input/output (I/O) sub-system 105, a bus 106, and devices 200. In FIG. 3, a block including the processor 101A, the RAM 102, the HBA 104, the I/O sub-system 105, and the bus 106 is a host 100A, for example, and the devices 200 may be external devices connected to the host 100A.

For example, the storage system 2000A may be assumed to be a server. As another example, the storage system 2000A may be a personal computer (PC), a set-top-box, a digital camera, a navigation device, a mobile device, or the like. For example, the devices 200 that are connected to the host 100A may include first through n-th SDs 200-1 through 200-n.

The processor 101A may include a circuit, interfaces, or a program code for processing data and controlling operations of the components of the storage system 2000A. For example, the processor 101A may include a central processing unit (CPU), an advanced risk machine (ARM) processor, or an application specific integrated circuit (ASIC).

The RAM 102 is a volatile memory, and may include SRAM or DRAM, which stores data, commands, or program codes which are necessary for operations of the storage system 2000A. The RAM 102 functions as a main memory. The RAM 102 stores RAID control SW 102-1. The RAID control software 102-1 includes program codes for controlling the storage system 2000A according to a log-structured RAID method. For example, the RAID control software 102-1 may include program codes for performing an operation illustrated in the flowcharts of FIGS. 38-40.

The processor 101A controls operations of the storage system 2000A according to the log-structured RAID method by using the program codes stored in the RAM 102. For example, the processor 101A drives the RAID control software 102-1 stored in the RAM 102 to perform a mapping table managing method, a write operation controlling method, and a read operation controlling method as illustrated in FIGS. 38-40.

The HBA 104 connects the first through n-th SDs 200-1 through 200-n to the host 100A of the storage system 2000A. For example, the HBA 104 may include a small computer system interface (SCSI) adaptor, a fiber channel adaptor, a serial advanced technology attachment (ATA) adaptor, or the like. In detail, the HBA 104 may be directly connected to the first through n-th SDs 200-1 through 200-n, which are based on a fiber channel (FC) HBA. The HBA 104 may interface the host 100A with the first through n-th SDs 200-1 through 200-n by being connected to the first through n-th SDs 200-1 through 200-n in a storage area network (SAN) environment.

The I/O sub-system 105 may include a circuit, interfaces, or a program code capable of operating to perform data communication between the components of the storage system 2000A. The I/O sub-system 105 may include at least one standardized bus and at least one bus controller. Accordingly, the I/O sub-system 105 may recognize devices connected to the bus 106, list the devices connected to the bus 106, and allocate or deallocate resources for various devices connected to the bus 106. In other words, the I/O sub-system 105 may operate to manage communications on the bus 106. For example, the I/O sub-system 105 may be a peripheral component interconnect express (PCIe) system, and may include a PCIe root complex and at least one PCIe switch or bridge.

The first through n-th SDs 200-1 through 200-n may be implemented by using SSDs or HDDs. According to an exemplary embodiment of the inventive concept, the first through n-th SDs 200-1 through 200-n are SSDs.

A plurality of pieces of PMT information 201-1 through 201-n are distributed into and stored in the first through n-th SDs 200-1 through 200-n, respectively. For example, a RAID-Level mapping table is divided into the plurality of pieces of PMT information 201-1 through 201-n, and the plurality of pieces of PMT information 201-1 through 201-n are distributed into and stored in the first through n-th SDs 200-1 through 200-n, respectively.

Mapping information for the storage system 2000A is divided into the plurality of pieces of PMT information 201-1 through 201-n based on an initially-set criterion, and the plurality of pieces of PMT information 201-1 through 201-n are distributed into and stored in the first through n-th SDs 200-1 through 200-n, respectively. Since the plurality of pieces of PMT information 201-1 through 201-n are substantially the same as the plurality of pieces of PMT information 1301-1 through 1301-n of FIG. 1, an operation of distributing and storing the plurality of pieces of PMT information 201-1 through 201-n into and in the first through n-th SDs 200-1through 200-n will not be repeated here.

Each of the first through n-th SDs 200-1 through 200-n includes a RAM region and a flash memory region. The plurality of pieces of PMT information 201-1 through 201-n are distributed into and stored in respective RAM regions of the first through n-th SDs 200-1 through 200-n. In other words, the plurality of pieces of PMT information 201-1 through 201-n are stored in the respective RAM regions of the first through n-th SDs 200-1 through 200-n, respectively.

After a certain time period or after a write operation is completed, the plurality of pieces of PMT information distributed into and stored in the RAM regions of the first through n-th SDs 200-1 through 200-n are backed up in the flash memory regions of the first through n-th SDs 200-1 through 200-n.

For example, during a write operation, the first through n-th SDs 200-1 through 200-n write header information including the volume identification information VolumeID and the virtual address Vaddr, together with data, to the flash memory regions thereof.

When one of the first through n-th SDs 200-1 through 200-n is defective, the processor 101A restores the plurality of pieces of PMT information by using the PMT information backed up in the flash memory regions of the first through n-th SDs 200-1 through 200-n and the header information stored together with the data in the flash memory regions thereof. Various methods of restoring PMT information will be described in detail later with reference to FIGS. 25-31.

The processor 101A may perform the flowcharts of FIGS. 38-40 by using the program codes stored in the RAM 102.

The processor 101A transmits a read command or a write command to the first through n-th SDs 200-1 through 200-n.

For example, the processor 101A generates a write command including the volume identification information VolumeID, the virtual address Vaddr, the stripe identification information StripeID, and the physical address Paddr. The processor 101A transmits a write command Write (VolumeID, Vaddr, StripeID, Paddr) to the i-th SD 200-i in which the PMT information 201-i corresponding to the volume identification information VolumeID and the virtual address Vaddr included in the write command is stored, and to the j-th SD 200-j in which the physical address Paddr exists.

For example, the processor 101A generates a read command including the volume identification information VolumeID and the virtual address Vaddr. The processor 101A transmits a first read command VRead (VolumeID, Vaddr) to the i-th SD 201-i in which the PMT information 201-i corresponding to the volume identification information VolumeID and the virtual address Vaddr included in the read command is stored.

For example, when receiving information (StripeID, Paddr) from the i-th SD 200-i, the processor 101A transmits a second read command PRead (StripeID, Paddr) including the received information (StripeID, Paddr) to the j-th SD 200-j in which the physical address Paddr exists.

Each of the first through n-th SDs 200-1 through 200-n may perform a write operation or a read operation according to the flowcharts of FIGS. 41-43.

For example, the i-th SD 200-i from among the first through n-th SDs 200-1 through 200-n performs a write operation as follows.

In response to the write command Write (VolumeID, Vaddr, StripeID, Paddr), the i-th SD 200-i determines whether PMT information corresponding to information (VolumeID, Vaddr) included in a write command is stored therein. If it is determined that the PMT information corresponding to the information (VolumeID, Vaddr) included in the write command is stored in the i-th SD 200-i, the i-th SD 200-i performs an update operation by adding, to the PMT information PMTi, mapping information about a storage location in which data writing is to be performed based on the write command

The i-th SD 200-i also determines whether the physical address Paddr included in the write command exists therein. If it is determined that the physical address Paddr included in the write command exists in the i-th SD 200-i, the i-th SD 200-i searches for a storage location corresponding to information (StripeID, Paddr) by using the PMT information PMTi and writes data received from the host 100A to a found storage location.

For example, the i-th SD 200-i or the j-th SD 200-j from among the first through n-th SDs 200-1 through 200-n performs a read operation as follows.

In response to the first read command VRead (VolumeID, Vaddr), the i-th SD 200-i searches for information (StripeID, Paddr) corresponding to information (VolumeID, Vaddr) included in the first read command by using the PMT information 201-i.

If a found physical address Paddr exists in the i-th SD 200-i, the i-th SD 200-i searches for a storage location corresponding to found information (StripeID, Paddr) by using the PMT information 201-i. Then, the i-th SD 200-i reads data from the found storage location and transmits the read data to the host 100A.

On the other hand, if the found physical address Paddr does not exist in the i-th SD 200-i, the i-th SD 1300-i transmits the found information (StripeID, Paddr) to the host 100A.

Then, in response to the second read command PRead (StripeID, Paddr), the j-th SD 200-j searches for a storage location corresponding to the found information (StripeID, Paddr) by using PMT information 201-j. Then, the j-th SD 200-j reads data from the found storage location and transmits the read data to the host 100A.

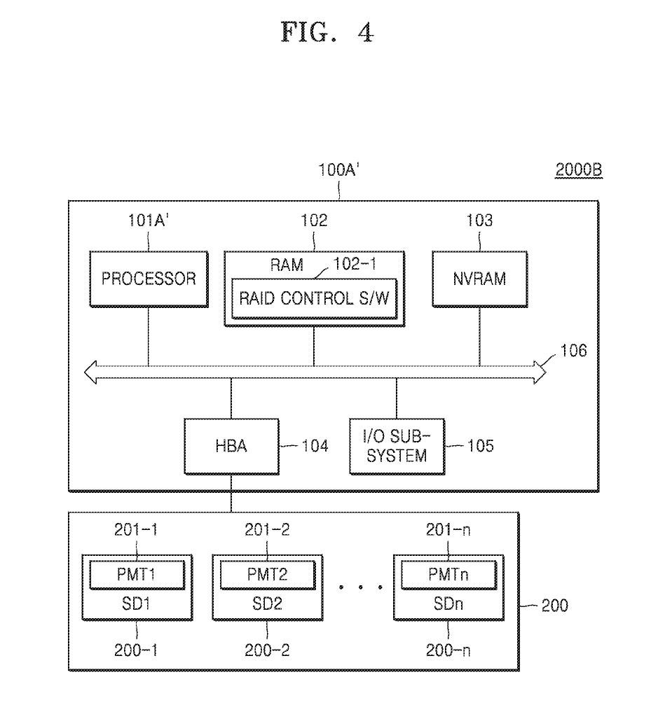

FIG. 4 is a block diagram of a storage system 2000B according to another exemplary embodiment of the inventive concept. Referring to FIG. 4, the storage system 2000B may include a processor 101A′, a RAM 102, an NVRAM 103, an HBA 104, an I/O sub-system 105, a bus 106, and devices 200.

In FIG. 4, a block including the processor 101A′, the RAM 102, the NVRAM 103, the HBA 104, the I/O sub-system 105, and the bus 106 is a host 100A′, for example, and the devices 200 may be external devices connected to the host 100A′.

The storage system 2000B of FIG. 4 may additionally include the NVRAM 103, unlike the storage system 2000A of FIG. 3. The other components of the storage system 2000B of FIG. 4 are the same as those of the storage system 2000A of FIG. 3.

The NVRAM 103 is a RAM in which stored data is retained if power is removed. For example, the NVRAM 103 may be implemented by using PRAM, FeRAM, or MRAM. An another example, the NVRAM 103 may be implemented according to a method of applying power to DRAM or SRAM, which is volatile memory, by using a battery or a capacitor. In other words, when system power is cut off, the DRAM or SRAM is driven by the battery or the capacitor, and thus data may be retained by moving data stored in the DRAM or SRAM to an SD which is a non-volatile storage space. According to this method, even when system power is removed, data stored in the DRAM or SRAM may be retained.

The NVRAM 103 may include a cache that stores data that is not protected temporarily by parity information during a garbage collection operation. For example, a cache for storing data that is to be written in units of stripes to the first through n-th SDs 200-1 through 200-n may be allocated to the NVRAM 103.

The processor 101A′ copies, into the NVRAM 103, valid pages of the first through n-th SDs 200-1 through 200-n that are included in the victim stripe for garbage collection, and controls a garbage collection operation by using data copied into the NVRAM 103. In detail, the processor 101A′ copies, into an orphan cache of the NVRAM 103, the valid pages of the first through n-th SDs 200-1 through 200-n that are included in the victim stripe for garbage collection.

The processor 101A′ erases a memory block that is included in the victim stripe and stores parity information from among the respective memory blocks of the first through n-th SDs 200-1 through 200-n, copies the valid pages included in the victim stripe into memory blocks that are to define a new stripe, and erases the memory blocks of the victim stripe, in which the valid pages copied into the memory blocks that are to define the new stripe were stored.

The processor 101A′ may perform the flowcharts of FIGS. 38-40 by using the program codes stored in the RAM 102. An operation corresponding to a mapping table managing method which is performed by the processor 101A′ is the same as that of the processor 101A of FIG. 3, and thus, detailed descriptions thereof will be omitted here.

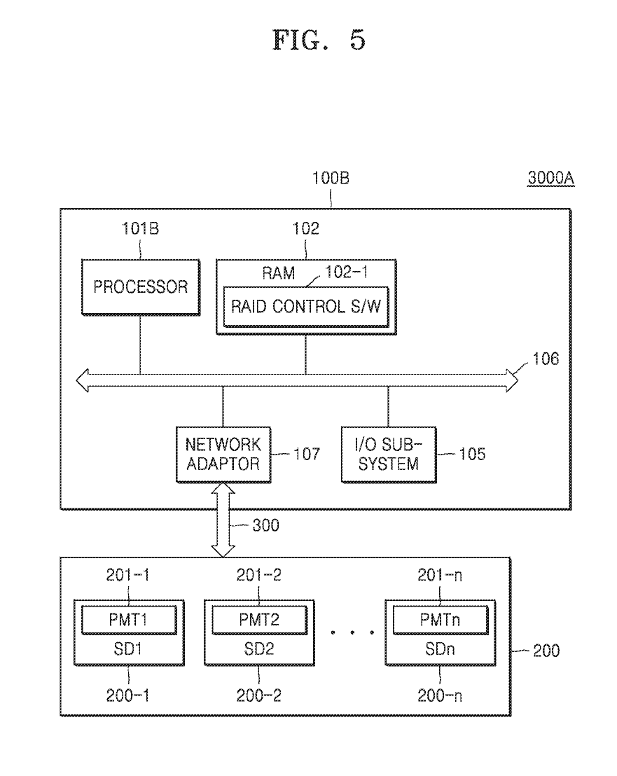

FIG. 5 is a block diagram of a storage system 3000A according to another exemplary embodiment of the inventive concept. Referring to FIG. 5, the storage system 3000A includes a host 100B, devices 200, and a link unit 300.

The host 100B includes a processor 101B, a RAM 102, a network adaptor 107, an I/O sub-system 105, and a bus 106. For example, the host 100B may be assumed to be a server. In another example, the host 100B may be a PC, a set-top-box, a digital camera, a navigation device, a mobile device, or the like.

Since the RAM 102, the I/O sub-system 105, the bus 106, and the first through n-th SDs 200-1 through 200-n included in the host 100B have already been described above with reference to the storage system 2000A of FIG. 3, repeated descriptions thereof will be omitted here.

The network adaptor 107 may be combined with the devices 200 via the link unit 300. For example, the link unit 300 may include copper wiring, fiber optic cabling, at least one wireless channel, or a combination thereof.

The network adaptor 107 may include a circuit, interfaces, or a code capable of operating to transmit and receive data according to at least one networking standard. For example, the network adaptor 107 may communicate with the devices 200 according to at least one Ethernet standard.

The devices 200 may include the first through n-th SDs 200-1 through 200-n. For example, the first through n-th SDs 200-1 through 200-n may be implemented by using SSDs or HDDs. According to an exemplary embodiment of the inventive concept, the first through n-th SDs 200-1 through 200-n are SSDs.

The processor 101B may include a circuit, interfaces, or a program code for processing data and controlling operations of the components of the storage system 3000A. For example, the processor 101B may include a central processing unit (CPU), an advanced risk machine (ARM) processor, or an application specific integrated circuit (ASIC).

The processor 101B controls operations of the storage system 2000B according to the log-structured RAID method by using the program codes stored in the RAM 102. For example, the processor 101B drives the RAID control software 102-1 stored in the RAM 102 to perform a mapping table managing method, a write operation controlling method, and a read operation controlling method as illustrated in FIGS. 38-40.

An operation corresponding to a mapping table managing method which is performed by the processor 101B is the same as that of the processor 101A of FIG. 3, and thus, detailed descriptions thereof will be omitted here.

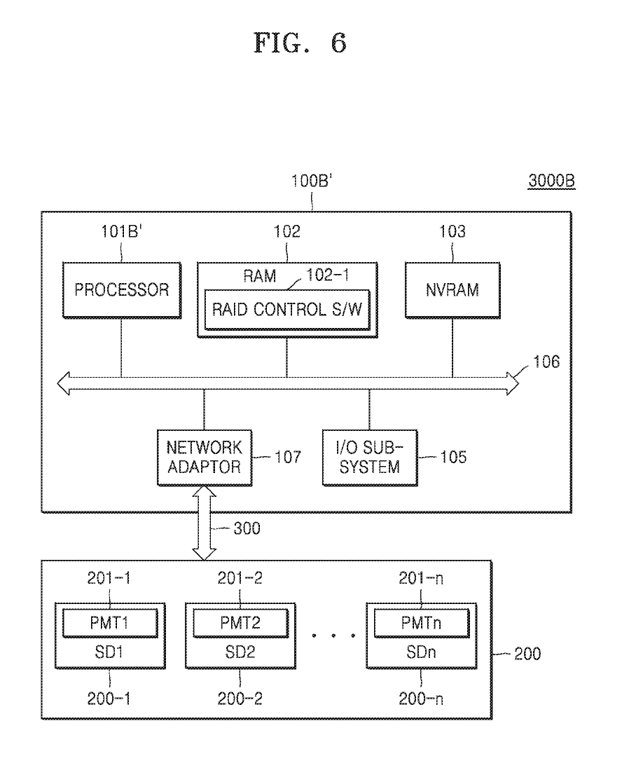

FIG. 6 is a block diagram of a storage system 3000B according to another exemplary embodiment of the inventive concept. Referring to FIG. 6, the storage system 3000B includes a host 100W, devices 200, and a link unit 300.

The host 100B′ includes a processor 101B′, a RAM 102, a network adaptor 107, an I/O sub-system 105, and a bus 106. For example, the host 100B′ may be assumed to be a server. In another example, the host 100B′ may be a PC, a set-top-box, a digital camera, a navigation device, a mobile device, or the like.

The storage system 3000B of FIG. 6 may additionally include the NVRAM 103, unlike the storage system 3000A of FIG. 5. The other components of the storage system 3000B of FIG. 6 are the same as those of the storage system 3000A of FIG. 5.

The processor 101B′ copies, into the NVRAM 103, valid pages of the first through n-th SDs 200-1 through 200-n that are included in the victim stripe for garbage collection, and controls a garbage collection operation by using data copied into the NVRAM 103. In detail, the processor 101B′ copies, into an orphan cache of the NVRAM 103, the valid pages of the first through n-th SDs 200-1 through 200-n that are included in the victim stripe for garbage collection.

The processor 101B′ erases a memory block that is included in the victim stripe and stores parity information from among the respective memory blocks of the first through n-th SDs 200-1 through 200-n, copies the valid pages included in the victim stripe into memory blocks that are to define a new stripe, and erases the memory blocks of the victim stripe, in which the valid pages copied into the memory blocks that are to define the new stripe were stored.

The processor 101B′ may perform the flowcharts of FIGS. 38-40 by using the program codes stored in the RAM 102. An operation corresponding to a mapping table managing method which is performed by the processor 101B′ is the same as that of the processor 101A of FIG. 3, and thus, detailed descriptions thereof will be omitted here.

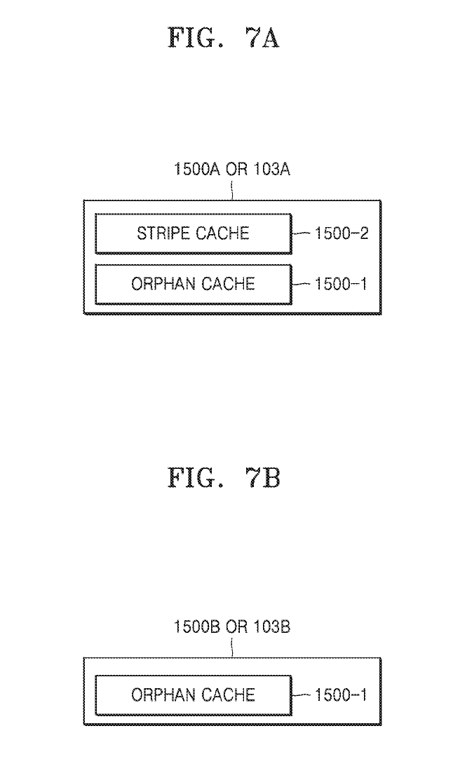

FIGS. 7A and 7B show various examples of setting storage regions in the NVRAM 1500 or 103 shown in FIGS. 2, 4, and 6.

Referring to FIG. 7A, an orphan cache 1500-1 and a stripe cache 1500-2 are allocated to an NVRAM 1500A or 103A according to an exemplary embodiment. The orphan cache 1500-1 stores orphan data that is not protected temporarily by parity information during garbage collection. The stripe cache 1500-2 temporarily stores data that is to be written to SDs in units of stripes.

Referring to FIG. 7B, an orphan cache 1500-1 may be allocated to an NVRAM 1500B or 103B according to another exemplary embodiment.

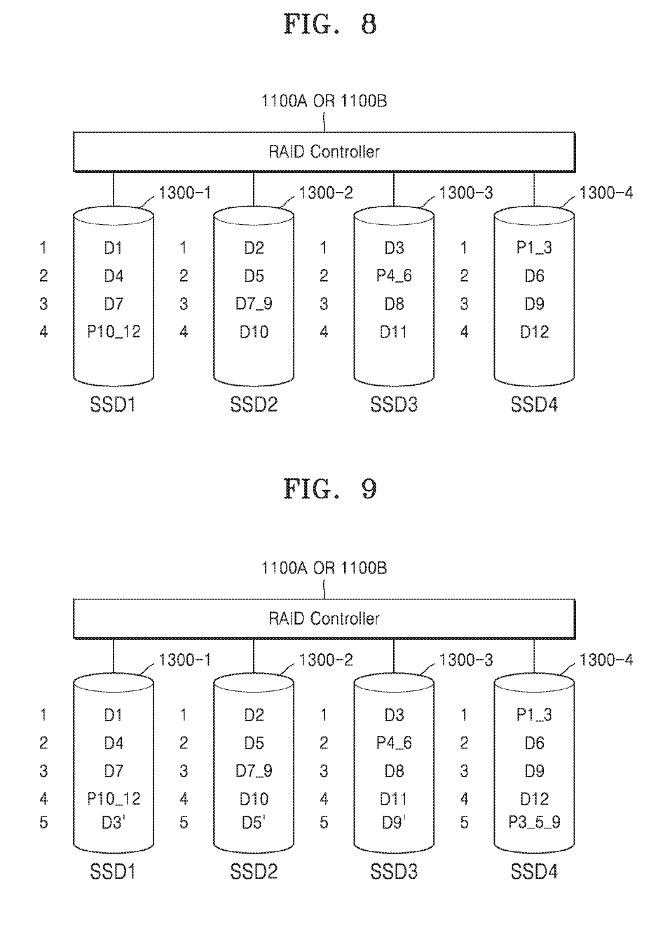

FIG. 8 is a conceptual view illustrating a write operation according to a parity-based RAID method in a storage system according to an exemplary embodiment of the inventive concept.

For convenience of description, FIGS. 8 and 9 show the RAID controller 1100A or 1100B and the SDs (for example, four SSDs, namely, first through fourth SSDs 1300-1 through 1300-4), which are the main elements of the storage system 1000A or 1000B shown in FIG. 1 or 2.

For reference, in the storage system 2000A, 2000B, 3000A, or 3000B shown in FIG. 3-6, the processor 101A, 101A′, 101B, or 101B′ may perform operations of the RAID controller 1100A or 1100B. The four SSDs may be indicated by reference numerals 1300-1 to 1300-4.

FIG. 8 shows an example in which a parity-based RAID method is applied to the first through fourth SSDs 1300-1 through 1300-4. Parity information with respect to each of pieces of data having the same addresses is stored in one of the first to fourth SSDs 1300-1 to 1300-4. For example, the parity information may be a result obtained by performing an XOR calculation with respect to the value of each of the data pieces having the same addresses. Even if one piece of data from among the pieces of data having the same addresses is lost, the lost data may be restored by using the parity information and the other pieces of data. According to the above principle, even if one of the SSDs is damaged, the data stored in the SSD may be restored.

Referring to FIG. 8, pieces of data are sequentially stored in the first through fourth SSD 1300-1 through 1300-4. For example, parity information P1_3 for data D1 through data D3 is stored in the fourth SSD 1300-4. Parity information P4_6 for data D4 through data D6 is stored in the third SSD 1300-3, parity information P7_9 for data D7 to data D9 is stored in the second SSD 1300-2, and parity information P10_12 for data D10 to data D12 is stored in the first SSD 1300-1.

It is assumed that the second SSD 1300-2 is defective. In this case, the data D2 in a first memory block of the second SSD 1300-2 may be restored by using a value obtained by performing an XOR calculation on the data D1, the data D3, and the parity information P1_3, data D5 in a second memory block thereof may be restored by using a value obtained by performing an XOR calculation on the data D4, the D6, and the parity information P4_6, and the data D10 in a fourth memory block thereof may be restored by using a value obtained by performing an XOR calculation on the data D11, the data D12, and the parity information P10_12.

In such a parity-based RAID method, one small write-update operation may cause two read operations and two write operations, thereby degrading the entire I/O performance and accelerating abrasion of the SSDs.

In FIG. 8, it is assumed that the data D3 stored in the third SSD 1300-3 is updated. In this case, the parity information P1_3 for the data D3 also needs to be updated so as to ensure reliability of the data D3. Therefore, to write the data D3, existing data D3 is read and existing parity information P1_3 is read, and then, new data D3′ is XORed to generate new parity information P1_3′. Then, the new data D3′ and the new parity information P1_3′ are written to the data D3 and the parity information P1_3. As described above, a problem that one write operation is amplified to two read operations and two write operations is referred to as a read-modify-write problem.

According to one or more exemplary embodiments of the inventive concept, the read-modify-write problem may be addressed by using the log-structured RAID method. This will now be described in detail with reference to FIG. 9.

FIG. 9 is a conceptual view illustrating a log-structured RAID method in a storage system according to an exemplary embodiment of the inventive concept.

First, it is assumed that the storage system updates the data D3 with the data D3′ when data has been stored in the first to fourth SSDs 1300-1 to 1300-4 as illustrated in FIG. 8. In this case, the new data D3′ is not overwritten at a first address of the third SSD 1300-3, in which the data D3 has already been written, but is written at a fifth address of the first SSD 1300-1, which is a new location in the first SSD 1300-1. Similarly, new data D5′ and new data D9′ are written in the log format at new locations without being overwritten at the addresses where the data D5 and the data D9 have respectively already been written. When write operations with respect to the new data D3′, the new data D5′, and the new data D9′, which define one stripe, are completed, parity information P3_5_9 about the new data D3′, the new data D5′, and the new data D9′ defining one stripe is written to the fourth SSD 1300-4.

When the above-described updating process according to the log-structured RAID method is completed, the first to fourth SSDs 1300-1 to 1300-4 store updated data and updated parity information as shown in FIG. 9.

A case where the first to fourth SSDs 1300-1 to 1300-4 independently perform a garbage collection operation will now be described below.

For example, it will be assumed that the data D3 that becomes invalid when the data D3′ is written has been deleted from the third SSD 1300-3 through a garbage collection operation, and then, the second SSD 1300-2 is defective. Then, to restore the data D2 stored in the second SSD 1300-2, the data D1 stored in the first SSD 1300-1, the data D3 stored in the third SSD 1300-3, and the parity information P1_3 stored in the fourth SSD 1300-4 are necessary. However, since the data D3 was deleted from the third SSD 1300-3 through a garbage collection operation, restoration of the data D2 is impossible.

According to exemplary embodiments of the inventive concept, to address this problem, the garbage collection operation is performed in units of stripes. For example, the data D1, the data D2, the data D3, and the parity information P1_3 defining one stripe are processed through one garbage collection operation.

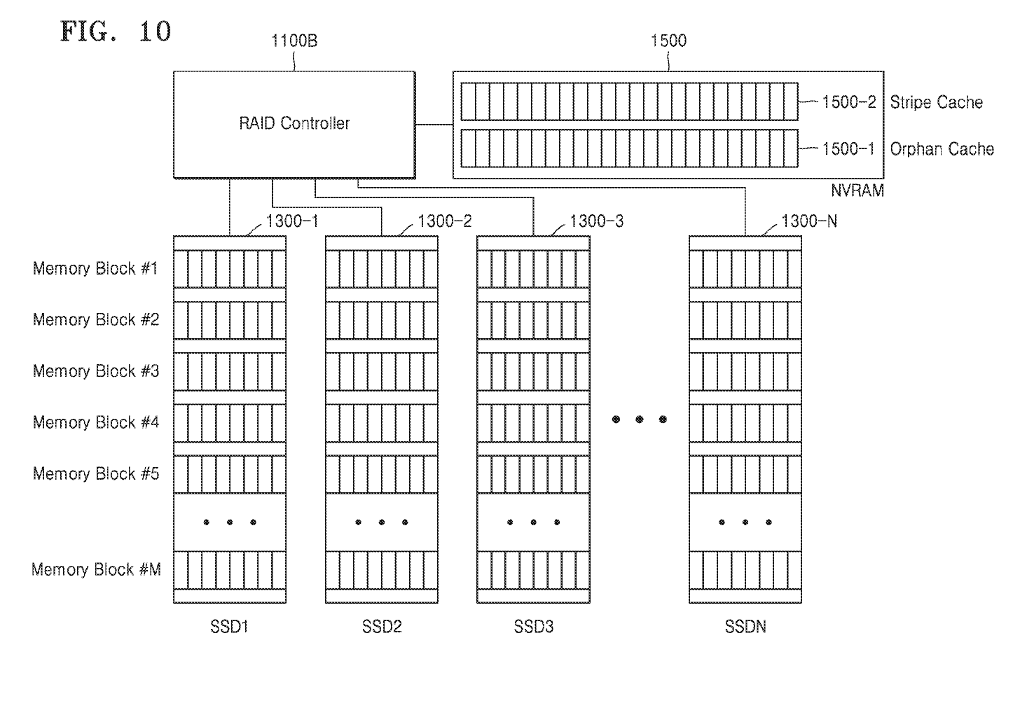

FIG. 10 is a block diagram illustrating an example of executing an SSD-based log-structured RAID method by using a NVRAM in a storage system, according to an exemplary embodiment of the inventive concept.

For convenience of description, FIGS. 10-16 show the RAID controller 1100B and the SDs (for example, four SSDs, namely, first through fourth SSDs 1300-1 through 1300-4), which are the main elements of the storage system 1000B shown in FIG. 2.

For reference, in the storage system 2000B or 3000B shown in FIG. 4 or 6, the processor 101A′ or 101B′ may perform operations of the RAID controller 1100B. The four SSDs may be indicated by reference numerals 1300-1 to 1300-4.

For example, first through N-th SSDs 1300-1 through 1300-N each include a plurality of memory blocks, namely, M memory blocks. In an SSD, a read or write operation may be performed in units of pages, but an erase operation is performed in units of memory blocks. For reference, a memory block may also be referred to as an erase block. In addition, each of the M memory blocks includes a plurality of pages.

In FIG. 10, one memory block includes eight pages. However, embodiments of the inventive concept are not limited thereto, and one memory block may include a plurality of pages less than or greater than the eight pages.

In FIG. 10, the orphan cache 1500-1 and the stripe cache 1500-2 are allocated to the NVRAM 1500.

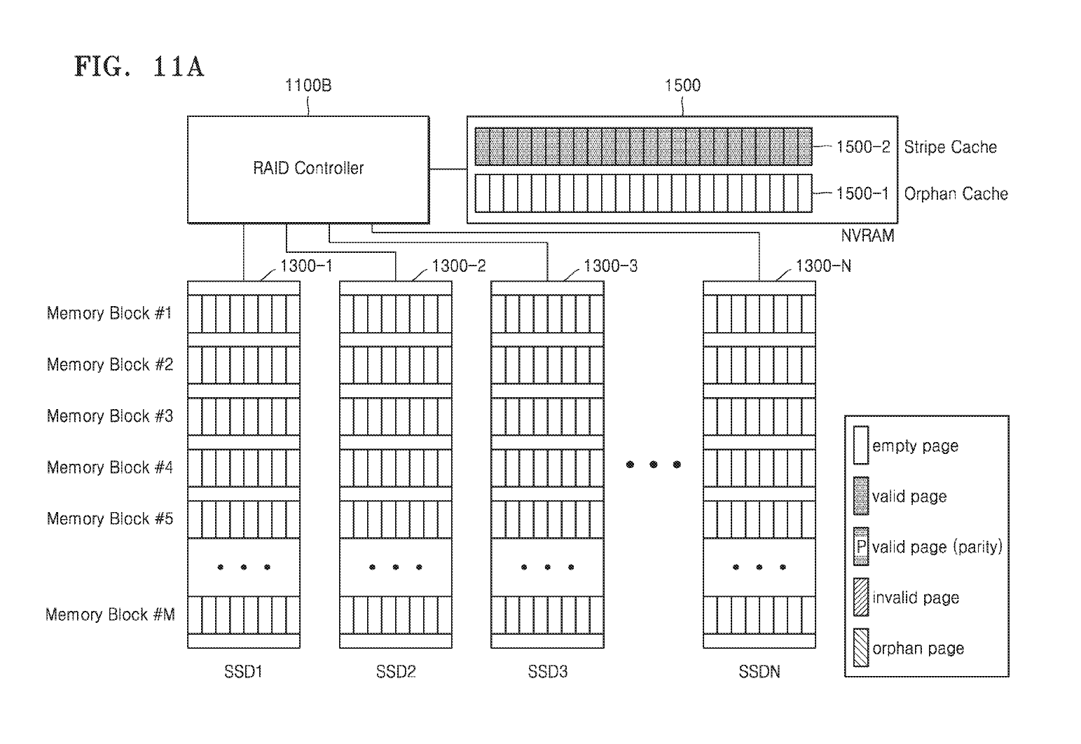

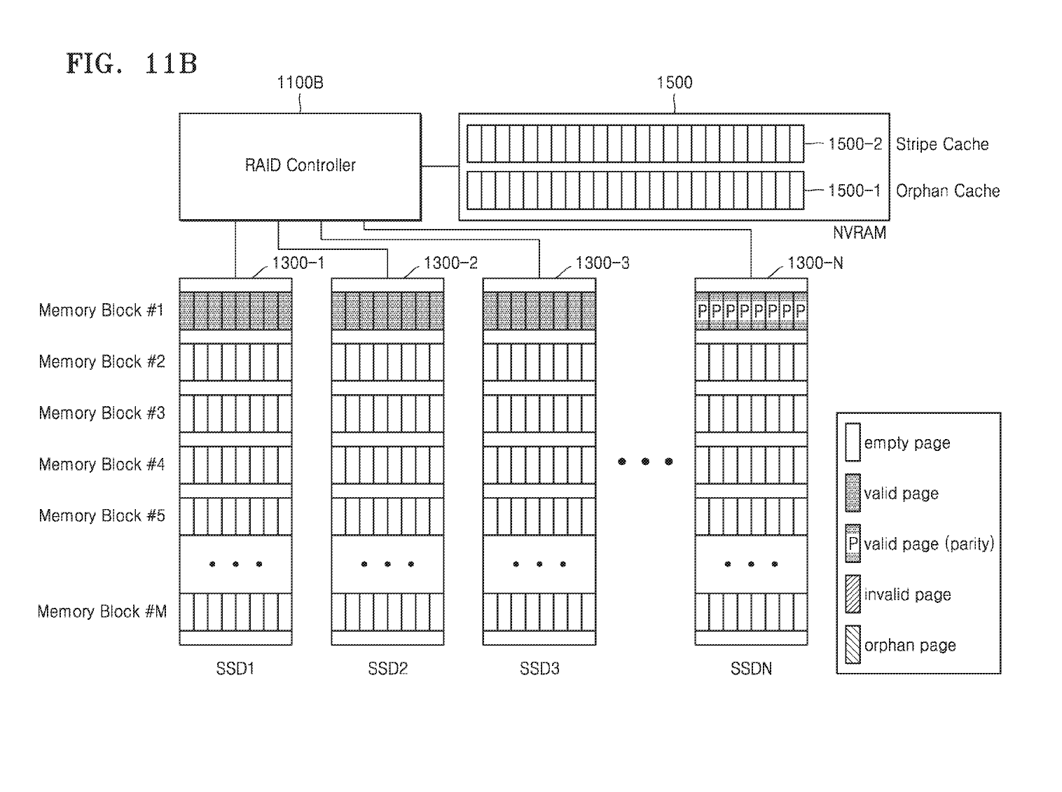

An example of performing a write operation by using the NVRAM according to the SSD-based log-structured RAID method in the storage system of FIG. 10 will now be described with reference to FIGS. 11A and 11B.

FIGS. 11A and 11B are conceptual diagrams illustrating a write operation performed in units of stripes in the storage system 1000B, according to an exemplary embodiment of the inventive concept.

When a write request occurs in the storage system 1000B, the RAID controller 1100B first stores data that is to be written, in the stripe cache 1500-2 of the NVRAM 1500. The data to be written is first stored in the stripe cache 1500-2 to write data of one full stripe, including parity information, in the first through N-th SSDs 1300-1 through 1300-N at one time. FIG. 11A shows an example in which data that is to be written in units of stripes is stored in the stripe cache 1500-2 of the NVRAM 1500.

Next, the RAID controller 1100B calculates parity information about the data stored in the stripe cache 1500-2. Thereafter, the RAID controller 1100B writes data of one full stripe, the data including calculated parity information and the data stored in the stripe cache 1500-2, to the first through N-th SSDs 1300-1 through 1300-N. In FIG. 11B, the data stored in the stripe cache 1500-2 is stored in memory blocks #1 in the first through (N-1)th SSDs 1300-1 through 1300-(N-1), and the parity information is stored in the N-th SSD 1300-N. In FIG. 11B, the memory blocks #1 respectively included in the first through N-th SSDs 1300-1 through 1300-N define a new stripe.

As described above, in the exemplary embodiment illustrated in FIGS. 11A and 11B, data corresponding to one full stripe is written at one time. According to this method, parity information corresponding to the size of a memory block may be collected and calculated at once, and thus, fragmented write & parity calculation may be prevented. However, a stripe cache space that is as large as the size of one full stripe needs to be secured, and an excessively large number of simultaneous write I/Os and parity calculation overhead may be generated.

According to another exemplary embodiment of the inventive concept, data may be written to the first through N-th SSDs 1300-1 through 1300-N in units of memory blocks. According to another exemplary embodiment of the inventive concept, data may be written to the first through N-th SSDs 1300-1 through 1300-N in units of pages.

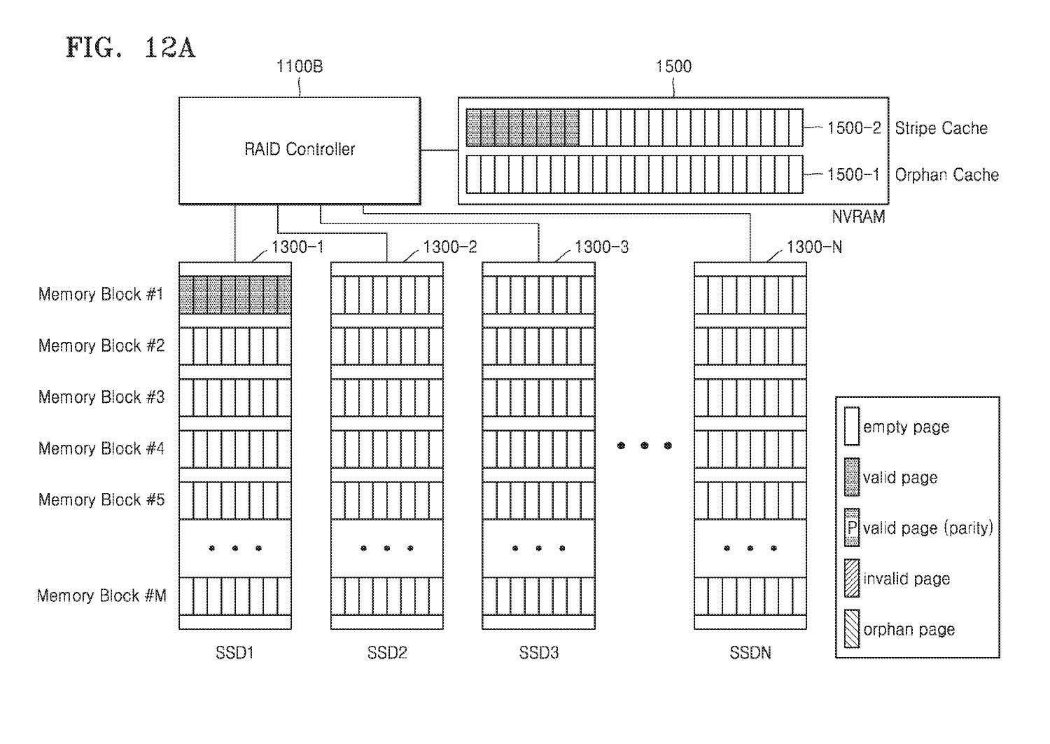

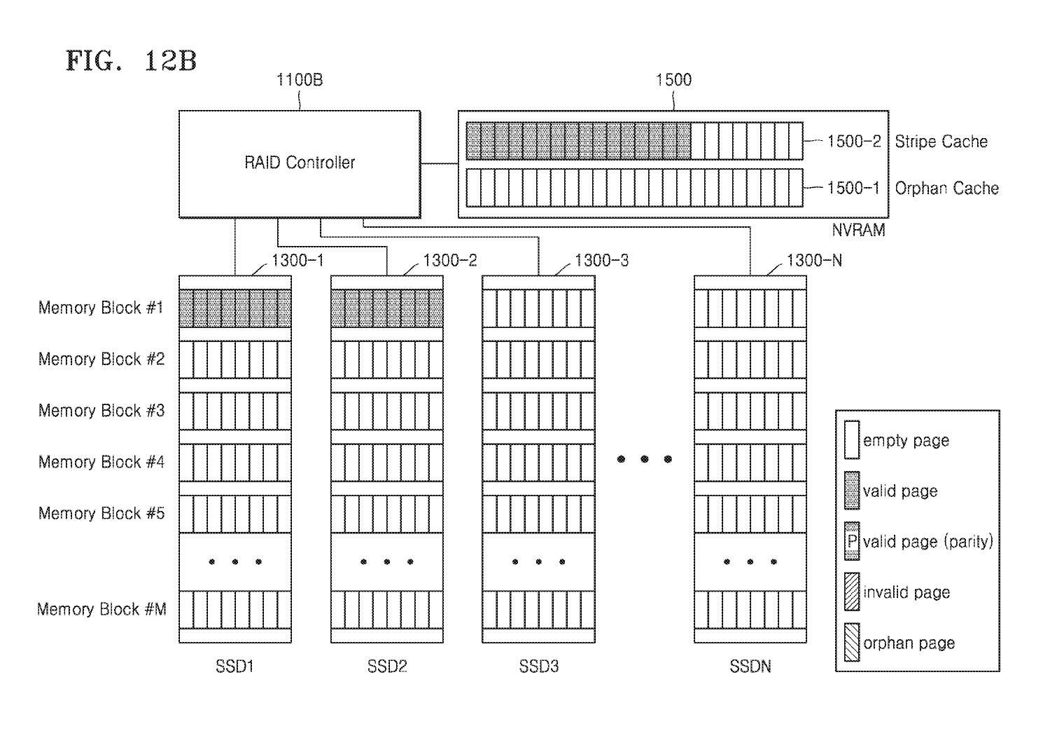

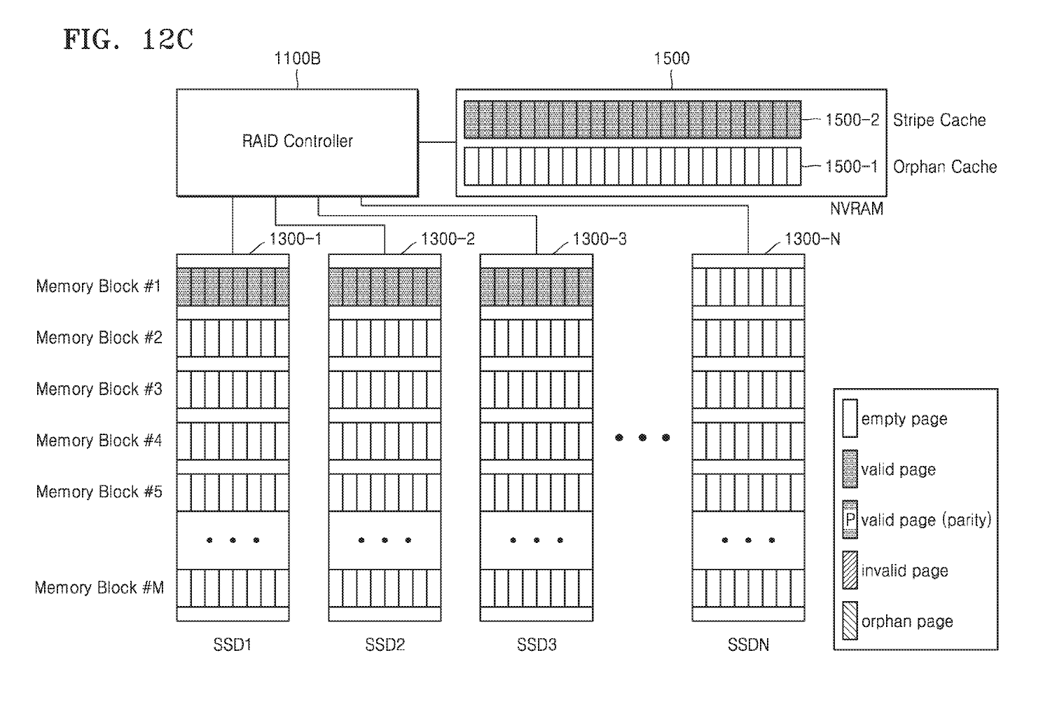

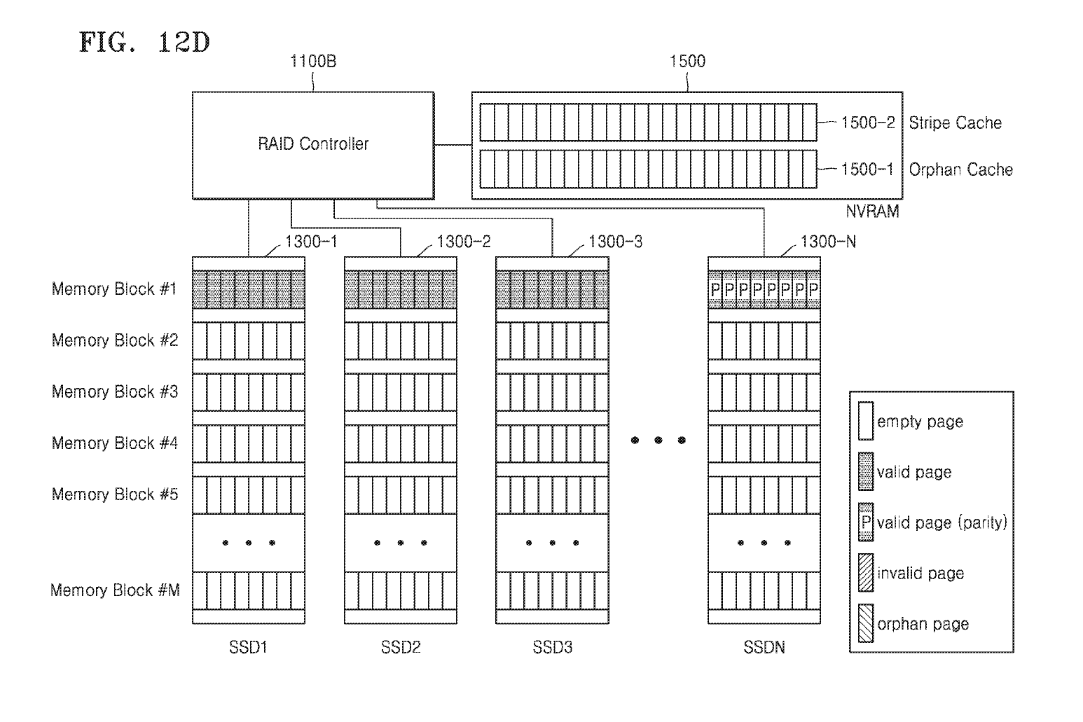

FIGS. 12A-12D are conceptual diagrams illustrating a data storing process in an example of writing data to SDs in units of memory blocks in a storage system according to an exemplary embodiment of the inventive concept.

The RAID controller 1100B sequentially stores data that is to be written, in the NVRAM 1500. When pieces of data that are together equivalent to the size of one memory block are initially collected in the NVRAM 1500, the RAID controller 1100B reads the data from the NVRAM 1500 and writes the read data in a memory block #1 of the first SSD 1300-1, which is empty. Accordingly, as shown in FIG. 12A, data is stored in the NVRAM 1500 and the first through N-th SSDs 1300-1 through 1300-N.

Next, when pieces of data that are together equivalent to the size of one memory block are secondly collected in the NVRAM 1500, the RAID controller 1100B reads the secondly-collected data from the NVRAM 1500 and writes the read data to a memory block #1 of the second SSD 1300-2, which is empty. Accordingly, as shown in FIG. 12B, data is stored in the NVRAM 1500 and the first through N-th SSDs 1300-1 through 1300-N.

Next, when pieces of data that are together equivalent to the size of one memory block are thirdly collected in the NVRAM 1500, the RAID controller 1100B reads the thirdly-collected data from the NVRAM 1500 and writes the read data to a memory block #1 of the third SSD 1300-3, which is empty. Accordingly, as shown in FIG. 12C, data is stored in the NVRAM 1500 and the first through N-th SSDs 1300-1 through 1300-N.

After sequentially writing data to the first through (N-1)th SSDs 1300-1 through 1300-(N-1), defining one stripe, in the above-described manner, the RAID controller 1100B calculates parity information about the data that is stored in the NVRAM 1500 and defines one stripe, and writes the calculated parity information to a memory block #1 of the N-th SSDN 1300-N. Thereafter, the RAID controller 1100B performs a flush operation for emptying the NVRAM 1500. Accordingly, as shown in FIG. 12D, data is stored in the NVRAM 1500 and the first through N-th SSDs 1300-1 through 1300-N.

As described above, in the method of writing data in units of memory blocks, data may be written to each SSD in units of memory blocks. However, a stripe cache space that is as large as the size of one full stripe may need to be secured, and an excessively large number of write I/Os per one time and parity calculation overhead may be generated.

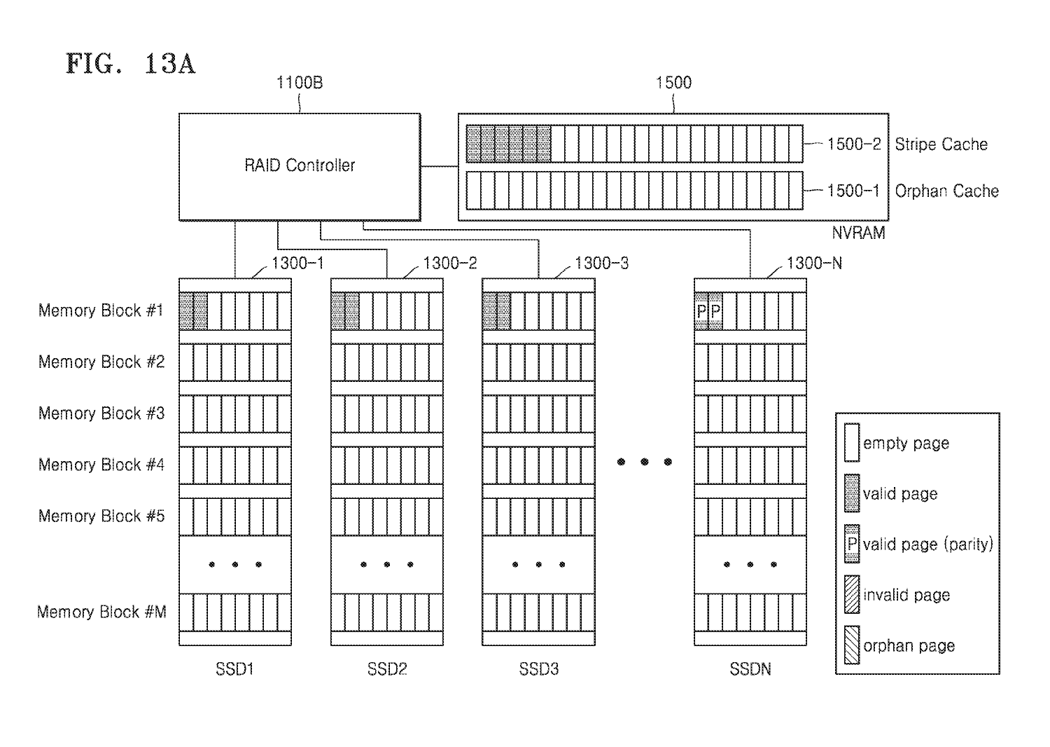

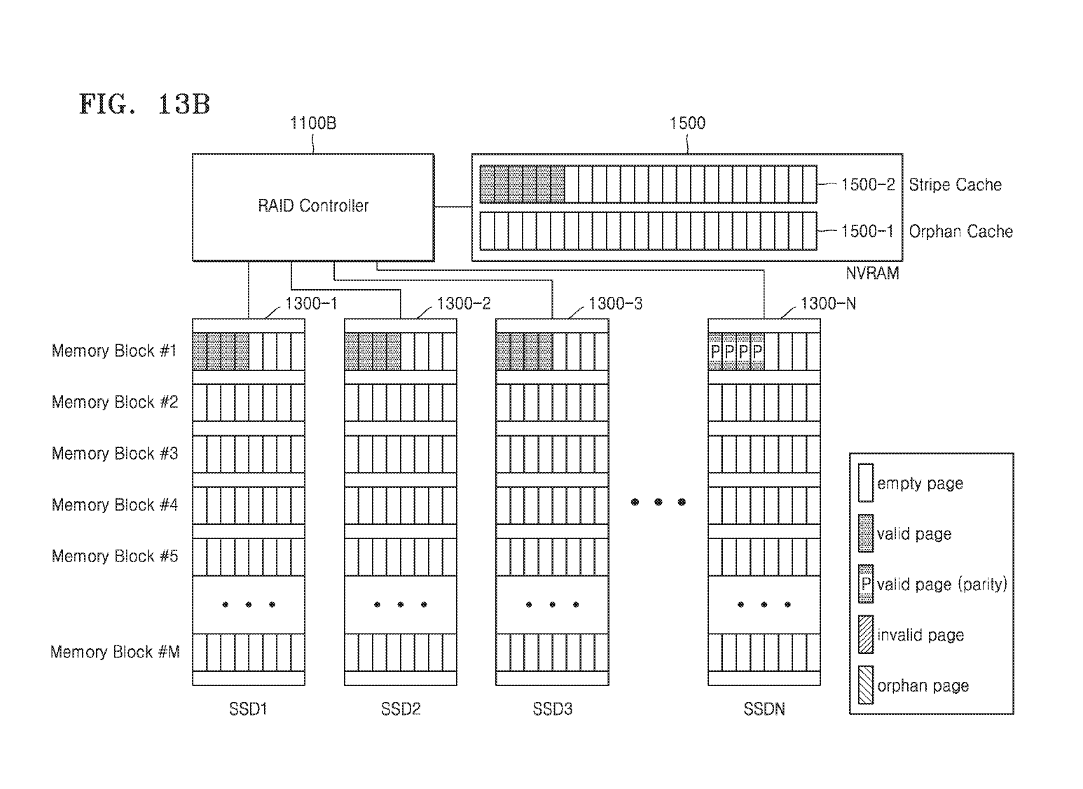

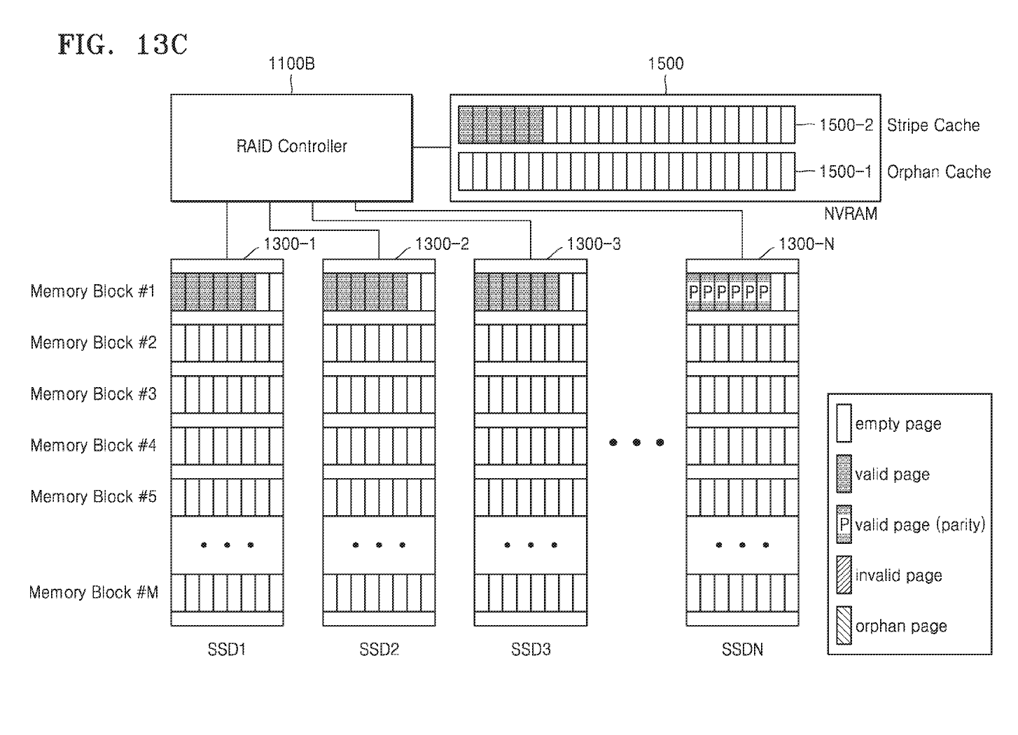

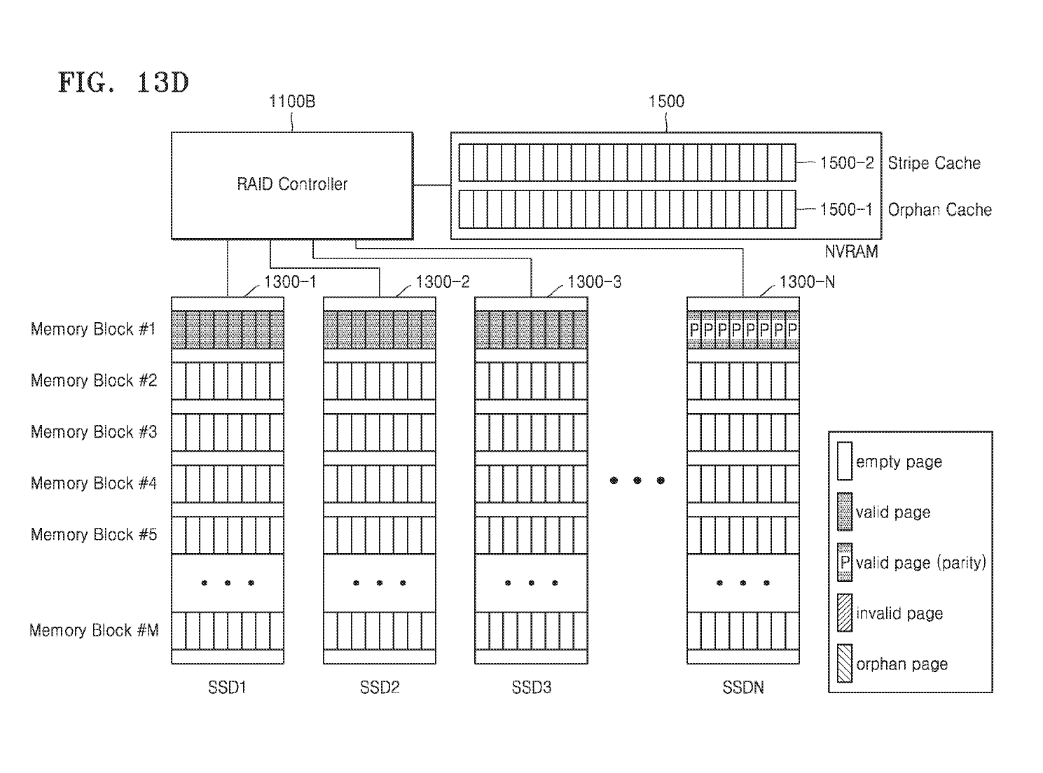

FIGS. 13A-13D are conceptual diagrams illustrating a data storing process in an example of writing data to SDs in units of pages in a storage system according to an exemplary embodiment of the inventive concept.

The RAID controller 1100B sequentially stores data that is to be written, in the NVRAM 1500. When data having a sufficient size to calculate parity information is collected in the NVRAM 1500, the RAID controller 1100B reads the collected data from the NVRAM 1500 and writes the read data to the memory blocks #1 of the first through Nth SSDs 1300-1 through 1300-N in units of pages. For example, the size of data sufficient to calculate parity information may be (N-1) pages obtained by subtracting 1 from N, which is the number of SSDs defining one stripe.

Then, the RAID controller 1100B calculates parity information about the data stored in the NVRAM 1500, and writes the calculated parity information to a first page of the memory block #1 of the N-th SSD 1300-N, which is empty. After writing the data and the parity information to the first through N-th SSDs 1300-1 through 1300-N, the RAID controller 1100B may flush the data from the NVRAM 1500.

As another example, when data that is K times (where K is an integer equal to or greater than 2) the data size sufficiently enough to calculate parity information is collected in the NVRAM 1500, the RAID controller 1100B may read the collected data from the NVRAM 1500 and write the read data to the memory blocks #1 of the first through Nth SSDs 1300-1 through 1300-N in units of pages. For example, if the value of K is 2, data corresponding to two pages may be written to each of the memory blocks of the SSDs, which define one stripe.

FIGS. 13A-13D show that data of two pages and parity information about the data are sequentially stored in each of the memory blocks #1 of the first through N-th SSDs, which define one stripe.

As described above, in the method of writing data in units of pages, since parity information may be calculated in units of pages, the parity calculation load to be performed at one time may be reduced, and there is no need to secure a stripe cache space corresponding to one full stripe. However, a write operation may not be performed on each SSD in units of memory blocks.

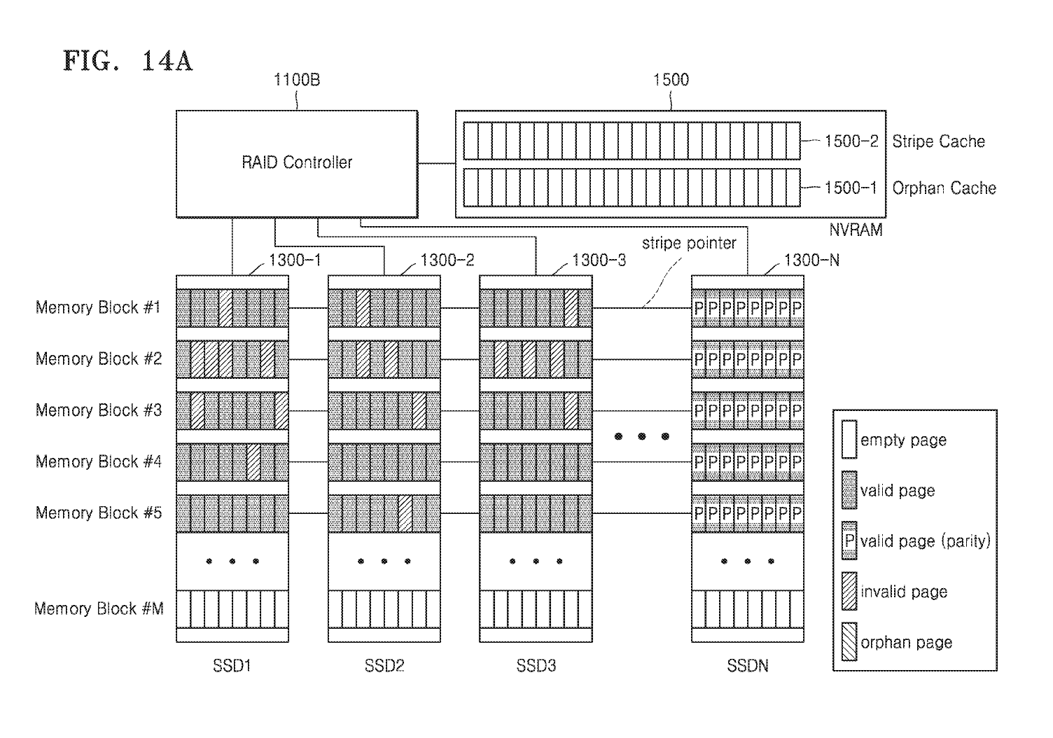

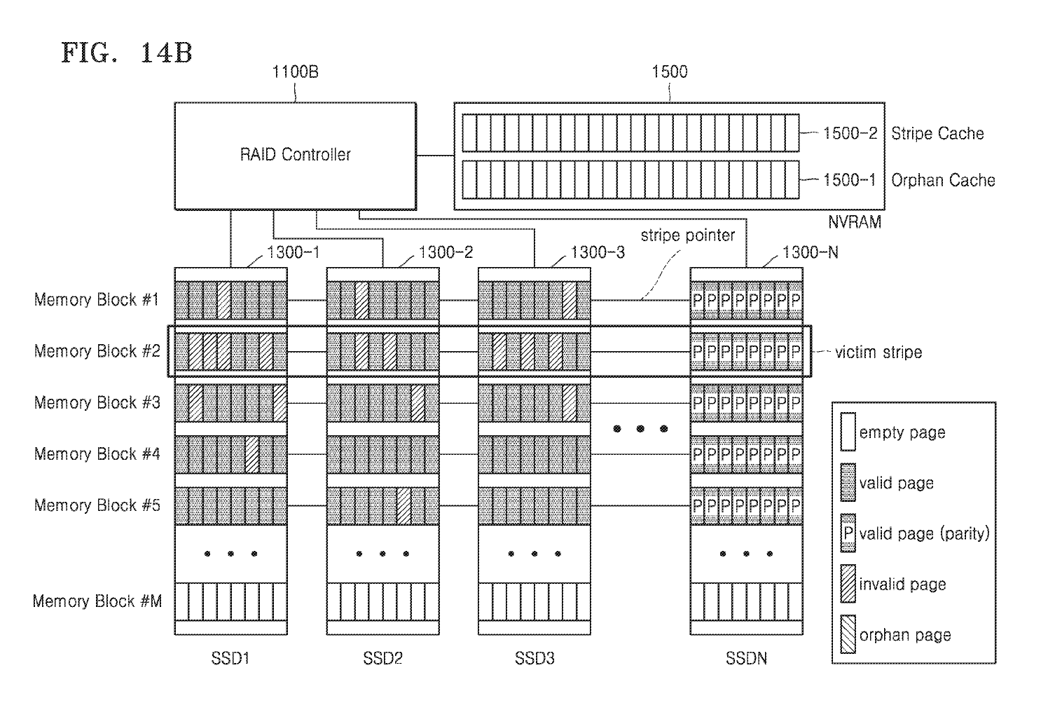

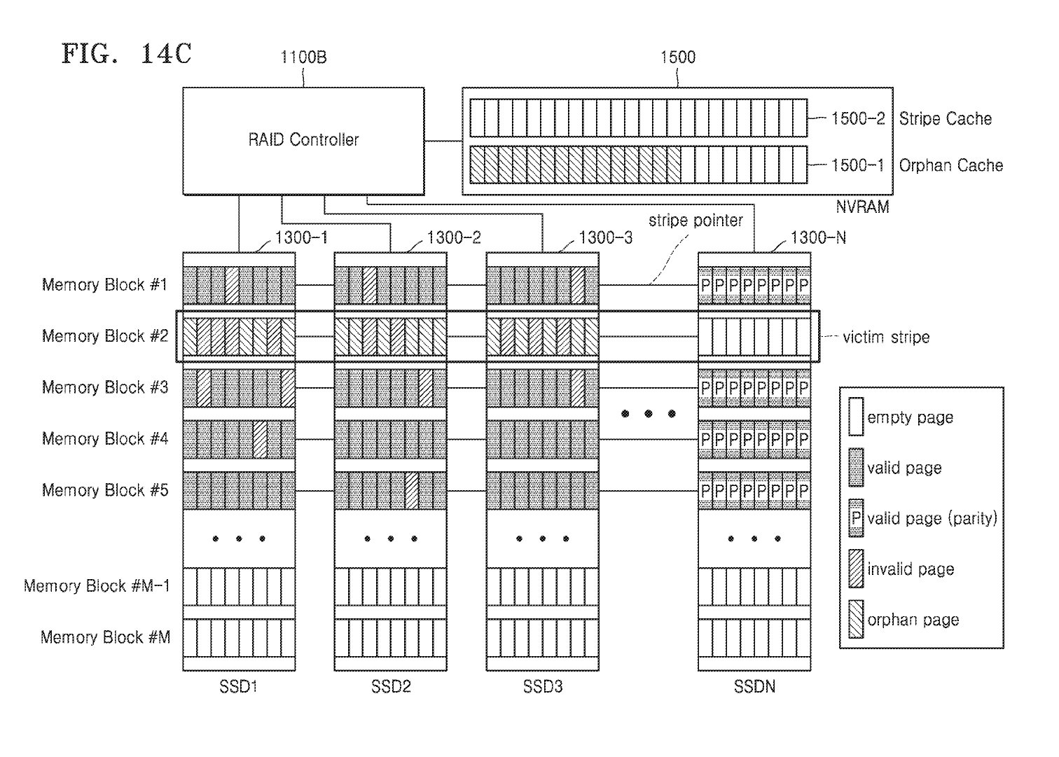

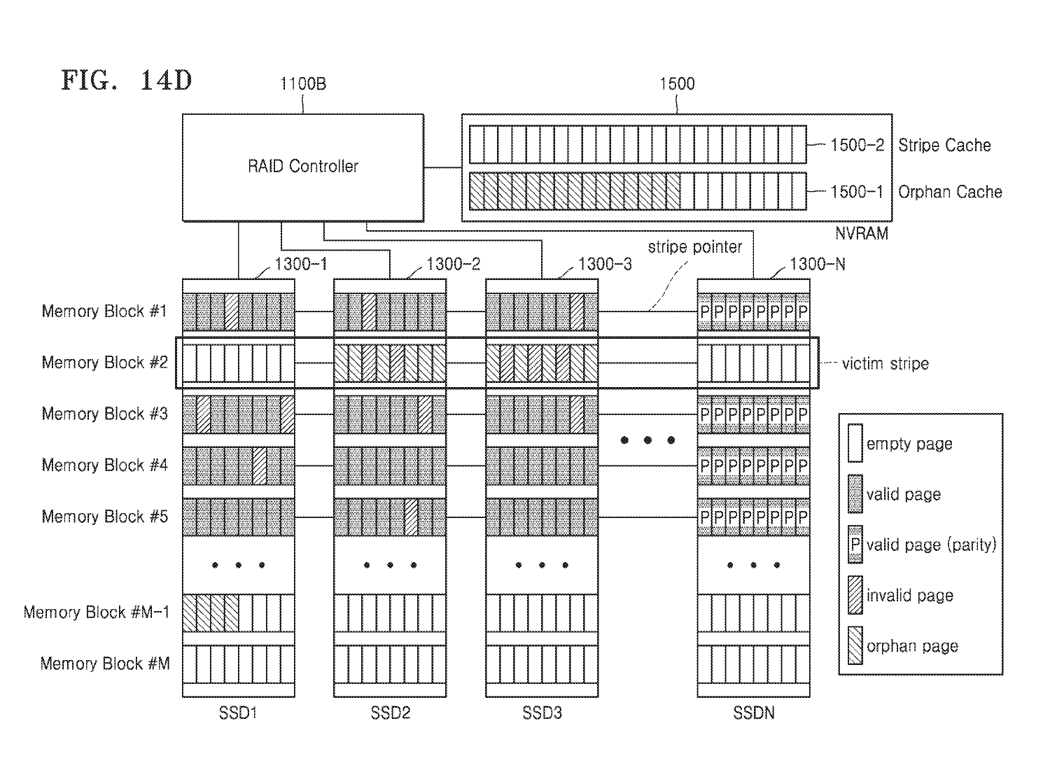

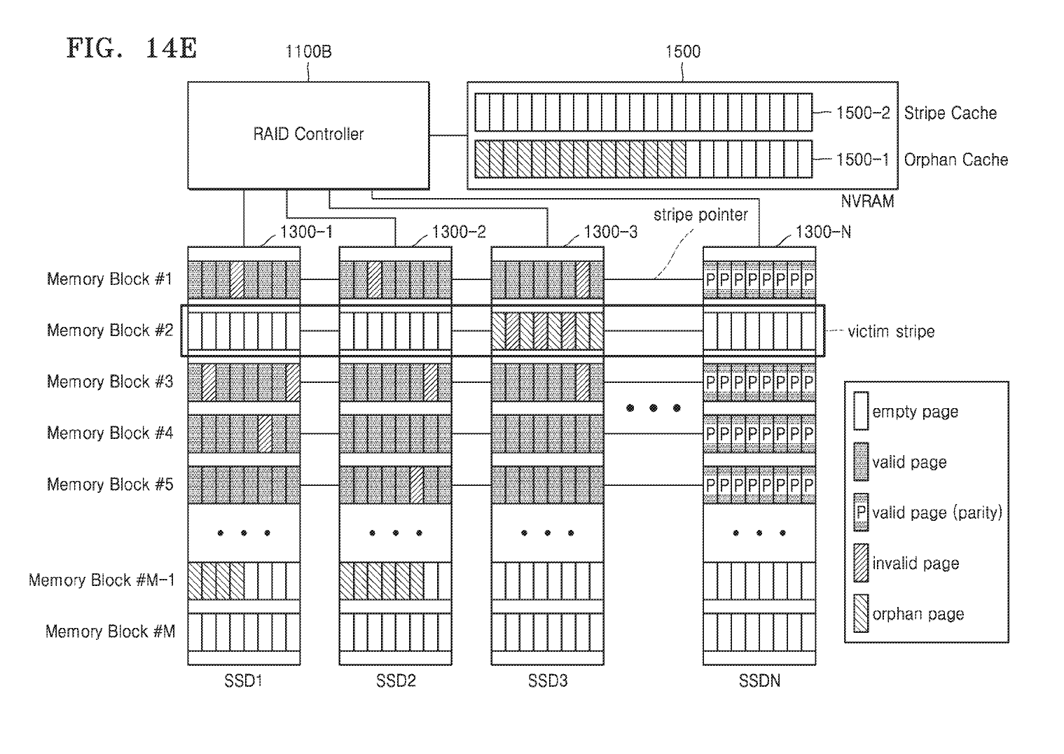

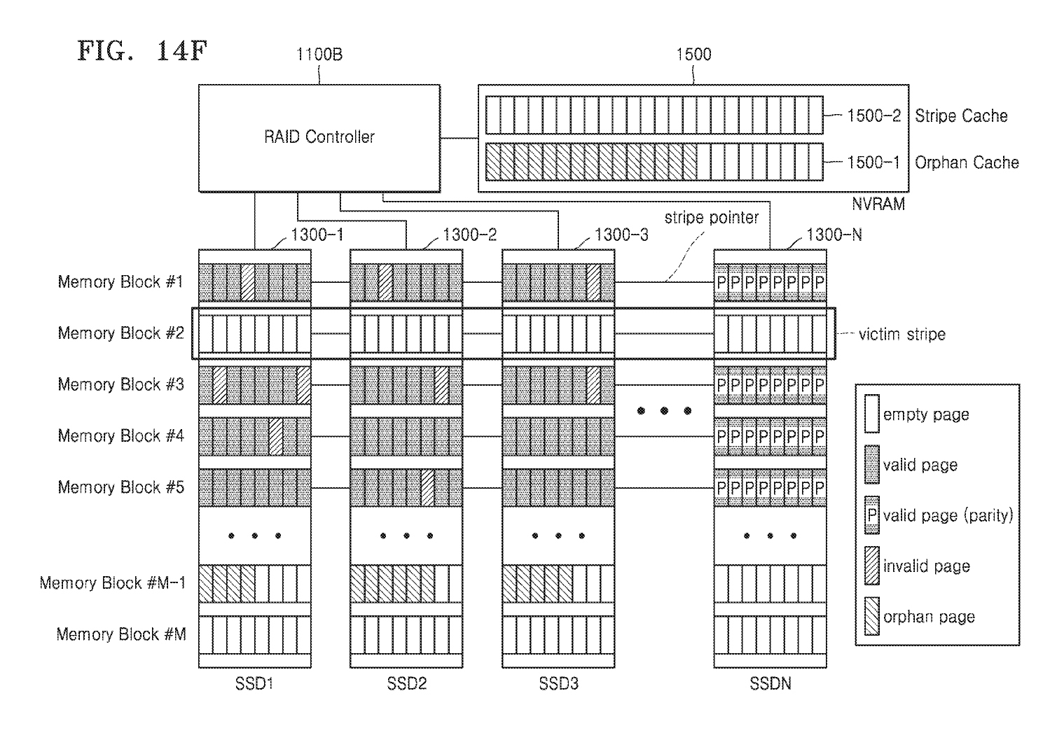

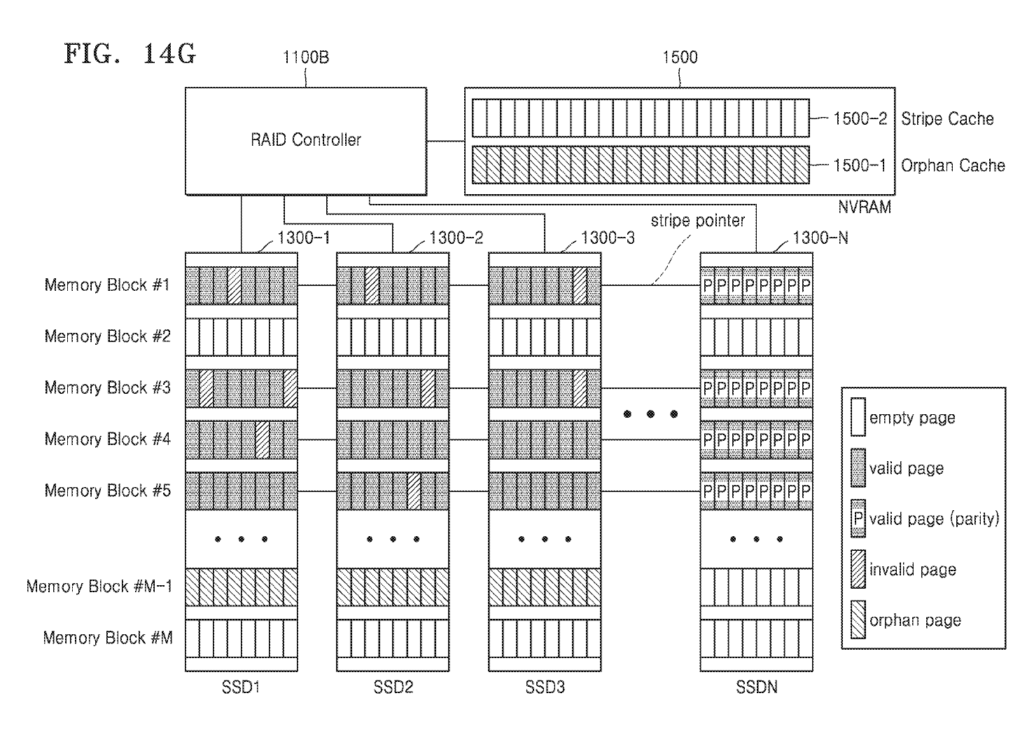

FIGS. 14A-14H are conceptual diagrams illustrating a garbage collection operation in a storage system according to an exemplary embodiment of the inventive concept. FIG. 14A illustrates an example in which data has been stored in the first through N-th SSDs 1300-1 through 1300-N according to a write operation performed in a storage system.

In the storage system, when a new write operation is performed with respect to the same logical address, existing data already stored at the logical address becomes invalid data, and thus a page in which the invalid data is stored is represented as an invalid page. In addition, memory blocks in the first through N-th SSDs 1300-1 through 1300-N, which define one stripe, are connected to one another by a stripe pointer. Accordingly, in which stripe a memory block in each SSD is included may be recognized by using the stripe pointer. The stripe pointer may be generated by the above-described stripe mapping table.

When a write operation is performed in the storage system, a garbage collection operation is necessary for securing a new storage space. In the storage system according to the present exemplary embodiment of the inventive concept, the garbage collection operation is performed in units of stripes.

When a request for garbage collection is generated in the storage system, the RAID controller 1100B selects a victim stripe that is a target of the garbage collection. For example, a stripe having the highest invalid page ratio may be selected as the victim stripe. In other words, a stripe having the lowest valid page ratio may be selected as the victim stripe.

If a request for garbage collection occurs in the storage system when data has been stored in the first through N-th SSDs 1300-1 through 1300-N as shown in FIG. 14A, a stripe that is at a second place from the top and has a highest invalid page ratio is selected as the victim stripe as shown in FIG. 14B.

After selecting the victim stripe as shown in FIG. 14B, the RAID controller 1100B copies the valid pages included in the victim stripe into the orphan cache 1500-1 of the NVRAM 1500. After finishing the copying process, the RAID controller 1100B erases parity information from the victim stripe. A data storage state of the first through N-th SSDs 1300-1 through 1300-N and a data storage state of the NVRAM 1500 after the erasure is completed are as shown in FIG. 14C. Accordingly, the orphan cache 1500-1 stores data of pages that are not protected temporarily by the parity information. A valid page that is not protected temporarily by parity information is referred to as an orphan page, and data stored in the orphan page is referred to as orphan data.

Referring to FIG. 14C, although the parity information included in the victim stripe is deleted, the data of all the valid pages included in the victim stripe is stored in the orphan cache 1500-1, and thus, reliability of the data may be ensured.

If a request to read the valid pages included in the victim stripe occurs during garbage collection, the RAID controller 1100B directly reads the orphan pages requested to be read from the orphan cache 1500-1 of the NVRAM 1500. In other words, the RAID controller 1100B directly reads the orphan pages from the orphan cache 1500-1 of the NVRAM 1500 without reading the orphan pages from the first through N-th SSDs 1300-1 through 1300-N. Accordingly, in response to the request for reading the valid pages of the victim stripe during garbage collection, data reading may be performed with a low latency by using the NVRAM 1500.

Next, the RAID controller 1100B copies the valid pages included in the victim stripe into memory blocks which are to define a new stripe. For example, the valid pages of a memory block included in a victim stripe may be copied into another memory block that is included in the SSD storing the valid pages of the former memory block and that is used to define a new stripe. As another example, the valid pages included in the victim stripe may be evenly distributed and copied into memory blocks that are to define a new stripe.

For example, the above-described memory blocks that are to define a new stripe may be allocated as a storage region for copying the valid pages included in the victim stripe for garbage collection. In other words, the RAID controller 1100B manages memory blocks such that data according to a normal write operation is not mixed in the memory blocks that are to define a new stripe and are allocated to copy the valid pages during garbage collection.

For example, an operation in which the valid pages of a memory block included in the victim stripe are copied into another memory block that is included in the SSD storing the valid pages of the former memory block and that is used to define a new stripe will now be described.

The RAID controller 1100B copies orphan pages located in a memory block #2 of the first SSD 1300-1 into a memory block #M-1 of the first SSD 1300-1. After that, the RAID controller 1100B performs an erase operation on the memory block #2 of the first SSD 1300-1. A data storage state of the first through N-th SSDs 1300-1 through 1300-N and a data storage state of the NVRAM 1500 after the erase operation is completed are as shown in FIG. 14D.

Similarly, the RAID controller 1100B copies orphan pages located in a memory block #2 of the second SSD 1300-2 into a memory block #M-1 of the second SSD 1300-2. After that, the RAID controller 1100B performs an erase operation on the memory block #2 of the second SSD 1300-2. A data storage state of the first through N-th SSDs 1300-1 through 1300-N and a data storage state of the NVRAM 1500 after the erase operation is completed are as shown in FIG. 14E.

The RAID controller 1100B copies orphan pages located in a memory block #2 of the third SSD 1300-3 into a memory block #M-1 of the third SSD 1300-3. After that, the RAID controller 1100B performs an erase operation on the memory block #2 of the third SSD 1300-3. A data storage state of the first through N-th SSDs 1300-1 through 1300-N and a data storage state of the NVRAM 1500 after the erase operation is completed are as shown in FIG. 14F.

According to an exemplary embodiment, the RAID controller 1100B manages memory blocks into which orphan pages are copied, such that the memory blocks are comprised of only orphan pages obtained by garbage collection. Orphan data is data that survives while invalid data initially stored together with the orphan data is being deleted through garbage collection. In other words, since the orphan data is proven to have a long data lifetime, it is inefficient to store the orphan data together with data according to a normal write operation in one memory block. Storing data having a similar data lifetime in one memory block is efficient to reduce or minimize an inter-valid-page copy operation during garbage collection.

When garbage collection is performed in this manner, the respective memory blocks #M-1 of the first through (N-1)th SSDs 1300-1 through 1300-(N-1) are filled with orphan data. A data storage state of the first through N-th SSDs 1300-1 through 1300-N and a data storage state of the NVRAM 1500, after this garbage collection is performed, are as shown in FIG. 14G.

Then, the RAID controller 1100B calculates parity information about the orphan data stored in the NVRAM 1500 and then writes the calculated parity information to a memory block #M-1 of the N-th SSDN 1300-N. After writing the parity information, the orphan data stored in the respective memory blocks #M-1 of the first through (N-1)th SSDs 1300-1 through 1300-(N-1) is converted into valid pages that are able to be protected by the parity information stored in the memory block #M-1 of the N-th SSDN 1300-N. The RAID controller 1100B generates a new stripe including the memory blocks #M-1 of the first through N-th SSDs 1300-1 through 1300-N, and registers location information of the memory blocks #M-1 defining the new stripe in the stripe mapping table. After writing the parity information, the RAID controller 1100B flushes the orphan data stored in the orphan cache 1500-1 of the NVRAM 1500. A data storage state of the first through N-th SSDs 1300-1 through 1300-N and a data storage state of the NVRAM 1500 after the flush operation is completed are as shown in FIG. 14H.

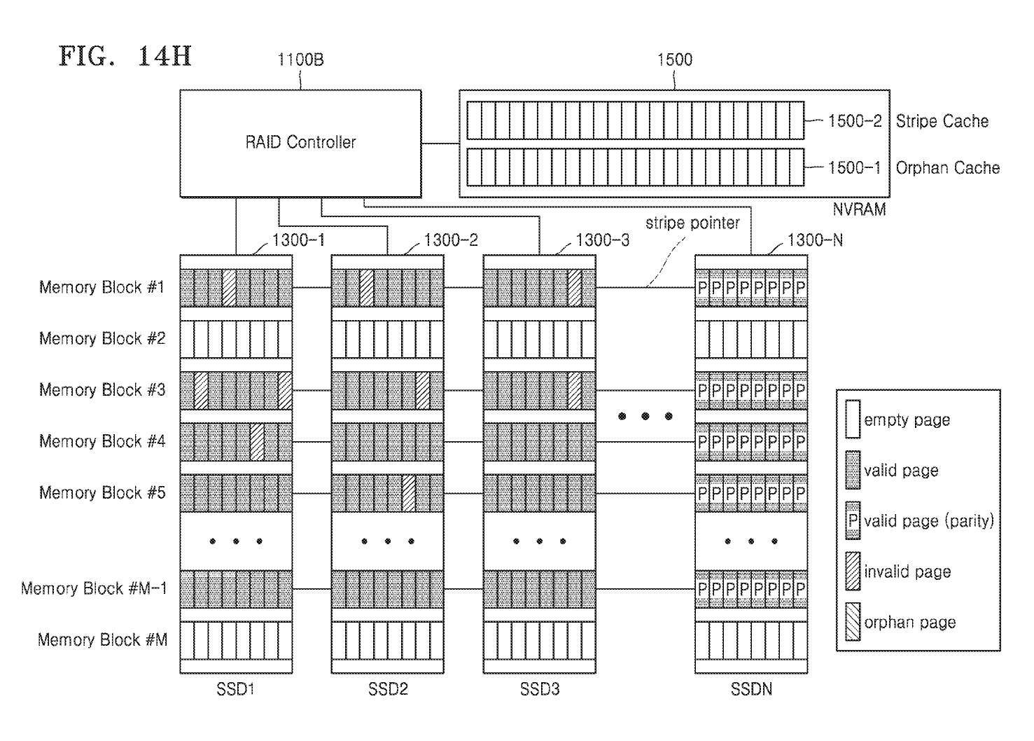

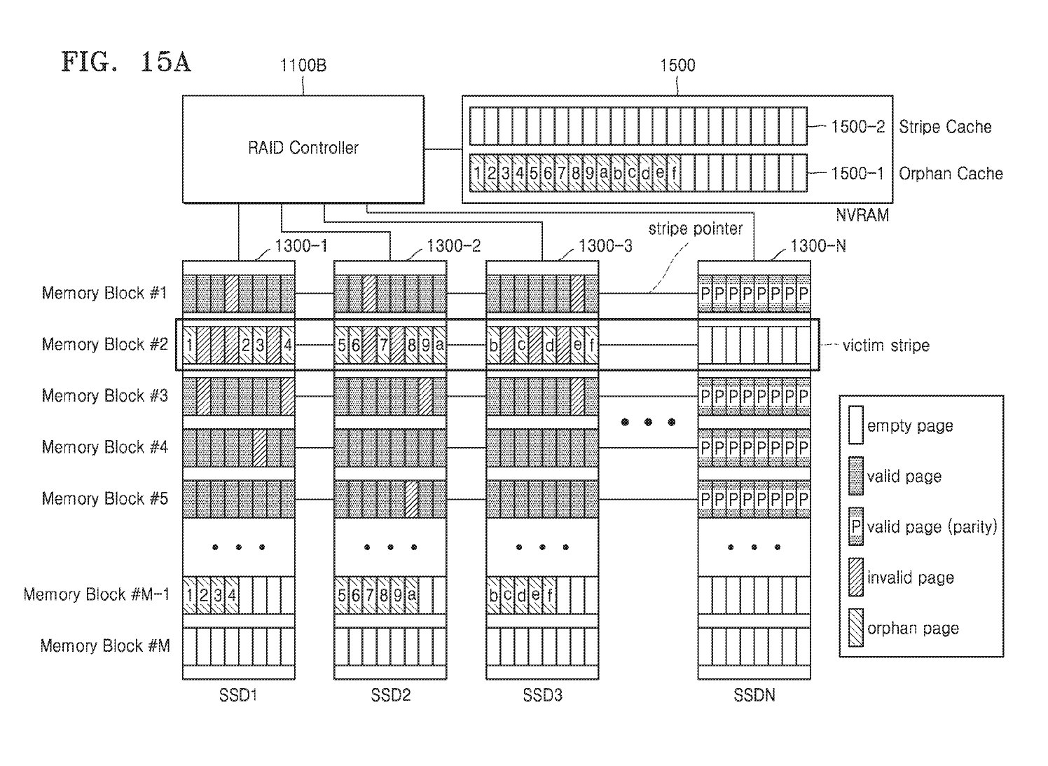

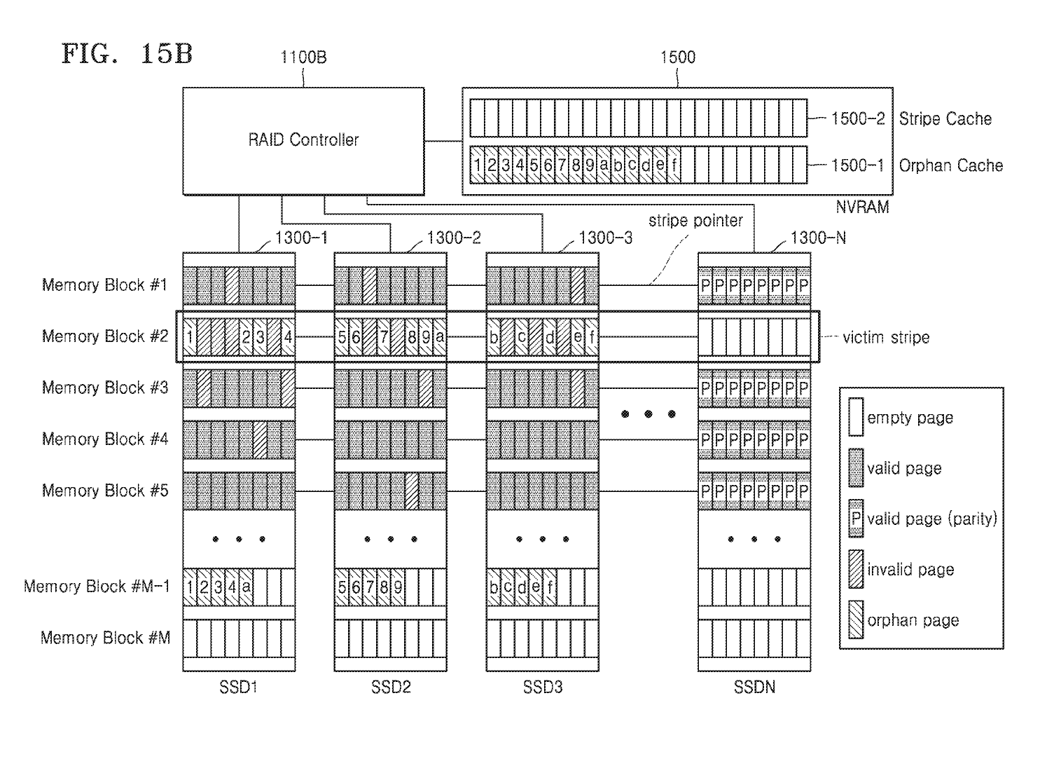

FIGS. 15A and 15B are conceptual diagrams illustrating various examples of copying valid pages included in a victim stripe into memory blocks that are to constitute a new stripe, during a garbage collection operation in the storage system according to the exemplary embodiment of the inventive concept.

Referring to FIGS. 15A and 15B, since parity information about the valid pages included in the victim stripe has been deleted, the valid pages included in the victim stripe are orphan pages.

Referring to FIG. 15A, the orphan pages included in the victim stripe are only copied into the same SSD as the SSD in which the orphan pages are located. In other words, orphan pages 1, 2, 3, and 4 included in the memory block #2 of the first SSD 1300-1 are copied into the memory block #M-1 of the first SSD 1300-1, and orphan pages 5, 6, 7, 8, 9, and a included in the memory block #2 of the second SSD 1300-2 are copied into the memory block #M-1 of the second SSD 1300-2, and orphan pages b, c, d, e, and f included in the memory block #2 of the third SSD 1300-3 are copied into the memory block #M-1 of the third SSD 1300-3.

Accordingly, copying of orphan pages is performed within an identical SSD. Accordingly, I/O may be performed only via an internal I/O bus of an SSD and an external I/O bus is not required, and thus, I/O bus traffic may be reduced. However, the numbers of orphan pages in the memory blocks of the victim stripe may be different from each other, and thus, the overall number of times an erase operation is performed may increase.

As another example, the orphan pages may be freely copied regardless of the SSD in which the orphan pages are originally stored.

According to this method, orphan pages stored in the orphan cache 1500-1 are copied into pages of a flash memory forming each SSD. Accordingly, the number of orphan pages in each of the SSDs is the same as those in other SSDs in all cases, and thus, it is easy to generate parity information from the orphan pages and convert the orphan pages into normal valid pages. In addition, the number of times an erase operation is performed may be reduced. However, since the orphan page copying is performed by using an external I/O bus, the I/O bus traffic increases and the copy latency may increase.

As another example, orphan pages located in each memory block of a victim stripe are basically copied into the same SSD as the SSD corresponding to the memory block, and some of the orphan pages are copied from the NVRAM 1500 into SSDs to obtain an orphan page balance.

In detail, the orphan page balance may be obtained via the following process. First, an average value of the valid pages is calculated by dividing the total number of valid pages included in a victim stripe by the number of memory blocks except for the memory block storing parity information from among a plurality of memory blocks that define the victim stripe. Next, valid pages, the valid pages included in each of the memory blocks defining the victim stripe are copied into a memory block that is to define a new stripe within the same SSD in the range of less than or equal to the average value. Next, the other valid pages included in the victim stripe are copied into the memory blocks that are to define the new stripe, such that the valid pages may be evenly stored in the respective memory blocks of the SSDs, which are to define the new stripe. These operations will be described below with reference to FIG. 15B.

For example, the total number of valid pages included in the memory blocks #2 of the first through third SSDs 1300-1 through 1300-3 is 15. Therefore, the average value of valid pages per SSD in the victim stripe is 5. Thus, 5 or less valid pages from among the valid pages included in each of the memory blocks defining the victim stripe are copied into a new memory block within the same SSD.

The memory block #2 of the first SSD 1300-1 has four orphan pages 1, 2, 3, and 4, the number of which is less than or equal to 5, which is the average value of valid pages per SSD in the victim stripe. Accordingly, all of the orphan pages 1, 2, 3, and 4 in the memory block #2 of the first SSD 1300-1 are copied into the memory block #M-1 of the first SSD 1300-1.

Next, the memory block #2 of the second SSD 1300-2 has six orphan pages 5, 6, 7, 8, 9, and a. Accordingly, only five orphan pages from among the six orphan pages 5, 6, 7, 8, 9, and a included in the memory block #2 are copied to another memory block of the same SSD 1300-2. For example, the orphan pages 5, 6, 7, 8, and 9 except for the orphan page a, from among the six orphan pages 5, 6, 7, 8, 9, and a of the memory block #2 in the second SSD 1300-2, are copied to the memory block #M-1 of the second SSD 1300-2.

Next, the memory block #2 of the third SSD 1300-3 has five orphan pages b, c, d, e, and f, the number of which is in the range less than or equal to the average value of valid pages per SSD in the victim stripe, which is 5. Therefore, the orphan pages b, c, d, e, and f located in the memory block #2 of the third SSD 1300-3 are copied to the memory block #M-1 of the third SSD 1300-3.

Next, the orphan page a stored in the orphan cache 1500-1 of the NVRAM 1500 is copied to the memory block #M-1 of the first SSD 1300-1 through an external copying operation.

FIG. 16 illustrates an example of a stripe formation after a garbage collection operation is performed in a storage system according to an exemplary embodiment of the inventive concept.

While a RAID-level garbage collection operation is being performed, the number of times an erase operation is needed by each SSD to secure one free memory block may vary. Accordingly, memory blocks that define a stripe may vary. In other words, although memory blocks that have the same index and are respectively included in the SSDs form a stripe at first, the memory blocks defining a stripe may be changed as illustrated in FIG. 16 while subsequent garbage collection is being conducted.

Referring to FIG. 16, a memory block #5 of the first SSD 1300-1, a memory block #4 of the second SSD 1300-2, a memory block #5 of the third SSD 1300-3, and a memoryblock #4 of the N-th SSDN 1300-N define a stripe. Information about such a dynamic stripe formation is divided into pieces of PMT information, and the pieces of PMT information are respectively stored in the first through N-th SSDs 1300-1 through 1300-N.

Since the storage systems 1000A, 2000A, and 3000A of FIGS. 1, 3, and 5 include no NVRAMs 1500 or 103, the storage systems 1000A, 2000A, and 3000A have simple circuit configurations. However, due to non-inclusion of the NVRAM 1500 or 103, the reliability of orphan data unable to be protected temporarily by parity information during a garbage collection operation may decrease.

For example, the storage system 1000A, 2000A, and 3000A of FIGS. 1, 3, and 5 may write data of one full stripe to the first through N-th SSDs 1300-1 through 1300-N at one time by using a partial region of the NVRAM 1500 or 103 as a cache.

Since a log-structured storage system should reconstitute data that is to be written to form a log structure regardless of a virtual address, the log-structured storage system needs to manage mapping data about a virtual address and a physical address. The size of the mapping data increases in approximately proportion to the size of data that is handled by the log-structured storage system. For example, when the log-structured storage system is formed with 20 SSDs each having a size of 4 TB and performs page-level mapping, the size of the mapping data may be about 90 GB. For fast response, the entire mapping table needs to be loaded to dynamic RAM (DRAM) and used. Accordingly, the mapping table occupies a large area of the DRAM of the log-structured storage system.

In the method of loading the entire mapping table of the log-structured storage system to a system memory (e.g., RAM) of a storage server, as the number of SSDs or the capacity thereof increases, the size of the system memory needs to proportionally increase. In addition, it is difficult to restore mapping data in abnormal shutdown circumstances.

To address these problems, the inventive concept provides a method of managing a mapping table of a log-structured storage system by dividing the mapping table into partial mapping tables and storing the partial mapping tables in the SDs (e.g., SSDs) defining the log-structured storage system.

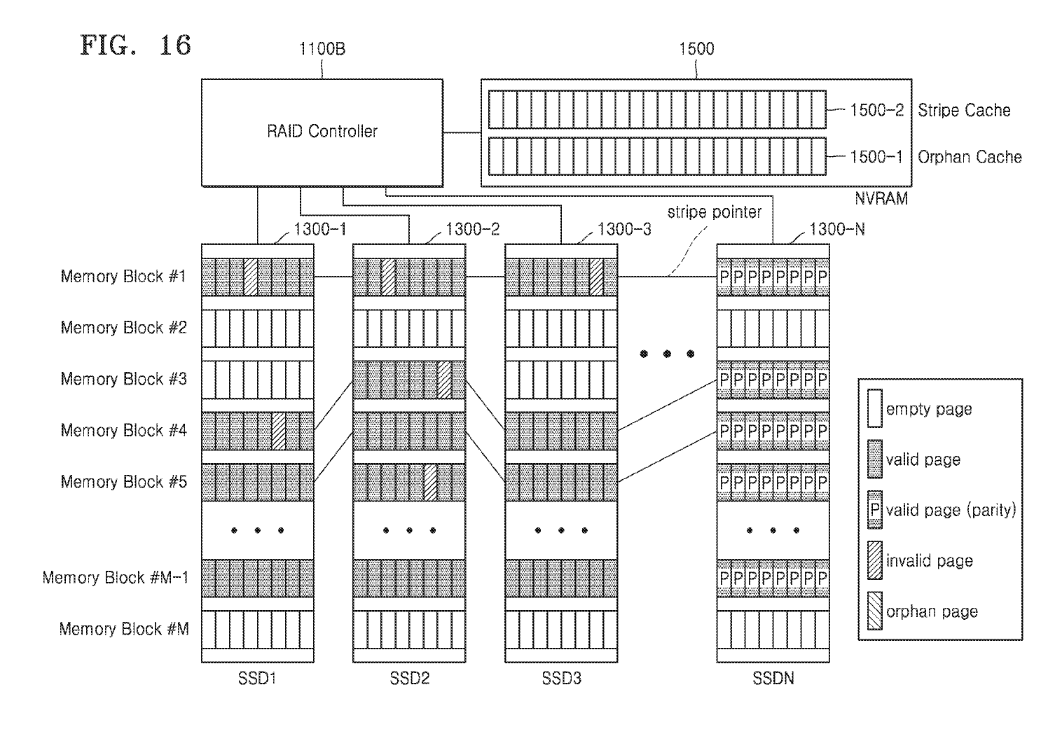

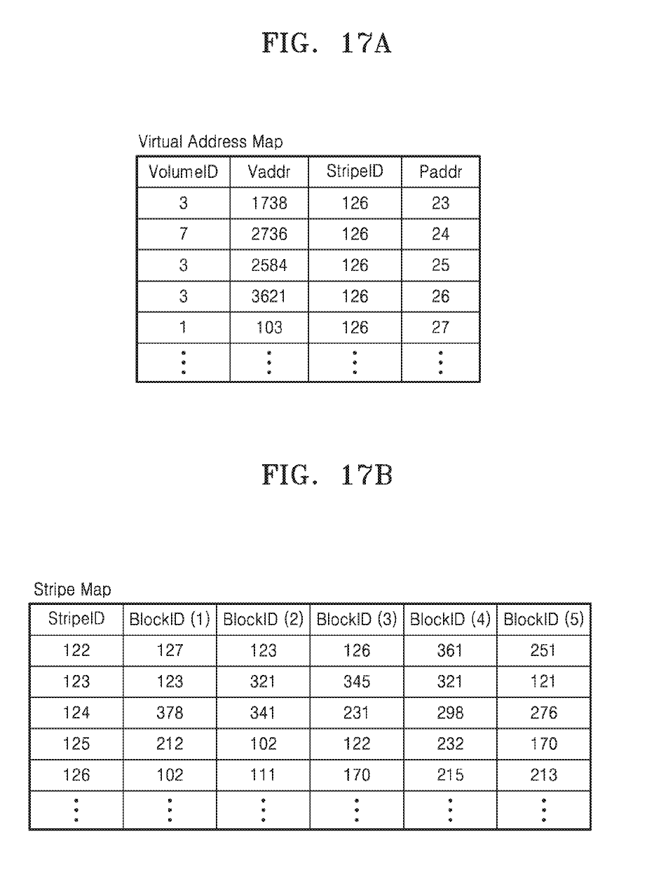

For example, mapping table information of a log-structured storage system includes virtual address mapping table information Virtual Address Map and stripe mapping table information Stripe Map as respectively illustrated in FIGS. 17A and 17B.

A host instructs a read/write operation with respect to SDs, via volume identification information VolumeID and a virtual address Vaddr corresponding to the volume identification information VolumeID. The virtual address Vaddr is also referred to as a logical Address or a logical block address (LBA). Accordingly, mapping table information that maps the volume identification information VolumeID and the virtual address Vaddr with stripe identification information StripeID and a physical address Paddr is necessary. The mapping table information that performs this mapping is the virtual address mapping table information illustrated in FIG. 17A.

Since respective pieces of identification information BlockID of memory blocks of SDs (e.g., SSDs) that define one stripe may be different, mapping table information indicating which memory blocks respectively included in the SDs define the stripe is necessary. The mapping table information that performs this mapping is the stripe mapping table information illustrated in FIG. 17B.

As shown in FIG. 17A, the virtual address mapping table information has a structure in which the volume identification information VolumeID and the virtual address Vaddr are mapped with the stripe identification information StripeID and the physical address Paddr. As shown in FIG. 17B, the stripe mapping table information has a structure in which the stripe identification information StripeID is mapped with pieces of respective memory block identification information BlockID of the SDs.

As another example, the virtual address mapping table information of FIG. 17A may not include the volume identification information VolumeID and the virtual address Vaddr. In detail, virtual address mapping table information Virtual Address Map may be generated for each volume identification information VolumeID, and stripe identification information StripeID and a physical address Paddr for the volume identification information VolumeID may be found by using the virtual address Vaddr as a key. This example is expressed in Table 1 below.

TABLE 1
Virtual Address Map for Volume ID 3

| (Vaddr) | StripeID | Paddr |
|---|---|---|
| 1 | 126 | 23 |
| 4 | 126 | 24 |
| 6 | 126 | 25 |

For example, Table 1 is virtual address mapping table information Virtual Address Map for Volume ID 3, stripe identification information StripID and a physical address Paddr when a virtual address Vaddr of Volume ID 3 is 1 are found by referring to a first row of Table 1, and stripe identification information StripeID and a physical address Paddr when the virtual address Vaddr of Volume ID 3 is 4 are found by referring to a fourth row of Table 1. According to this example, since volume identification information VolumeID and a virtual address Vaddr are not included as columns in a mapping table, the size of the mapping table may be reduced.

Similarly, when the stripe mapping table information Stripe Map uses the stripe identification information StripeID as a key, the stripe identification information StripeID does not need to be included as a column in the stripe mapping table information Stripe Map.

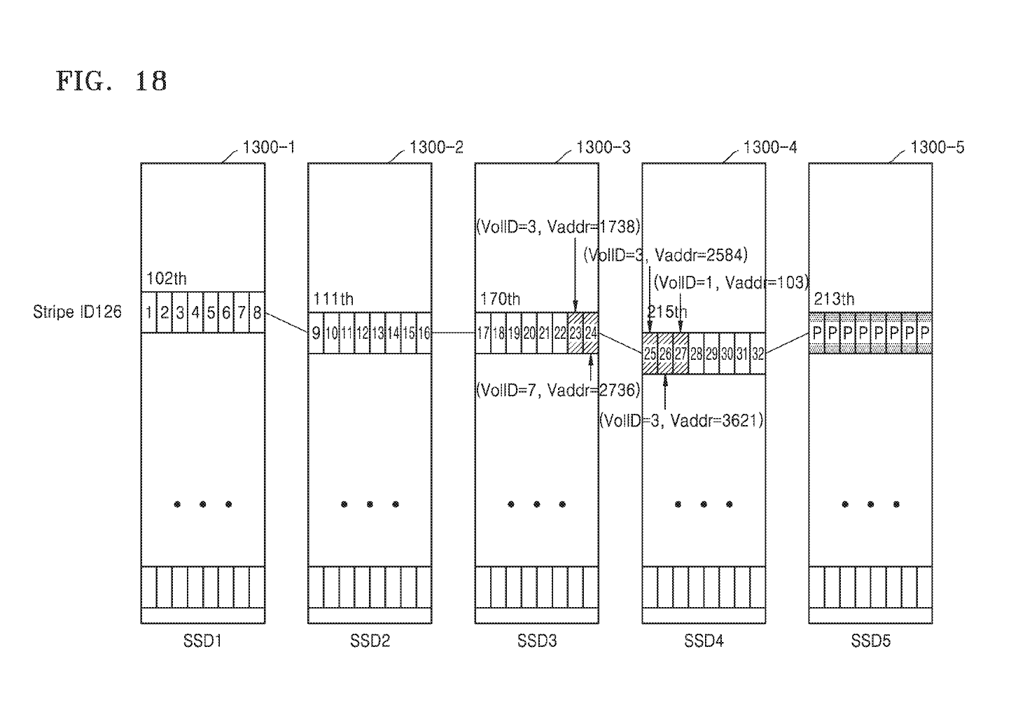

FIG. 18 shows respective data storage locations on SDs according to the virtual address mapping table information and the stripe mapping table information of FIGS. 17A and17B.

Referring to FIG. 18, it is assumed that one memory block of each SSD includes 8 physical addresses Paddr. Consecutive physical addresses Paddr are assigned to SDs that define one stripe. For example, data of physical addresses Paddr of 1 through 8 is stored in a first SSD 1300-1, data of physical addresses Paddr of 9 through 16 is stored in a second SSD 1300-2, data of physical addresses Paddr of 17 through 24 is stored in a third SSD 1300-3, and data of physical addresses Paddr of 25 through 32 are stored in a fourth SSD 1300-4.

By referring to the virtual address mapping table information of FIG. 17A, (VolumeID=3, Vaddr=1738) is mapped with (StripeID=126, Paddr=23). Referring to the stripe mapping table information of FIG. 17B, stripe identification information StripeID of 126 in the third SSD 1300-3 including a physical address Paddr of 23 is mapped with memory block identification information BlockID of 170. Accordingly, (VolumeID=3, Vaddr=1738) is mapped with a storage location of a seventh address of a 170^{th} memory block of the third SSD 1300-3.

Next, (VolumeID=7, Vaddr=2736) is mapped with (StripeID=126, Paddr=24), based on the virtual address mapping table information of FIG. 17A. Referring to the stripe mapping table information of FIG. 17B, stripe identification information StripeID of 126 in the third SSD 1300-3 including a physical address Paddr of 24 is mapped with memory block identification information BlockID of 170. Accordingly, (VolumeID=7, Vaddr=2736) is mapped with a storage location of an eighth address of the 170^{th} memory block of the third SSD 1300-3.

Next, (VolumeID=3, Vaddr=2584) is mapped with (StripeID=126, Paddr=25), based on the virtual address mapping table information of FIG. 17A. Referring to the stripe mapping table information of FIG. 17B, stripe identification information StripeID of 126 in the fourth SSD 1300-4 including a physical address Paddr of 25 is mapped with memory block identification information BlockID of 215. Accordingly, (VolumeID=3, Vaddr=2584) is mapped with a storage location of a first address of a 215^{th} memory block of the fourth SSD 1300-4.

In this manner, physical storage locations in SDs for (VolumeID=3, Vaddr=3621) and (VolumeID=1, Vaddr=103) may be ascertained.

An example in which virtual address mapping table information and stripe mapping table information constructed as illustrated in FIGS. 17A and 17B are centralized and managed by a RAID controller or a processor of a host has been illustrated above.

Hereinafter, the inventive concept proposes a method of managing virtual address mapping table information and stripe mapping table information constructed as illustrated in FIGS. 17A and 17B by distributing and storing the same into and in the SDs (e.g., SSDs) defining a storage system.

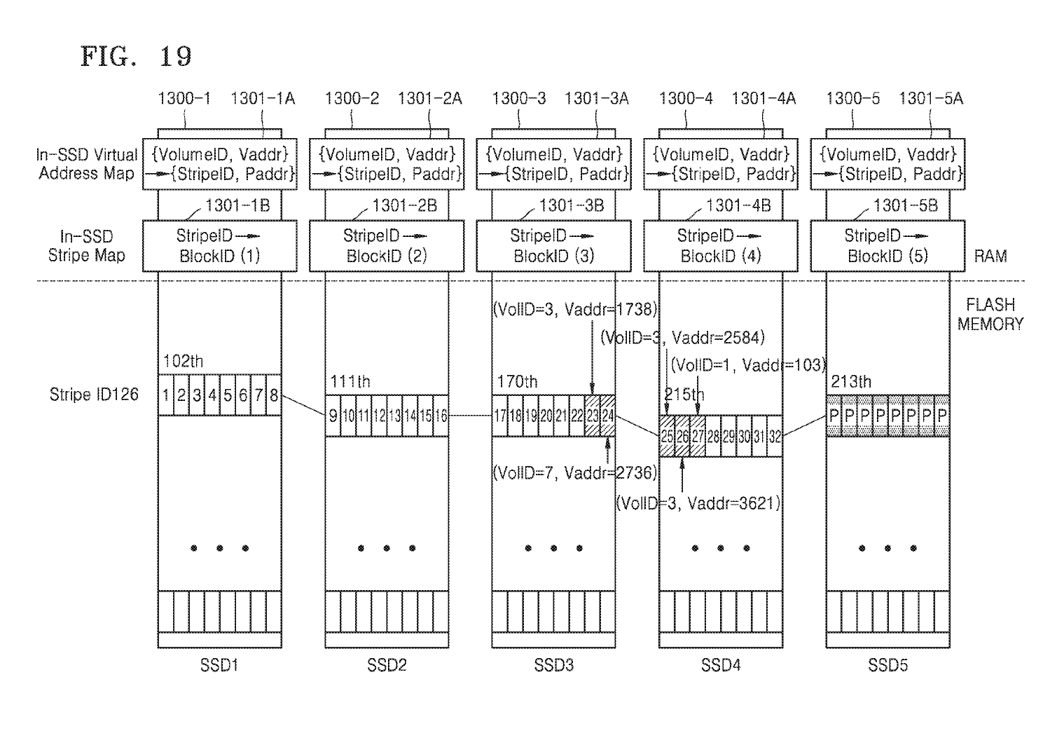

FIG. 19 illustrates a method of distributing and storing mapping information into and in SSDs in a storage system according to an exemplary embodiment of the inventive concept.

First, the stripe mapping table information is divided by SSDs and stored in SSDs. Pieces of mapping table information into which the stripe mapping table information is divided and which are respectively stored in SSDs are referred to as pieces of partial stripe mapping table information 1301-1B through 1301-5B. In FIG. 19, the pieces of partial stripe mapping table information 1301-1B through 1301-5B are indicated by In-SSD Stripe Map.

In other words, each SSD internally manages stripe mapping information indicating which memory block included therein belongs to each stripe identification information StripeID, by using partial stripe mapping table information.

Next, a virtual address mapping table is divided by SSDs according to a certain criterion and stored in the SSDs. The inventive concept provides two types of partitioning criteria, for example. A method of partitioning the virtual address mapping table based on a value obtained by hashing the volume identification information VolumeID, and a method of partitioning the virtual address mapping table based on a value obtained by hashing the virtual address Vaddr are provided. Exemplary embodiments of the inventive concept are not limited to the two methods, and various partitioning criteria may be used.

Pieces of mapping table information into which the virtual address mapping table information is divided and which are respectively stored in SSDs are referred to as pieces of partial virtual address mapping table information 1301-1A through 1301-5A. In FIG. 19, the pieces of partial virtual address mapping table information 1301-1A through 1301-5A are indicated by In-SSD Virtual Address Map.

For example, the partial stripe mapping table information 1301-1B through 1301-5B and the partial virtual address mapping table information 1301-1A through 1301-5A may be distributed into and stored in respective RAM regions of the first through fifth SSDs 1300-1 through 1300-5.

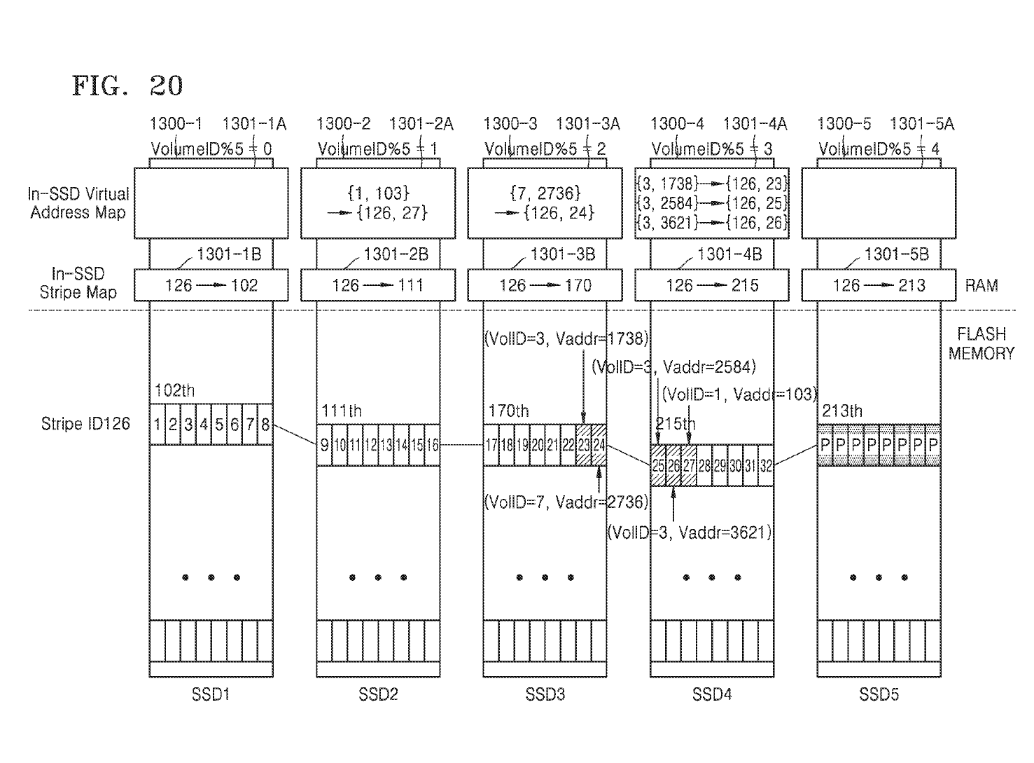

FIG. 20 illustrates a method of distributing and storing mapping table information into and in SDs in a storage system according to an exemplary embodiment of the inventive concept.

Referring to FIG. 20, a virtual address mapping table is divided based on a value obtained by hashing volume identification information VolumeID. In detail, virtual address mapping information may be classified as a plurality of pieces of partial virtual address mapping table information, based on a remainder obtained by dividing the volume identification information VolumeID by the number of SSDs that define the storage system. For example, when the number of SSDs that define the storage system is 5, the volume identification information VolumeID is divided by 5. Then, when the remainder of the division is 0, the virtual address mapping information is classified as the partial virtual address mapping table information 1301-1A of the first SSD 1300-1. When the remainder of the division is 1, the virtual address mapping information is classified as the partial virtual address mapping table information 1301-2A of the second SSD 1300-2. When the remainder of the division is 2, the virtual address mapping information is classified as the partial virtual address mapping table information 1301-3A of the third SSD 1300-3. When the remainder of the division is 3, the virtual address mapping information is classified as the partial virtual address mapping table information 1301-4A of the fourth SSD 1300-4. When the remainder of the division is 4, the virtual address mapping information is classified as the partial virtual address mapping table information 1301-5A of the fifth SSD 1300-5.

For example, when virtual address mapping information is (VolumeID=3, Vaddr=1738)−>(StripeID=126, Paddr=23), the remainder obtained by dividing the volume identification information VolumeID by 5 is 3. Accordingly, the virtual address mapping information (VolumeID=3, Vaddr=1738)−>(StripeID=126, Paddr=23) is classified as the partial virtual address mapping table information 1301-3A of the third SSD 1300-3 and stored in the third SSD 1300-3.

Thus, the virtual address mapping table information centralized and managed by a RAID controller or a processor of a host as illustrated in FIG. 17A is classified as the five pieces of partial virtual address mapping table information 1301-1A through 1301-5A illustrated in FIG. 20. The five pieces of partial virtual address mapping table information 1301-1A through 1301-5A are distributed into and stored in the first through fifth SSDs 1300-1 through 1300-5.

In a storage system to which a method of distributing and storing mapping table information into and in SDs according to the inventive concept is applied, a data read operation and a data write operation may be performed as follows.

The inventive concept introduces a write command and a read command having new standards. First, a write command of a new standard applicable to the inventive concept includes the volume identification information VolumeID, the virtual address Vaddr, the stripe identification information StripeID, and the physical address Paddr. In other words, the RAID controller or the processor of the host may generate a write command having a form such as Write (VolumeID, Vaddr, StripeID, Paddr).

As described above with reference to FIGS. 1-6, the RAID controller or the processor of the host transmits a write command Write (VolumeID, Vaddr, StripeID, Paddr) to both an i-th SD 200-i in which PMT information 201-i corresponding to the volume identification information VolumeID and the virtual address Vaddr included in the write command is stored, and to a j-th SD 200-j in which the physical address Paddr exists.

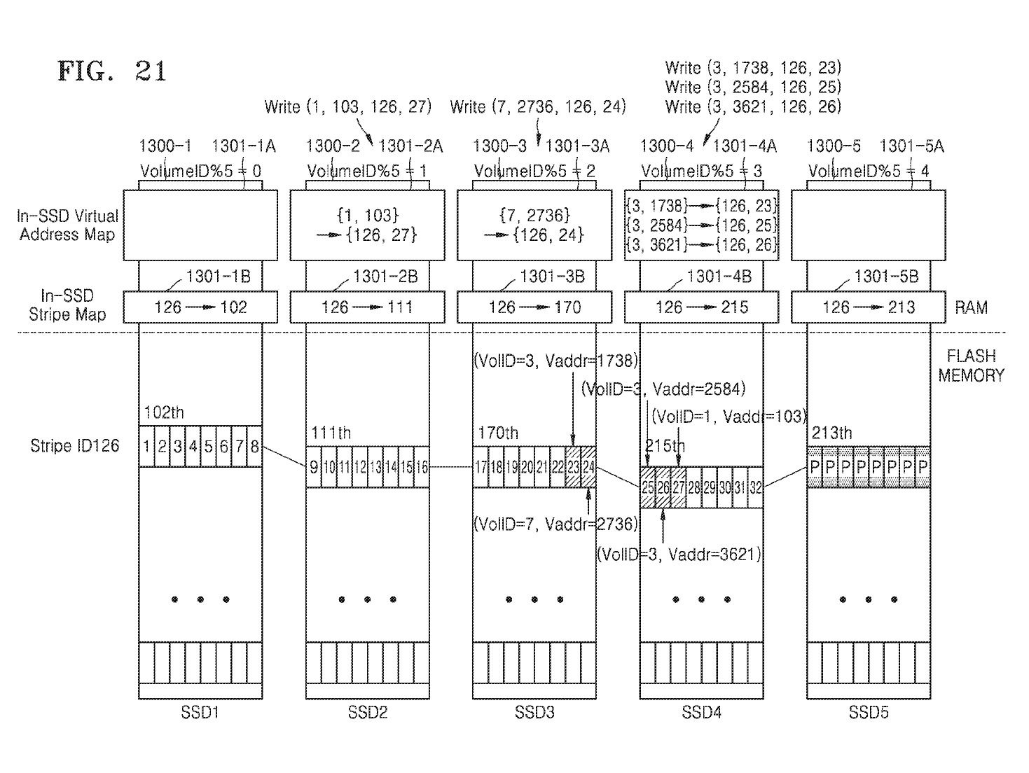

FIG. 21 shows a process of updating pieces of partial virtual address mapping table information according to a write command in a storage system according to an exemplary embodiment of the inventive concept. FIG. 21 illustrates an example in which the virtual address mapping table is divided based on a value obtained by hashing the volume identification information VolumeID.

For example, in response to a write command Write (1, 103, 126, 27), partial mapping table updating is performed in the second SSD 1300-2 because the volume identification information VolumeID is 1, and a data write operation is performed in the fourth SSD 1300-4 because the physical address Paddr is 27. In response to a write command Write (7, 2736, 126, 24), partial mapping table updating is performed in the third SSD 1300-3 because the volume identification information VolumeID is 7, and a data write operation is performed in the third SSD 1300-3 because the physical address Paddr is 24.

Partial mapping table update operations in response to write commands Write (3, 1738, 126, 23), Write (3, 2584, 126, 25), and Write (3, 3621, 126, 26) are performed in the fourth SSD 1300-4 because the volume identification information VolumeID is 3. However, a data write operation in response to the write command Write (3, 1738, 126, 23) is performed in the third SSD 1300-3, and data write operations in response to the write commands Write (3, 2584, 126, 25) and Write (3, 3621, 126, 26) are performed in the fourth SSD 1300-4.

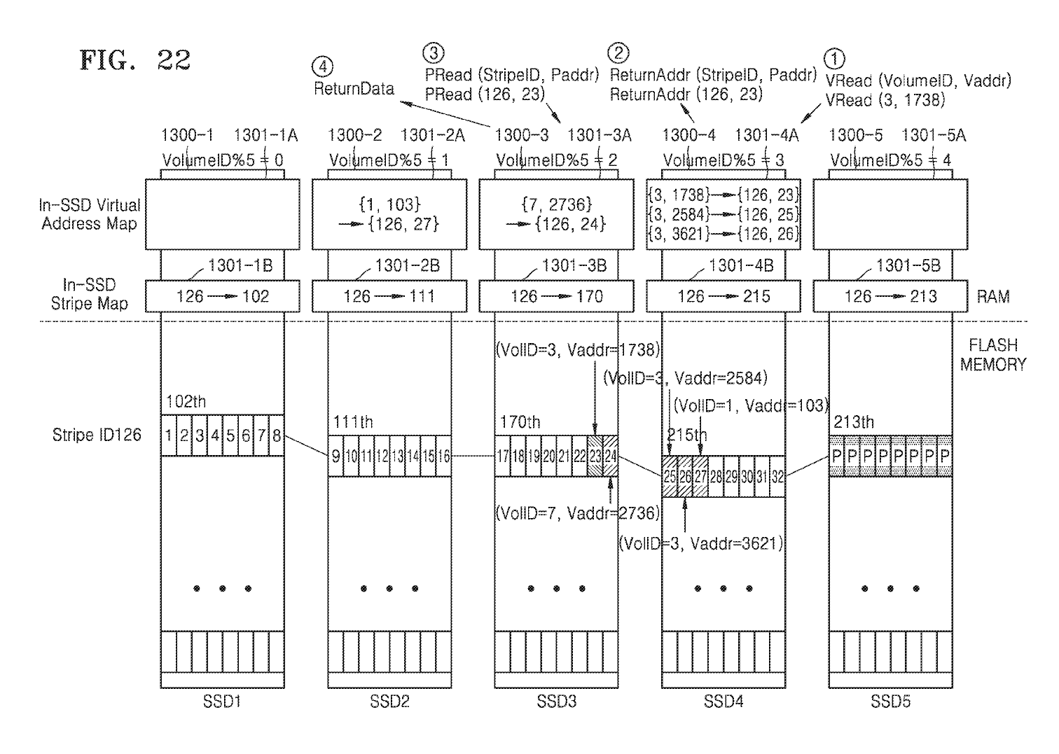

FIG. 22 illustrates a read operation performed in a storage system according to an exemplary embodiment of the inventive concept.

Since partial virtual address mapping table information and partial stripe mapping table information are stored in SSDs, a new read command may be needed to perform a read operation.

For example, it is assumed that data having volume ID information VolumeID of 3 and a virtual address Vaddr of 1738 is read. First, since partial virtual address mapping table information having the volume ID information VolumeID of 3 is stored in the fourth SSD 1300-4, the RAID controller or the processor of the host transmits a first read command VRead (VolumeID, Vaddr) to the fourth SSD 1300-4 (1). In other words, a first read command VRead (3, 1738) is transmitted to the fourth SSD 1300-4.

The fourth SSD 1300-4 ascertains that the data having the volume ID information VolumeID of 3 and the virtual address Vaddr of 1738 is stored in a storage location corresponding to StripeID of 126 and Paddr of 23, based on the partial virtual address mapping table information 1301-4A. However, since the storage location corresponding to Paddr of 23 does not exist in the fourth SSD 1300-4, the fourth SSD 1300-4 transmits location information (StripeID=126, Paddr=23) instead of the data to the RAID controller or the host (2).

Next, the RAID controller or the processor of the host transmits a second read command PRead(StripeID, Paddr) to the third SSD 1300-3 including the storage location corresponding to Paddr of 23 (3). In other words, a second read command VRead(126, 23) is transmitted to the third SSD 1300-3. Then, the third SSD 1300-3 ascertains that a stripe having StripeID of 126 corresponds to a 170^{th} memory block, based on the partial stripe mapping table information 1301-3B. Accordingly, the third SSD 1300-3 reads data from the storage location corresponding to Paddr of 23 included in the 170^{th} memory block and transmits the read data to the RAID controller or the host (4).

As shown in FIG. 22, an SSD in which PMT information is stored supports two types of read commands. The SSD supports the first read command VRead(VolumeID, Vaddr) using a virtual address and the second read command PRead(StripeID, Paddr) using a physical address.

In other words, when the first read command VRead(VolumeID, Vaddr) is received by an SSD and a storage location corresponding to information (StripeID, Paddr) mapped with information (VolumeID, Vaddr) exists in the SSD, data is read from the storage location and returned to the RAID controller or the host. When the storage location corresponding to mapping information (StripeID, Paddr) mapped with information (VolumeID, Vaddr) does not exist in the SSD, the mapping information (StripeID, Paddr) is returned to the RAID controller or the host.

When the second read command PRead (VolumeID, Paddr) is received by an SSD, the SSD reads data from a storage location corresponding to the mapping information (StripeID, Paddr) and returns the read data to the RAID controller or the host.

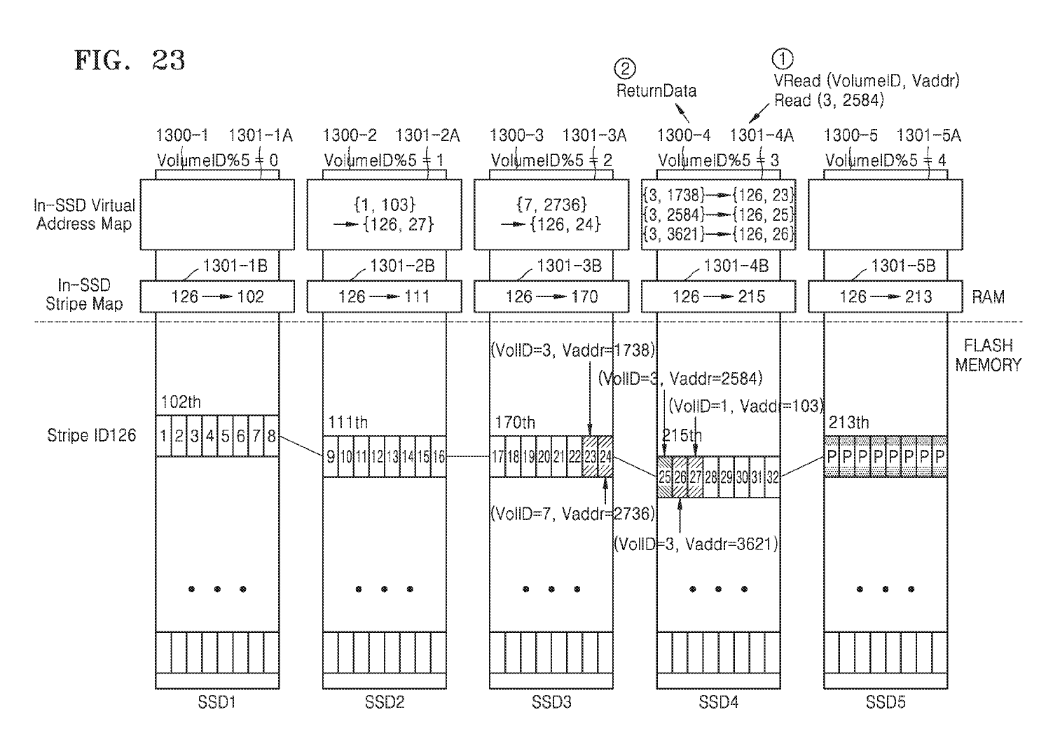

FIG. 23 illustrates a read operation performed in a storage system according to another exemplary embodiment of the inventive concept.

For example, it is assumed that data corresponding to volume identification information VolumeID of 3 and a virtual address Vaddr of 2584 is read. First, since pieces of partial virtual address mapping table information having volume identification information VolumeID of 3 are stored in the fourth SSD 1300-4, the RAID controller or the processor of the host transmits a first read command VRead (VolumeID, Vaddr) to the fourth SSD 1300-4 (1). In other words, a first read command VRead (3, 2584) is transmitted to the fourth SSD 1300-4.

The fourth SSD 1300-4 ascertains that the data having the volume ID information VolumeID of 3 and the virtual address Vaddr of 2584 is stored in a storage location corresponding to StripeID of 126 and Paddr of 25, based on the partial virtual address mapping table information 1301-4A. The storage location corresponding to Paddr of 25 exists in the fourth SSD 1300-4. Accordingly, the fourth SSD 1300-4 ascertains that a stripe having StripeID of 126 corresponds to a 215^{th} memory block, based on the partial stripe mapping table information 1301-4B. Thus, the fourth SSD 1300-4 reads data from the storage location corresponding to Paddr of 25 included in the 215^{th} memory block and returns the read data to the RAID controller or the host (2).

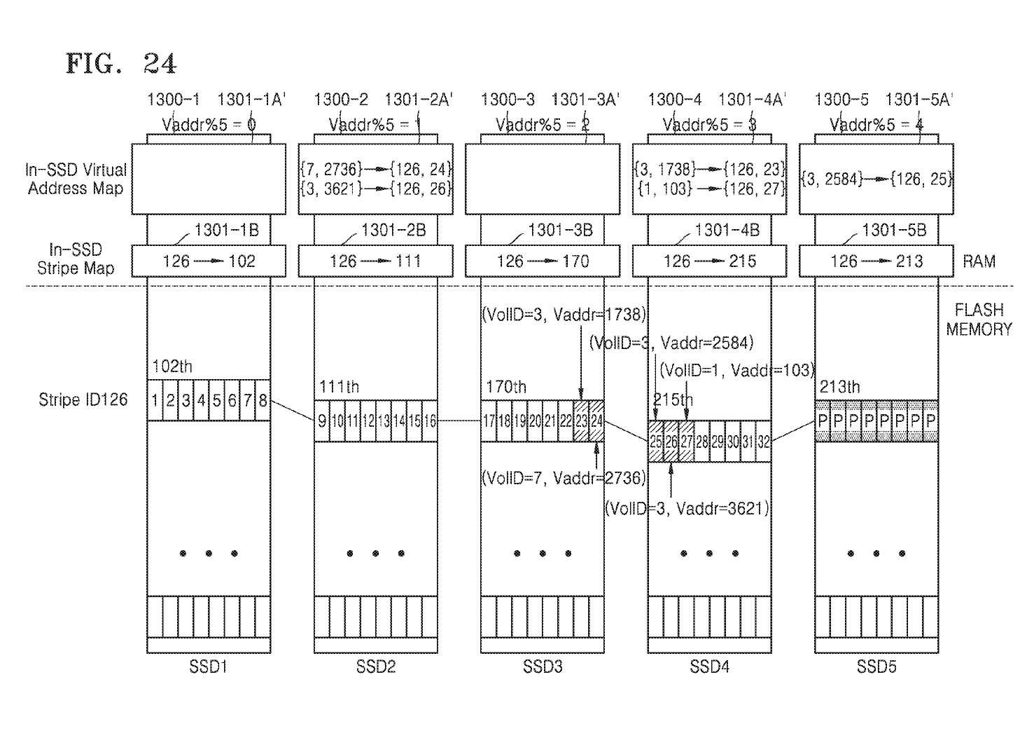

FIG. 24 illustrates a mapping table managing method in a storage system according to another exemplary embodiment of the inventive concept.

FIG. 24 illustrates an example in which the virtual address mapping information Virtual Address Map is classified into a plurality of pieces of partial virtual address mapping table information based on a value obtained by hashing the virtual address Vaddr, and the plurality of pieces of partial virtual address mapping table information are distributed into and stored in SDs.

For example, when the number of SSDs that form a RAID storage system is 5, the virtual address Vaddr is divided by 5. Then, when the remainder of the division is 0, the virtual address mapping information is classified as partial virtual address mapping table information 1301-1A′ of the first SSD 1300-1. When the remainder of the division is 1, the virtual address mapping information is classified as partial virtual address mapping table information 1301-2A′ of the second SSD 1300-2. When the remainder of the division is 2, the virtual address mapping information is classified as partial virtual address mapping table information 1301-3A′ of the third SSD 1300-3. When the remainder of the division is 3, the virtual address mapping information is classified as partial virtual address mapping table information 1301-4A′ of the fourth SSD 1300-4. When the remainder of the division is 4, the virtual address mapping information is classified as partial virtual address mapping table information 1301-5A′ of the fifth SSD 1300-5.

For example, since the remainder obtained by dividing the virtual address Vaddr of each of mapping information (VolumeID=7, Vaddr=2736) and mapping information (VolumeID=3, Vaddr=3621) by 5 is 1, the two pieces of mapping information are classified as the partial virtual address mapping table information 1301-2A′ of the second SSD 1300-2 and stored in the second SSD 1300-2. Since the remainder obtained by dividing the virtual address Vaddr of each of mapping information (VolumeID=3, Vaddr=1738) and mapping information (VolumeID=1, Vaddr=103) by 5 is 3, the two pieces of mapping information are classified as the partial virtual address mapping table information 1301-4A′ of the fourth SSD 1300-4 and stored in the fourth SSD 1300-4. Since the remainder obtained by dividing the virtual address Vaddr of mapping information (VolumeID=3, Vaddr=2584) by 5 is 4, the mapping information is classified as the partial virtual address mapping table information 1301-5A′ of the fifth SSD 1300-5 and stored in the fifth SSD 1300-5.

Even when pieces of partial virtual address mapping table information are obtained based on the virtual address Vaddr and stored in SSDs, an update operation, a read operation, and a write operation may be performed according to methods as illustrated in FIGS. 21-23.

FIG. 25 illustrates a mapping table managing method in a storage system according to another exemplary embodiment of the inventive concept.

According to the inventive concept, an SSD stores partial virtual address mapping table information and partial stripe mapping table information. If one of a plurality of SSDs is defective, data stored in the defective SSD may be restored using parity information included in a stripe, but partial virtual address mapping table information and partial stripe mapping table information stored therein may be lost. To address this problem, according to an exemplary embodiment of the inventive concept as illustrated in FIG. 25, partial virtual address mapping table information and partial stripe mapping table information are stored in respective RAM regions of two SSDs in a mirroring manner

For example, the partial virtual address mapping table information 1301-1A and the partial stripe mapping table information 1301-1B stored in the RAM region of the first SSD 1300-1 are stored in the RAM region of the second SSD 1300-1 via mirroring. The partial virtual address mapping table information 1301-2A and the partial stripe mapping table information 1301-2B stored in the RAM region of the second SSD 1300-2 are stored in the RAM region of the first SSD 1300-1 via mirroring.

Similarly, the partial virtual address mapping table information 1301-3A and the partial stripe mapping table information 1301-3B stored in the RAM region of the third SSD 1300-3 are stored in the RAM region of the fourth SSD 1300-4 via mirroring. The partial virtual address mapping table information 1301-4A and the partial stripe mapping table information 1301-4B stored in the RAM region of the fourth SSD 1300-4 are stored in the RAM region of the third SSD 1300-3 via mirroring.

For example, when the first SSD 1300-1 is defective, PMT information stored in the first SSD 1300-1 may be restored using the partial virtual address mapping table information 1301-1A and the partial stripe mapping table information 1301-1B stored the second SSD 1300-2 via mirroring.

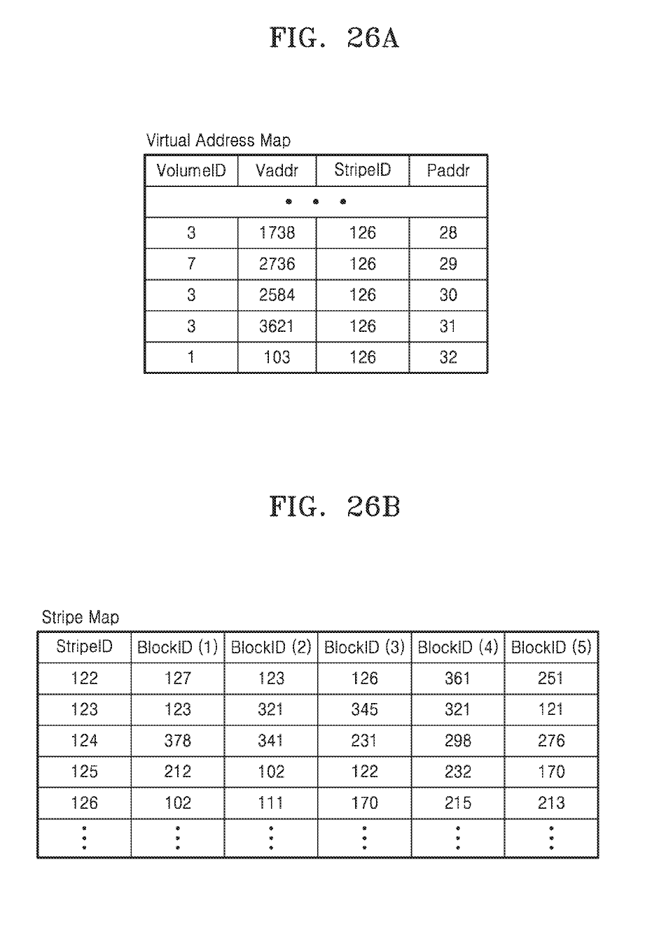

FIG. 26A shows a virtual address mapping table that is used in a storage system, according to another exemplary embodiment of the inventive concept. FIG. 26B shows a stripe mapping table that is used in a storage system, according to another exemplary embodiment of the inventive concept.

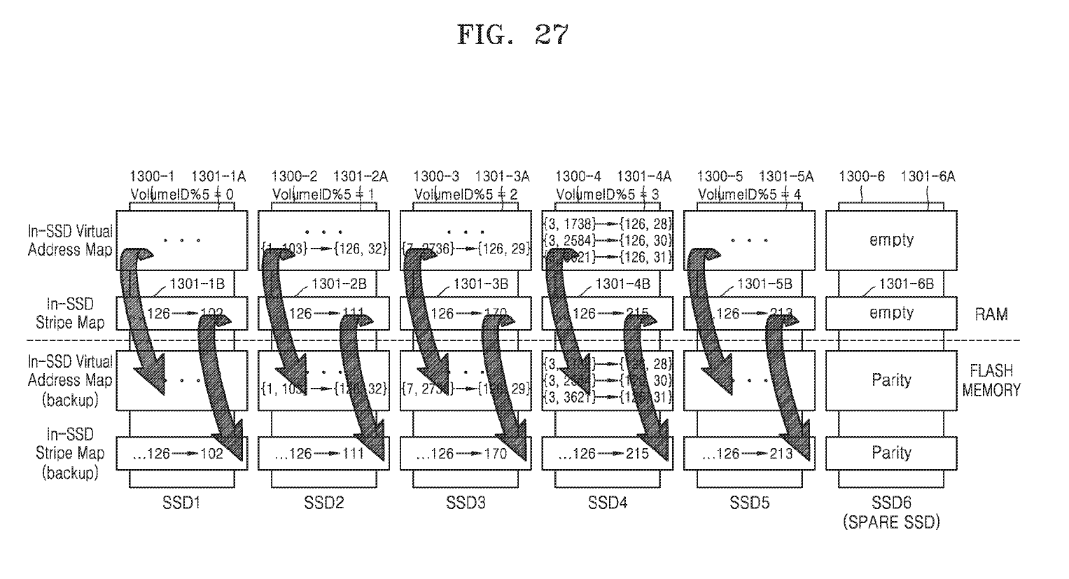

FIG. 27 shows distributed storing and backup management of the virtual address mapping table and the stripe mapping table of FIGS. 26A and 26B in a storage system, according to an exemplary embodiment of the inventive concept.

The pieces of partial virtual address mapping table information 1301-1A through 1301-5A and the pieces of partial stripe mapping table information 1301-1B through 1301-5B stored in the RAM regions of the first through fifth SSDs 1300-1 through 1300-5 are written to the flash memory regions thereof at regular intervals after a full stripe write operation is completed. The partial virtual address mapping table information 1301-1A through 1301-5A and the partial stripe mapping table information 1301-1B through 1301-5B stored for backup in the flash memory regions of the first through fifth SSDs 1300-1 through 1300-5 define a stripe group, and parity information for the stripe group is stored in a spare SD, which is a sixth SSD 1300-6. The sixth SSD 1300-6, which is a spare SD, does not participate in a data read operation and a data write operation in normal situations. However, when one SSD is defective, the sixth SSD 1300-6 restores data and PMT information stored in the defective SSD and stores the same.

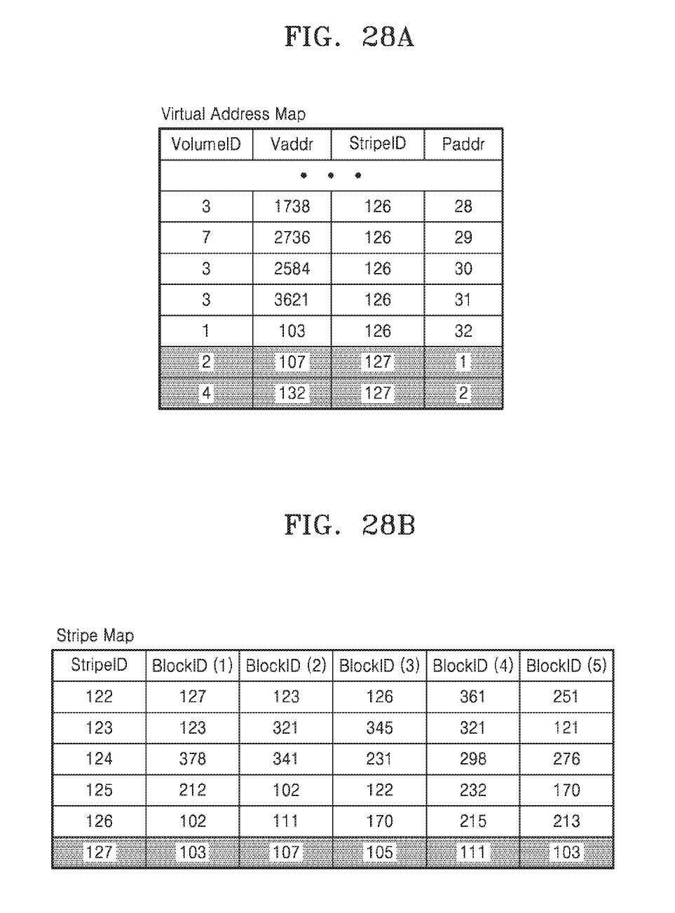

FIG. 28A shows a virtual address mapping table that is used in a storage system, according to another exemplary embodiment of the inventive concept. FIG. 28B shows a stripe mapping table that is used in a storage system, according to another exemplary embodiment of the inventive concept.

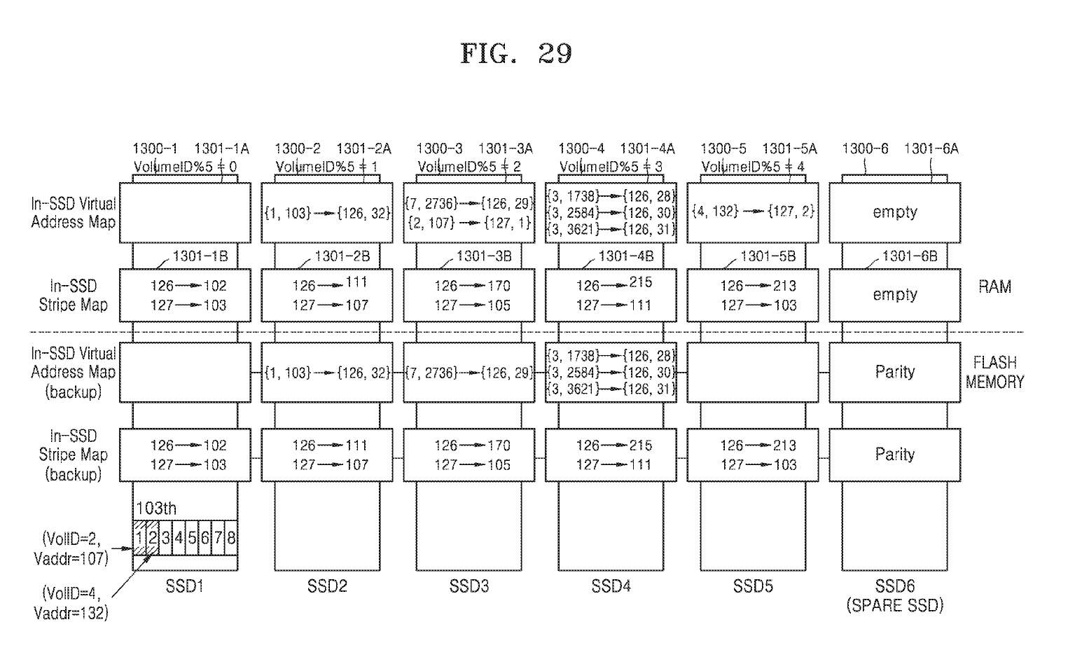

FIG. 29 shows distributed storing and backup management of the virtual address mapping table and the stripe mapping table of FIGS. 28A and 28B in a storage system, according to an exemplary embodiment of the inventive concept.

Referring to FIG. 29, a write operation is performed at a storage location of (VolumeID=2, Vaddr=107), and another write operation is performed at a storage location of (VolumeID=4, Vaddr=132). At this time, mapping information for (VolumeID=2, Vaddr=107) is updated in the RAM region of the third SSD 1300-3, and mapping information for (VolumeID=4, Vaddr=132) is updated in the RAM region of the fifth SSD 1300-5. The two pieces of mapping information are not included yet in the PMT information for backup stored in the flash memory regions of the third and fifth SSDs 1300-3 and 1300-5.

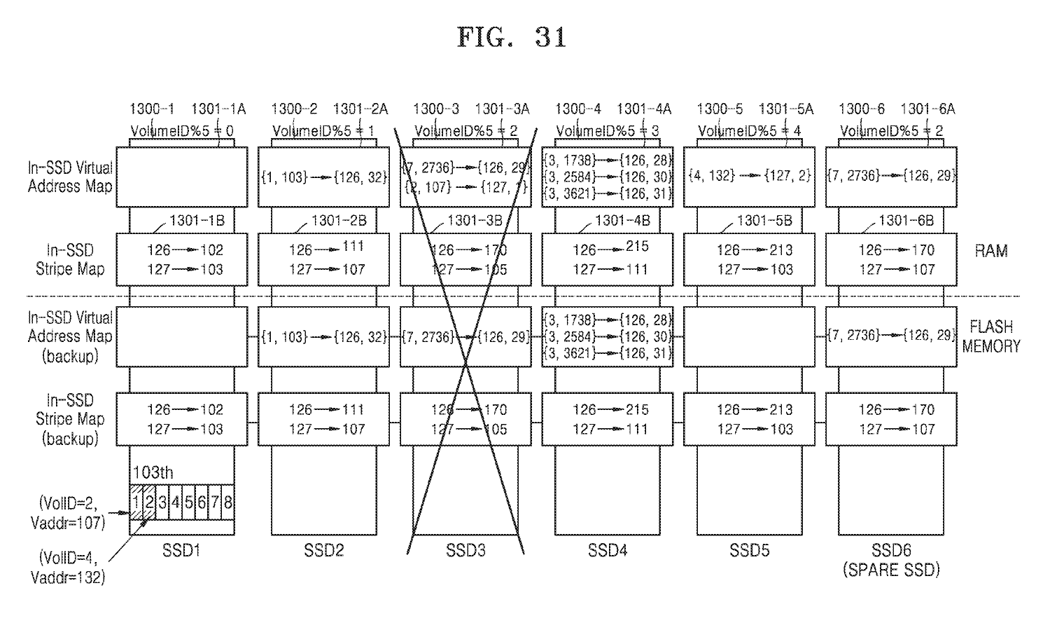

In this state, it is assumed as illustrated in FIG. 31 that the third SSD 1300-3 is defective. Then, the partial virtual address mapping table information and the partial stripe mapping table information stored for backup in the flash memory region of the third SSD 1300-3 are able to be restored based on the parity information.

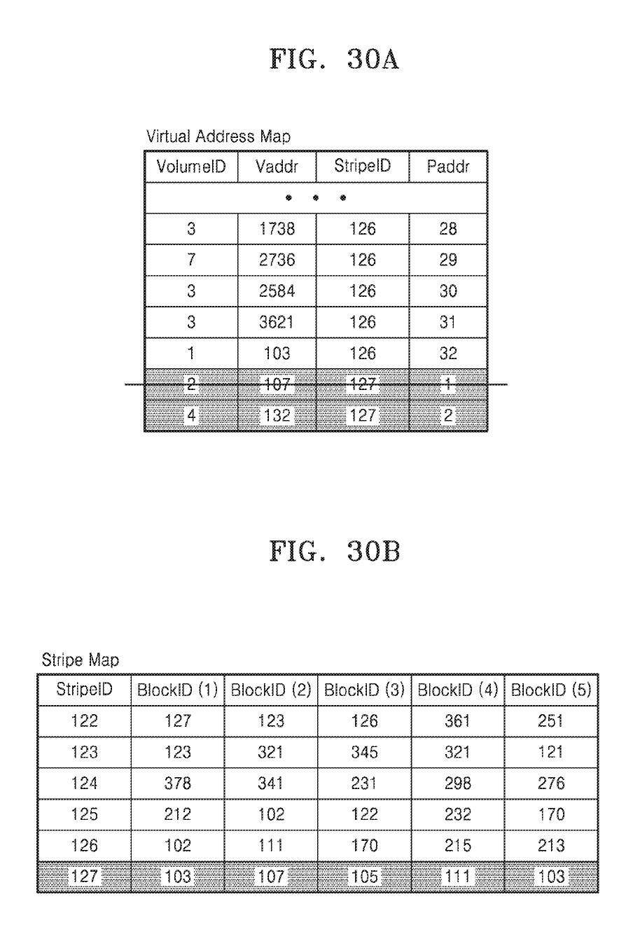

However, both the partial virtual address mapping table information and the partial stripe mapping table information for backup do not include latest mapping information. Respective pieces of mapping information for (VolumeID=2, Vaddr=107) and (VolumeID=4, Vaddr=132) as illustrated in FIGS. 30A and 30B are not included in the partial virtual address mapping table information and the partial stripe mapping table information for backup. Since the mapping information for (VolumeID=2, Vaddr=107) from among the two pieces of mapping information are included in the defective third SSD 1300-3, the mapping information for (VolumeID=2, Vaddr=107) may be lost.

However, the mapping information for (VolumeID=2, Vaddr=107) may be restored by using metadata that is stored together when data is stored in the flash memory region of the first SSD 1300-1. For example, when data is written to the flash memory region of each SSD, VolumeID and Vaddr of the data are also written in the form of a header of the data.

To restore latest PMT information after the PMT information stored in the third SSD 1300-3 has been restored, VolumeID and Vaddr included in the header information of recently written data is read from the flash memory region of each SSD. In this example, a write operation with respect to a stripe having StripeID of 127 is performed after PMT information is backed up using the partial stripe mapping table information of each SSD. Then, the PMT information restored by using the backup needs to be additionally updated with pieces of mapping information associated with the stripe having StripeID of 127.

First, each SSD checks memory blocks included in the stripe having a stripe ID of 127 by using the partial stripe mapping table information and ascertains VolumeID and Vaddr from the header information about the data stored in the checked memory blocks.

Referring to FIG. 31, it can seen that a write operation has not been performed on respective memory blocks of the second, third, fourth, and fifth SSDs 1300-2, 1300-3, 1300-4, and 1300-5 that define the stripe having a stripe ID of 127 and that a write operation has been performed on only a memory block of the first SSD 1300-1 that constitutes the stripe having a stripe ID of 127. It can be seen that data write operations for (VolumeID=2, Vaddr=107) and (VolumeID=4, Vaddr=132) have been performed, from the header information of the data written to the memory block of the first SSD 1300-1 that is included in the stripe having a stripe ID of 127. The mapping information for (VolumeID=2, Vaddr=107) from among the two pieces of mapping information for (VolumeID=2, Vaddr=107) and (VolumeID=4, Vaddr=132) corresponds to mapping information that is managed by the defective third SSD 1300-3. Accordingly, the mapping information for (VolumeID=2, Vaddr=107) is updated in partial virtual address mapping table information 1301-6A of the sixth SSD 1300-6 that plays a role of the defective third SSD 1300-3.

Thus, the partial virtual address mapping table information 1301-6A and the partial stripe mapping table information 1301-6B stored in the sixth SSD 1300-6 are restored as latest versions. The partial virtual address mapping table information 1301-6A and the partial stripe mapping table information 1301-6B correspond to the partial virtual address mapping table information 1301-3A and the partial stripe mapping table information 1301-3B stored in the RAM region of the third SSD 1300-3.

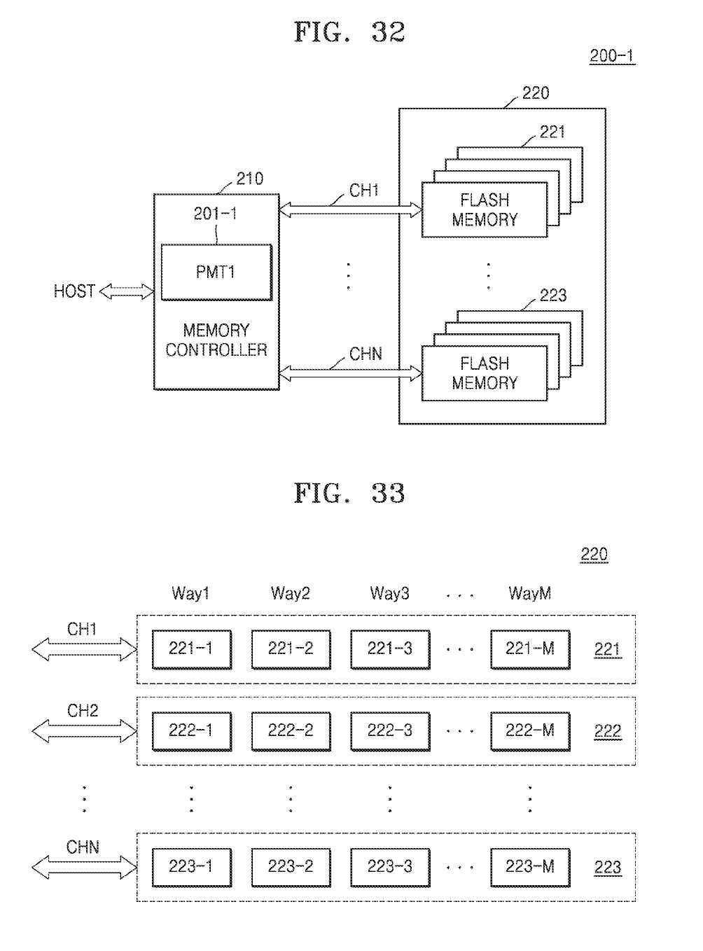

FIG. 32 is a block diagram of an SSD 200-1 forming a storage system according to an exemplary embodiment of the inventive concept. Referring to FIG. 32, the SSD 200-1 may include a memory controller 210 and a memory device 220.

The memory controller 210 may control the memory device 220 according to a command received from a host. In detail, the memory controller 210 may provide an address, a command, and a control signal to the memory device 220 via a plurality of channels CH1 through CHN to control a program (or write) operation, a read operation, and an erase operation with respect to the memory device 220.

The memory controller 210 stores the PMT information 201-1. For example, the PMT information 201-1 may include partial virtual address mapping table information and partial stripe mapping table information. Since the partial virtual address mapping table information and the partial stripe mapping table information have been described above in detail, repeated descriptions thereof will be omitted here.

The memory device 220 may include at least one flash memory chip, namely, flash memory chips 221 and 223. As another example, the memory device 220 may not only include flash memory chips but also PRAM chips, FRAM chips, MRAM chips, or the like.

In FIG. 32, the SSD 200-1 includes N channels (where N is a natural number), and each channel includes four flash memory chips. The number of flash memory chips included in each of the channels may be variously set.

FIG. 33 exemplarily shows channels and ways in the SSD 220 of FIG. 32.

A plurality of flash memory chips 221, 222, through to 223 may be electrically coupled to the channels CH1 to CHN, respectively. The channels CH1 to CHN may be independent buses, through which commands, addresses, and data may be transmitted to or received from the flash memory chips 221, 222, through to 223, respectively. The flash memory chips connected to different channels may operate independently from each other. Each of the plurality of flash memory chips 221, 222, through to 223 respectively connected to the channels CH1 to CHN may form a plurality of ways Way1 to WayM. M flash memory chips may be respectively connected to the M ways formed in each channel.

For example, flash memory chips 221-1 to 221-M may form M ways Way1 to WayM in the first channel CH1. The flash memory chips 221-1 to 221-M may be respectively connected to the M ways Way1 to WayM in the first channel CH1. The above relations between the flash memory chips, the channels, and the ways may be applied to flash memory chips 222 and flash memory chips 223.

A way is a unit of identification of each flash memory chip within an identical channel. Each of the flash memory chips may be identified according to a channel number and a way number. A channel and a way of a flash memory chip, which is to perform a request transmitted from the host, may be determined by a logical address transmitted from the host.

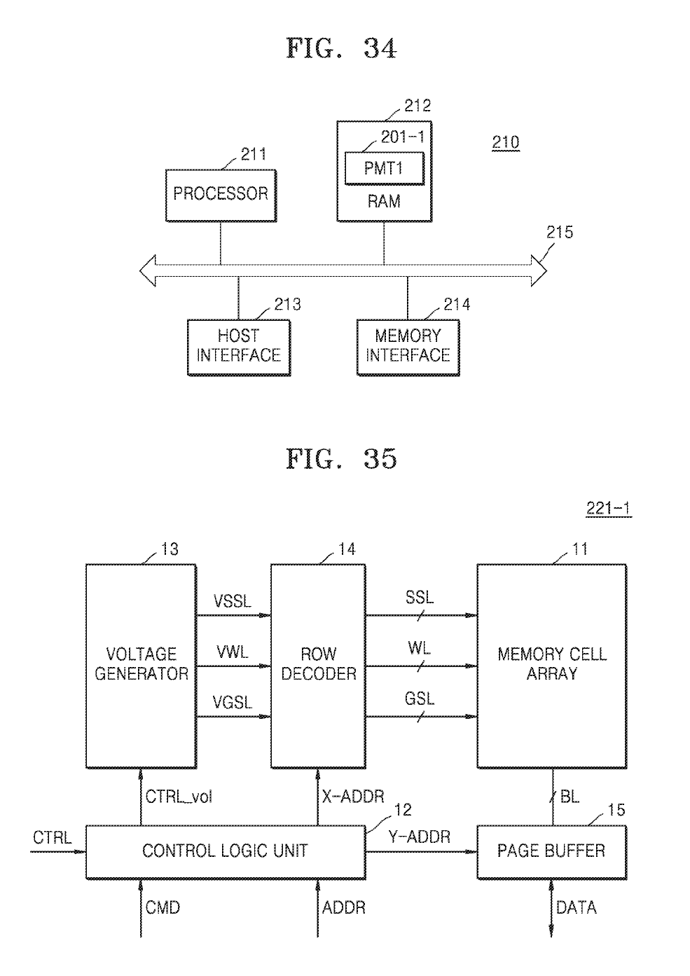

FIG. 34 is a block diagram illustrating a detailed structure of the memory controller 210 illustrated in FIG. 33. As shown in FIG. 34, the memory controller 210 includes a processor 211, a RAM 212, a host interface 213, a memory interface 214, and a bus 215. The components of the memory controller 210 are electrically coupled to each other via the bus 215.

The processor 211 may control an overall operation of the SSD 200-1 by using program codes and pieces of data that are stored in the RAM 212. When the SSD 200-1 is initialized, the processor 211 reads from the memory device 220 a program code and data which are necessary for controlling operations performed by the SSD 200-1, and loads the read program code and data into the RAM 212.

The RAM 212 stores the PMT information 201-1. For example, the PMT information 201-1 may include partial virtual address mapping table information and partial stripe mapping table information. Since the partial virtual address mapping table information and the partial stripe mapping table information have been described above in detail, repeated descriptions thereof will be omitted here.

The processor 211 may perform a control operation corresponding to the command received from the host, by using the program codes and the pieces of data that are stored in the RAM 212. In detail, the processor 211 may execute a write command or a read command received from the host. In response to a write command Write (VolumeID, Vaddr, StripeID, Paddr) as described above, the processor 211 performs an update operation on the PMT information 201-1 and a data write operation. The processor 211 may perform an operation according to the first read command VRead (VolumeID, Vaddr) or the second read command PRead (StripeID, Paddr). The processor 211 may control the SSD 200-1 to perform a page copying operation or a memory block erase operation according to a garbage collection operation based on the command received from the host.

The host interface 213 includes a protocol for exchanging data with a host that is connected to the memory controller 210, and interfaces the memory controller 210 with the host. The host interface 213 may be implemented by using, but is not limited to, an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Universal Flash Storage (UFS) interface. The host interface 213 may receive a command, an address, and data from the host under the control of the processor 211 or may transmit data to the host.

The memory interface 214 is electrically connected to the memory device 220. The memory interface 214 may transmit a command, an address, and data to the memory device 220 under the control of the processor 211 or may receive data from the memory device 220. The memory interface 214 may be configured to support NAND flash memory or NOR flash memory. The memory interface 214 may be configured to perform software and hardware interleaving operations via a plurality of channels.

FIG. 35 is a block diagram illustrating a detailed structure of the flash memory chip 221-1 included in the memory device 220 of FIG. 33. Referring to FIG. 35, the flash memory chip 221-1a may include a memory cell array 11, a control logic unit 12, a voltage generator 13, a row decoder 14, and a page buffer 15. The components included in the flash memory chip 221-1 will now be described in detail.

The memory cell array 11 may be connected to at least one string selection line SSL, a plurality of word lines WL, and at least one ground selection line GSL, and may also be connected to a plurality of bit lines BL. The memory cell array 11 may include a plurality of memory cells MC that are disposed at intersections of the plurality of bit lines BL and the plurality of word lines WL.

When an erasure voltage is applied to the memory cell array 11, the plurality of memory cells MC enter an erasure state. When a programming voltage is applied to the memory cell array 11, the plurality of memory cells MC enter a program state. At this time, each memory cell MC may have one selected from an erasure state and first through n-th program states P1 through Pn that are distinguished from each other according to a threshold voltage.

In the first through n-th program states P1 through Pn, n may be a natural number equal to or greater than 2. For example, when each memory cell MC is a 2-bit level cell, n may be 3. In another example, when each memory cell MC is a 3-bit level cell, n may be 7. In another example, when each memory cell MC is a 4-bit level cell, n may be 15. As such, the plurality of memory cells MC may include multi-level cells. However, exemplary embodiments of the inventive concept are not limited thereto, and the plurality of memory cells MC may include single-level cells.

The control logic unit 12 may receive a command signal CMD, an address signal ADDR, and a control signal CTRL from the memory controller 210 to output various control signals for writing the data DATA to the memory cell array 11 or for reading the data from the memory cell array 11. In this way, the control logic unit 12 may control overall operations of the flash memory chip 221-1.

The various control signals output by the control logic unit 12 may be provided to the voltage generator 13, the row decoder 14, and the page buffer 15. In detail, the control logic unit 12 may provide a voltage control signal CTRL_vol to the voltage generator 13, may provide a row address signal X_ADDR to the row decoder 14, and may provide a column address signal Y_ADDR to the page buffer 15.

The voltage generator 13 may receive the voltage control signal CTRL_vol to generate various voltages for executing a program operation, a read operation and an erasure operation with respect to the memory cell array 11. In detail, the voltage generator 13 may generate a first drive voltage VWL for driving the plurality of word lines WL, a second drive voltage VSSL for driving the at least one string selection line SSL, and a third drive voltage VGSL for driving the at least one ground selection line GSL.

The first drive voltage VWL may be a program (or write) voltage, a read voltage, an erasure voltage, a pass voltage, or a program verification voltage. The second drive voltage VSSL may be a string selection voltage, namely, an on voltage or an off voltage. The third drive voltage VGSL may be a ground selection voltage, namely, an on voltage or an off voltage.

According to the present exemplary embodiment, the voltage generator 13 may receive the voltage control signal CTRL_vol to generate a program start voltage as a program voltage, when a program loop starts, namely, when the number of program loops performed is 1. As the number of program loops performed increases, the voltage generator 13 may generate a voltage that increases from the program start voltage by a step voltage in stages, as the program voltage.

The row decoder 14 may be connected to the memory cell array 11 through the plurality of word lines WL and may activate some of the plurality of word lines WL in response to the row address signal X_ADDR received from the control logic unit 12. In detail, during a read operation, the row decoder 14 may apply a read voltage to a word line selected from the plurality of word lines WL and apply a pass voltage to the remaining unselected word lines.

During a program operation, the row decoder 14 may apply a program voltage to the selected word line and apply the pass voltage to the unselected word lines. According to the present exemplary embodiment, the row decoder 14 may apply a program voltage to the selected word line and an additionally selected word line, in at least one selected from a plurality of program loops.

The page buffer 15 may be connected to the memory cell array 11 via the plurality of bit lines BL. In detail, during a read operation, the page buffer 15 may operate as a sense amplifier so as to output data DATA stored in the memory cell array 11. During a program operation, the page buffer 15 may operate as a write driver so as to input the data DATA desired to be stored in the memory cell array 11.

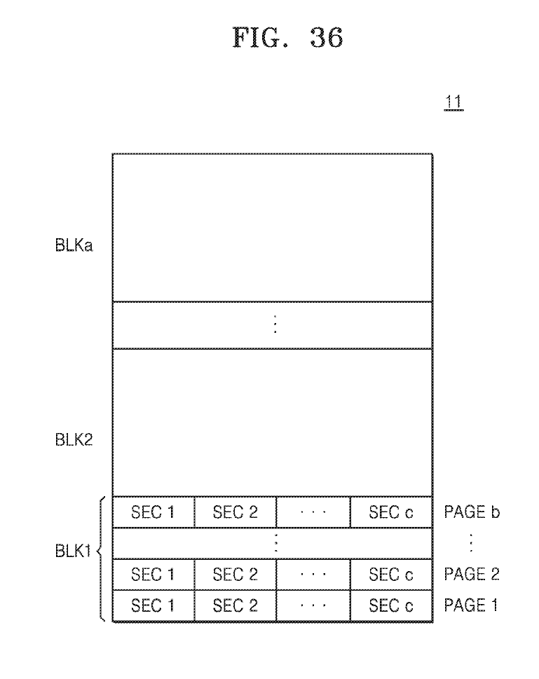

FIG. 36 is a schematic view illustrating the memory cell array 11 of FIG. 35.

Referring to FIG. 36, the memory cell array 11 may be a flash memory cell array. In this case, the memory cell array 11 may include a plurality of memory blocks BLK1, . . . , and BLKa (where “a” denotes a positive integer which is equal to or greater than two) and each of the memory blocks BLK1, . . . , and BLKa may include a plurality of pages PAGE1, . . . , and PAGEb (where “b” denotes a positive integer which is equal to or greater than two). In addition, each of the pages PAGE1, . . . , and PAGEb may include a plurality of sectors SEC1, . . . , and SECc (where “c” denotes a positive integer which is equal to or greater than two). Although only the pages PAGE1 through PAGEb and the sectors SEC1 through SECc of the memory block BLK1 are illustrated for convenience of explanation in FIG. 36, the other memory blocks BLK2 through BLKa may have the same structures as that of the memory block BLK1.

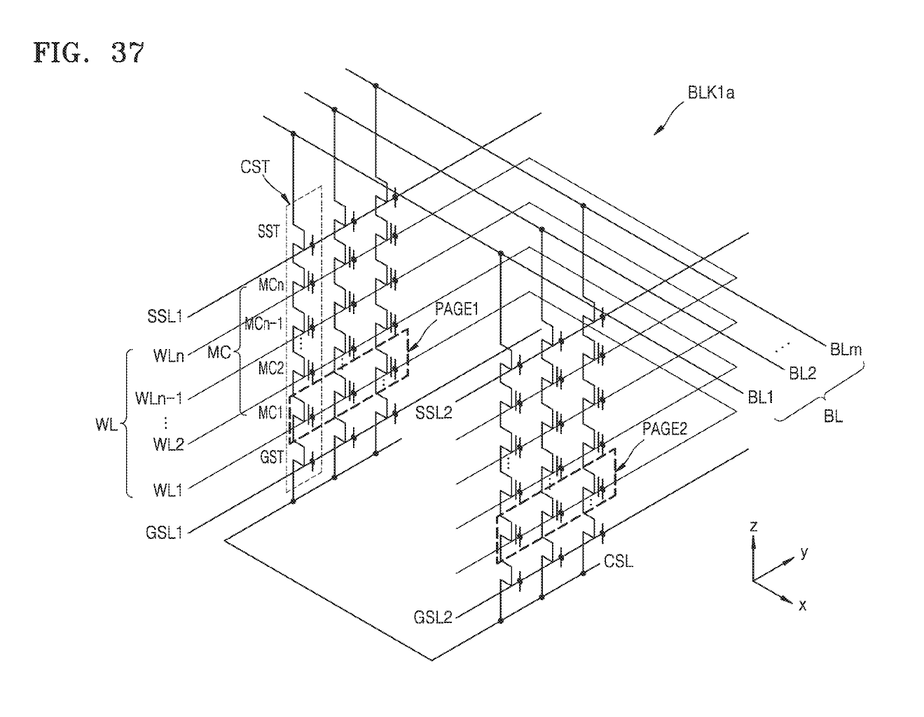

FIG. 37 is an equivalent circuit diagram illustrating a first memory block BLK1a, which is an example of the memory block BLK1 included in the memory cell array 11 of FIG. 36. Referring to FIG. 37, the first memory block BLK1a may be a NAND flash memory having a vertical structure. In FIG. 37, a first direction is referred to as an x direction, a second direction is referred to as a y direction, and a third direction is referred to as a z direction. However, exemplary embodiments of the inventive concept are not limited thereto, and the first through third directions may vary.

The first memory block BLK1a may include a plurality of cell strings CST, a plurality of word lines WL, a plurality of bit lines BL, a plurality of ground selection lines GSL1 and GSL2, a plurality of string selection lines SSL1 and SSL2, and a common source line CSL. The number of cell strings CST, the number of word lines WL, the number of bit lines BL, the number of ground selection lines GSL1 and GSL2, and the number of string selection lines SSL1 and SSL2 may vary according to embodiments.

Each of the cell strings CST may include a string selection transistor SST, a plurality of memory cells MC, and a ground selection transistor GST that are serially connected to each other between a bit line BL corresponding to the cell string CST and the common source line CSL. However, exemplary embodiments of the inventive concept are not limited thereto. According to another exemplary embodiment, each cell string CST may further include at least one dummy cell. According to another exemplary embodiment, each cell string CST may include at least two string selection transistors SST or at least two ground selection transistors GST.

Each cell string CST may extend in the third direction (z direction). In detail, each cell string CST may extend on a substrate in a vertical direction (z direction). Accordingly, the first memory block BLK1a including the cell strings CST may be referred to as a vertical-direction NAND flash memory. As such, by extending each cell string CST in the vertical direction (z direction) on a substrate, the integration density of the memory cell array 11 may increase.

The plurality of word lines WL may each extend in the first direction x and the second direction y, and each word line WL may be connected to memory cells MC corresponding thereto. Accordingly, a plurality of memory cells MC arranged adjacent to each other on the same plane in the first direction x and the second direction y may be connected to each other by an identical word line WL. In detail, each word line WL may be connected to gates of memory cells MC to control the memory cells MC. In this case, the plurality of memory cells MC may store data and may be programmed, read, or erased under the control of the connected word line WL.

The plurality of bit lines BL may extend in the first direction x and may be connected to the string selection transistors SST. Accordingly, a plurality of string selection transistors SST arranged adjacent to each other in the first direction x may be connected to each other by an identical bit line BL. In detail, each bit line BL may be connected to drains of the plurality of string selection transistors SST.

The plurality of string selection lines SSL1 and SSL2 may each extend in the second direction y and may be connected to the string selection transistors SST. Accordingly, a plurality of string selection transistors SST arranged adjacent to each other in the second direction y may be connected to each other by an identical string selection line SSL1 or SSL2. In detail, each string selection line SSL1 or SSL2 may be connected to gates of the plurality of string selection transistors SST to control the plurality of string selection transistors SST.

The plurality of ground selection lines GSL1 and GSL2 may each extend in the second direction y and may be connected to the ground selection transistors GST. Accordingly, a plurality of ground selection transistors GST arranged adjacent to each other in the second direction y may be connected to each other by an identical ground selection line GSL1 or GSL2. In detail, each ground selection line GSL1 or GSL2 may be connected to gates of the plurality of ground selection transistors GST to control the plurality of ground selection transistors GST.

The ground selection transistors GST respectively included in the cell strings CST may be connected to each other by the common source line CSL. In detail, the common source line CSL may be connected to sources of the ground selection transistors GST.

A plurality of memory cells MC connected to an identical word line WL and to an identical string selection line SSL1 or SSL2 and arranged adjacent to each other in the second direction y may be referred to as a page PAGE. For example, a plurality of memory cells MC that are connected to a first word line WL1 and to a first string selection line SSL1 and are arranged adjacent to each other in the second direction y may be referred to as a first page PAGE1. A plurality of memory cells MC that are connected to the first word line WL1 and to a second string selection line SSL2 and are arranged adjacent to each other in the second direction y may be referred to as a second page PAGE2.

To perform a program operation with respect to a memory cell MC, 0 V may be applied to a bit line BL, an on voltage may be applied to a string selection line SSL, and an off voltage may be applied to a ground selection line GSL. The on voltage may be equal to or greater than the threshold voltage so that a string selection transistor SST is turned on, and the off voltage may be smaller than the threshold voltage so that the ground selection transistor GST is turned off. A program voltage may be applied to a memory cell selected from the memory cells MC, and a pass voltage may be applied to the remaining unselected memory cells. In response to the program voltage, electric charges may be injected into the memory cells MC due to F-N tunneling. The pass voltage may be greater than the threshold voltage of the memory cells MC.

To perform an erasure operation with respect to the memory cells MC, an erasure voltage may be applied to the body of the memory cells MC, and 0 V may be applied to the word lines WL. Accordingly, data stored in the memory cells MC may be temporarily erased.

Next, a mapping table managing method performed in various kinds of RAID storage systems including the embodiments illustrated in FIGS. 1 to 6 will be described with reference to FIGS. 38-43.

FIG. 38 is a flowchart of a mapping table managing method in a storage system according to an exemplary embodiment of the inventive concept.

First, the storage system classifies mapping information into a plurality of pieces of PMT information and distributing and storing the plurality of pieces of PMT information in SDs, in operation S110. For example, SDs may include SSDs.

For example, the mapping information may include virtual address mapping information in which volume identification information and a virtual address are mapped with stripe identification information and a physical address, and stripe mapping information in which stripe identification information is mapped with pieces of memory block identification information of the SDs.

For example, the mapping information includes virtual address mapping information in which volume identification information and a virtual address are mapped with stripe identification information and a physical address, the virtual address mapping information is classified into a plurality of pieces of partial virtual address mapping table information based on a value obtained by hashing the volume identification information, and the plurality of pieces of partial virtual address mapping table information are distributed and stored in the SDs. For example, virtual address mapping information may be classified into the plurality of pieces of partial virtual address mapping table information, based on the remainder obtained by dividing the volume identification information by the number n of SDs that form a log-structured storage system, and the plurality of pieces of partial virtual address mapping table information may be stored in the SDs, respectively.

As another example, the mapping information includes virtual address mapping information in which volume identification information and a virtual address are mapped with stripe identification information and a physical address, the virtual address mapping information may be classified into a plurality of pieces of partial virtual address mapping table information based on a value obtained by hashing the virtual address, and the plurality of pieces of partial virtual address mapping table information may be distributed and stored in the SDs. For example, virtual address mapping information may be classified into a plurality of pieces of partial virtual address mapping table information, based on the remainder obtained by dividing the virtual address by the number n of SDs that form a storage system, and the plurality of pieces of partial virtual address mapping table information may be stored in the SDs, respectively.

For example, the mapping information includes stripe mapping information in which stripe identification information is mapped with pieces of memory block identification information of the SDs, the stripe mapping information may be classified into a plurality of pieces of partial stripe mapping table information in which memory block identification information corresponding to the stripe identification information is mapped with each SD, and the plurality of pieces of partial stripe mapping table information may be distributed and stored in the SDs.

Next, the storage system searches for a storage location in an SD on which an access operation is to be performed, by using the PMT information stored in each of the SDs, in operation S120. The access operation includes a write operation or a read operation with respect to the SDs that form the storage system.

Thereafter, the storage system performs an access operation with respect to a found storage location in the SD, in operation S130. In other words, data may be written to the found storage location in the SD or data may be read from the found storage location in the SD.

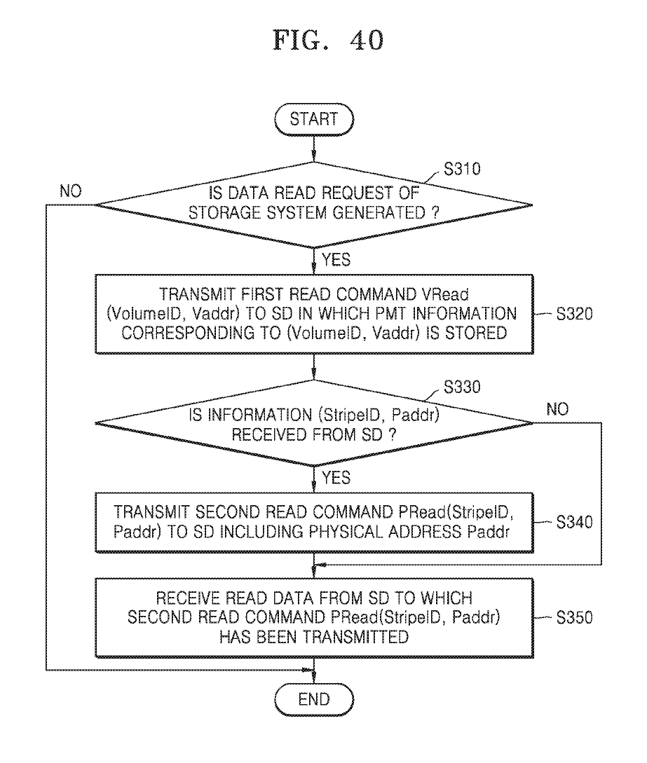

FIG. 39 is a flowchart of a write operation controlling method in a host of a storage system according to an exemplary embodiment of the inventive concept.

In operation S210, the host determines whether a data write request of the storage system is generated. For example, the data write request may be generated via a user interface (for example, input units such as a key pad and a mouse).

When a data write request is generated, the host transmits a write command Write (VolumeID, Vaddr, StripeID, Paddr) including volume identification information VolumeID, a virtual address Vaddr, stripe identification information StripeID, and a physical address Paddr to both an SD in which PMT information corresponding to (VolumeID, Vaddr) is stored and an SD in which the physical address Paddr included in the write command exists, in operation S220.

Next, the host transmits data that is to be written, to the SD in which the physical address Paddr included in the write command exists, in operation S230. In other words, the host does not transmit data that is to be written, to the SD in which the PMT information corresponding to (VolumeID, Vaddr) is stored.

FIG. 40 is a flowchart of a read operation controlling method in a host of a storage system according to an exemplary embodiment of the inventive concept.

In operation S310, the host determines whether a data read request of the storage system is generated. For example, the data read request may be generated via a user interface (for example, input units such as a key pad and a mouse).

When a data read request is generated, the host transmits a first read command VRead(VolumeID, Vaddr) to an SD in which PMT information corresponding to (VolumeID, Vaddr) is stored, in operation S320.

Next, the host determines whether information (StripeID, Paddr) is received from the SD, in operation S330. As described above, when the SD that has received the first read command VRead (VolumeID, Vaddr) does not include the physical address Paddr of information (StripeID, Paddr) mapped with (VolumeID, Vaddr) included in the first read command, the SD transmits the information (StripeID, Paddr) to the host.

In operation S340, when the information (StripeID, Paddr) is received from the SD, the host transmits the second read command PRead (StripeID, Paddr) to an SD including the physical address Paddr, based on the information (StripeID, Paddr) received from the SD.

Next, the host receives read data from the SD to which the second read command PRead (StripeID, Paddr) has been transmitted, in operation S350.

FIG. 41 is a flowchart of a write operation performing method in an SD of a storage system according to an exemplary embodiment of the inventive concept.

In operation S410, the SD determines whether a write command Write (VolumeID, Vaddr, StripeID, Paddr) is received from a host.

In operation S420, when the write command Write (VolumeID, Vaddr, StripeID, Paddr) is received, the SD determines whether PMT information corresponding to information (VolumeID, Vaddr) included in the write command is stored therein.

In operation S430, when the PMT information corresponding to information (VolumeID, Vaddr) included in the write command is stored in the SD, the SD updates the PMT information. The updating is performed by adding mapping information for (VolumeID, Vaddr, StripeID, Paddr) included in the write command to the PMT information stored in the SD.

In operation S440, when the PMT information corresponding to information (VolumeID, Vaddr) included in the write command is not stored in the SD, or after the SD updates the PMT information, the SD determines whether the physical address Paddr included in the write command exists therein.

In operation S450, when it is determined that the physical address Paddr included in the write command exists in the SD, the SD searches for a storage location corresponding to the information (StripeID, Paddr) by using the PMT information.

In operation S460, the SD writes data that is received from the host to a found storage location.

When it is determined in operation S440 that the physical address Paddr included in the write command does not exist in the SD, the method is concluded.

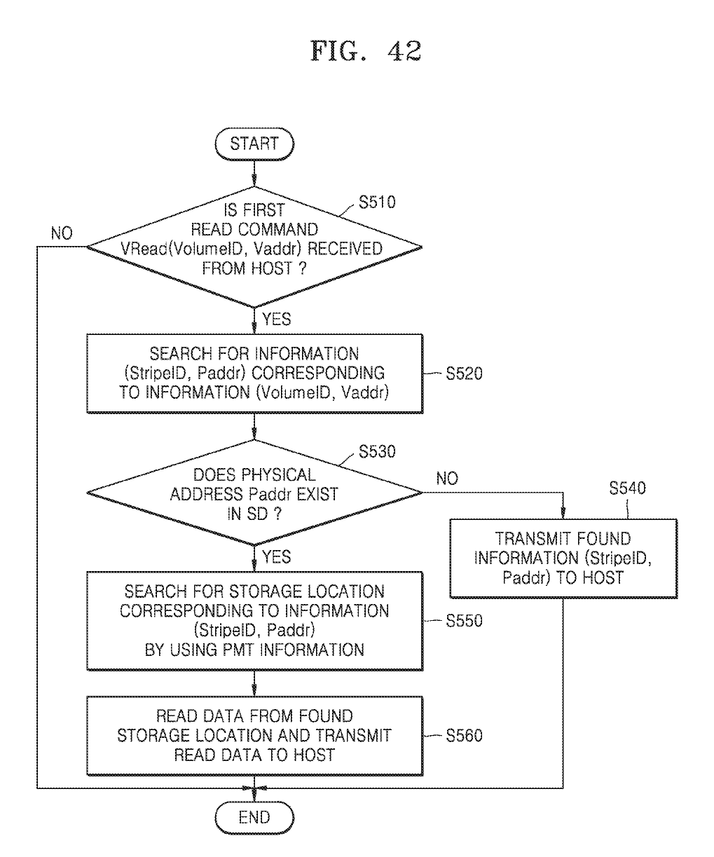

FIG. 42 is a flowchart of a read operation performing method in an SD of a storage system according to an exemplary embodiment of the inventive concept.

In operation S510, the SD determines whether a first read command VRead (VolumeID, Vaddr) is received from a host.

In operation S520, when the first read command VRead (VolumeID, Vaddr) is received, the SD searches for information (StripeID, Paddr) corresponding to information (VolumeID, Vaddr) included in the first read command by using the PMT information.

In operation S530, the SD determines whether the physical address Paddr included in found information (StripeID, Paddr) exists therein.

In operation S550, when it is determined in operation S530 that the physical address Paddr included in the write command exists in the SD, the SD searches for a storage location corresponding to the information (StripeID, Paddr) by using the PMT information.

Then, the SD reads data from the found storage location and transmits the read data to the host, in operation S560.

On the other hand, when it is determined in operation S530 that the physical address Paddr included in the write command does not exist in the SD, the SD transmits the found information (StripeID, Paddr) to the host, in operation S540.

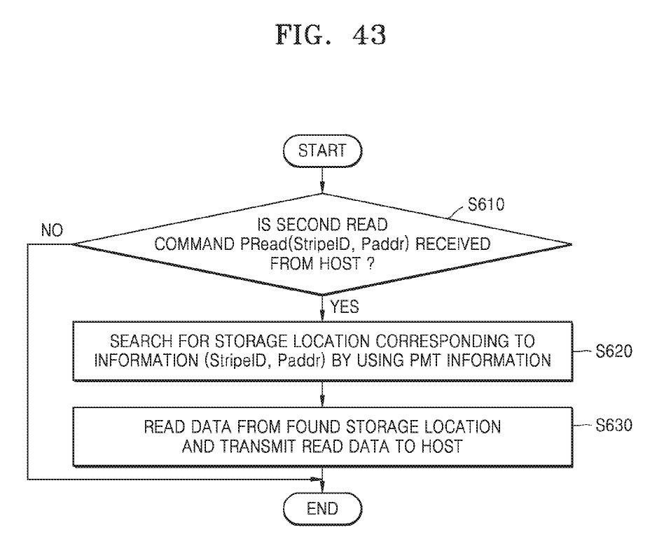

FIG. 43 is a flowchart of a read operation performing method in an SD of a storage system according to another exemplary embodiment of the inventive concept.

In operation S610, the SD determines whether a second read command PRead (StripeID, Paddr) is received from the host.

In operation S620, the SD searches for a storage location corresponding to the information (StripeID, Paddr) included in the second read command by using the PMT information.

Then, the SD reads data from the found storage location and transmits the read data to the host, in operation S630.

Meanwhile, a storage system according to the inventive concept may be mounted by using various types of packages, e.g., a package on package (POP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small-outline integrated circuit (SOIC), a shrink small outline package (SSOP), a thin small outline package (TSOP), a system in package (SIP), a multi chip package (MCP), a wafer-level fabricated package (WFP), and a wafer-level processed stack package (WSP).

While the inventive concept has been particularly shown and described with reference to exemplary embodiments thereof, it will be understood that various changes in form and details may be made therein without departing from the spirit and scope of the following claims.

What is claimed is:

1. A mapping table managing method in a storage system, the method comprising:
organizing mapping information about the storage system into a plurality of pieces of partial mapping table (PMT) information and distributing and storing the plurality of pieces of PMT information in storage devices (SDs);
searching for a storage location in an SD on which an access operation is to be performed, by using the PMT information stored in each of the SDs; and
performing the access operation on a found storage location in the SD.

2. The mapping table managing method of claim 1, wherein the mapping information comprises virtual address mapping information in which volume identification information and a virtual address are mapped with stripe identification information and a physical address, and stripe mapping information in which stripe identification information is mapped with respective pieces of memory block identification information of the SDs.

3. The mapping table managing method of claim 1, wherein the mapping information includes virtual address mapping information in which volume identification information and a virtual address are mapped with stripe identification information and a physical address, the virtual address mapping information is classified into a plurality of pieces of partial virtual address mapping table information based on a value obtained by hashing the volume identification information, and the plurality of pieces of partial virtual address mapping table information are distributed and stored in the SDs.

4. The mapping table managing method of claim 3, wherein the virtual address mapping information are classified into the plurality of pieces of partial virtual address mapping table information, based on a remainder obtained by dividing the volume identification information by the number of SDs of the storage system, and the plurality of pieces of partial virtual address mapping table information are respectively stored in the SDs.

5. The mapping table managing method of claim 1, wherein the mapping information includes virtual address mapping information in which volume identification information and a virtual address are mapped with stripe identification information and a physical address, the virtual address mapping information is classified into a plurality of pieces of partial virtual address mapping table information based on a value obtained by hashing the virtual address, and the plurality of pieces of partial virtual address mapping table information are distributed and stored in the SDs.

6. The mapping table managing method of claim 5, wherein the virtual address mapping information are classified into the plurality of pieces of partial virtual address mapping table information, based on a remainder obtained by dividing the virtual address by the number of SDs of the storage system, and the plurality of pieces of partial virtual address mapping table information are respectively stored in the SDs.

7. The mapping table managing method of claim 1, wherein the mapping information includes stripe mapping information in which stripe identification information is mapped with respective pieces of memory block identification information of the SDs, the stripe mapping information is classified into a plurality of pieces of partial stripe mapping table information in which memory block identification information corresponding to the stripe identification information is mapped with each SD, and the plurality of pieces of partial stripe mapping table information are distributed and stored in the SDs.

8. The mapping table managing method of claim 1, wherein the access operation comprises a write operation or a read operation with respect to SDs of the storage system.

9. A storage system comprising:
a plurality of storage devices (SDs) each comprising a random access memory (RAM) region and a non-volatile memory region; and
a controller configured to selectively transmit read commands and write commands to the plurality of SDs based on a log-structured storage environment, the controller being configured to organize mapping information about the storage system into a plurality of pieces of partial mapping table (PMT) information which are distributed into and stored in respective RAM regions of the SDs;
wherein the read commands and write commands received from the controller are executed using the PMT information stored in each of the SDs.

10. The storage system of claim 9, wherein the mapping information includes virtual address mapping information in which volume identification information and a virtual address are mapped with stripe identification information and a physical address, the virtual address mapping information is organized into a plurality of pieces of partial virtual address mapping table information based on a value obtained by hashing the volume identification information, and the plurality of pieces of partial virtual address mapping table information are distributed and stored in the respective RAM regions of the SDs.

11. The storage system of claim 9, wherein the mapping information includes virtual address mapping information in which volume identification information and a virtual address are mapped with stripe identification information and a physical address, the virtual address mapping information is organized into a plurality of pieces of partial virtual address mapping table information based on a value obtained by hashing the virtual address, and the plurality of pieces of partial virtual address mapping table information are distributed and stored in the respective RAM regions of the SDs.

12. The storage system of claim 9, wherein the write command includes volume identification information, a virtual address, stripe identification information, and a physical address.

13. The storage system of claim 12, wherein an update operation with respect to PMT information stored in a RAM region of at least one SD from among the plurality of pieces of PMT information, and a data write operation, are performed based on the write command.

14. The storage system of claim 9, wherein the controller is configured to transmit a first read command to a first target SD in which PMT information corresponding to volume identification information and a virtual address included in the first read command is stored, and, the first target SD is configured to search for stripe identification information and a physical address corresponding to the volume identification information and the virtual address included in the first read command by using the PMT information, and, when a found physical address exists in the first target SD, data is read from a storage location indicated by found stripe identification information and the found physical address and transmitted to the controller, and, when the found physical address does not exist in the first target SD, the found stripe identification information and the found physical address are transmitted to the controller.

15. The storage system of claim 14, wherein, when the controller receives the stripe identification information and the physical address from the first target SD, the controller is configured to transmit a second read command including the received stripe identification information and the received physical address to a second target SD in which the received physical address exists.

16. A storage system comprising:
a plurality of storage devices (SDs); and
a controller configured to
organize mapping information about the storage system into a plurality of pieces of partial mapping table (PMT) information and distribute and store the plurality of pieces of PMT information in the SDs,
search for a storage location in an SD on which an access operation is to be performed, by using the PMT information stored in each of the SDs, and
perform the access operation on a found storage location in the SD.

17. The storage system of claim 16, wherein the mapping information includes virtual address mapping information in which volume identification information and a virtual address are mapped with stripe identification information and a physical address, the virtual address mapping information is organized into a plurality of pieces of partial virtual address mapping table information based on a value obtained by hashing the volume identification information, and the plurality of pieces of partial virtual address mapping table information are distributed and stored in respective SDs.

18. The storage system of claim 16, wherein the mapping information includes virtual address mapping information in which volume identification information and a virtual address are mapped with stripe identification information and a physical address, the virtual address mapping information is organized into a plurality of pieces of partial virtual address mapping table information based on a value obtained by hashing the virtual address, and the plurality of pieces of partial virtual address mapping table information are distributed and stored in respective SDs.

19. The storage system of claim 16, wherein the controller is configured to transmit a first read command to a first target SD in which PMT information corresponding to volume identification information and a virtual address included in the first read command is stored, and, the first target SD is configured to search for stripe identification information and a physical address corresponding to the volume identification information and the virtual address included in the first read command by using the PMT information, and, when a found physical address exists in the first target SD, data is read from a storage location indicated by found stripe identification information and the found physical address and transmitted to the controller, and, when the found physical address does not exist in the first target SD, the found stripe identification information and the found physical address are transmitted to the controller.

20. The storage system of claim 19, wherein, when the controller receives the stripe identification information and the physical address from the first target SD, the controller is configured to transmit a second read command including the received stripe identification information and the received physical address to a second target SD in which the received physical address exists.
